(19) United States
(12) Patent Application Publication
(10) Pub. No.: US 2025/0232541 A1
(43) Pub. Date: Jul. 17, 2025

(54) METHODS OF UPDATING SPATIAL ARRANGEMENTS OF A PLURALITY OF VIRTUAL OBJECTS WITHIN A REAL-TIME COMMUNICATION SESSION

(71) Applicant: Apple Inc., Cupertino, CA (US)

(72) Inventors: Jesse CHAND, San Francisco, CA (US); Benjamin H. BOESEL, Sunnyvale, CA (US)

(21) Appl. No.: 19/016,975

(22) Filed: Jan. 10, 2025

Related U.S. Application Data
(60) Provisional application No. 63/656,519, filed on Jun. 5, 2024.
(60) Provisional application No. 63/646,885, filed on May 13, 2024.
(60) Provisional application No. 63/620,767, filed on Jan. 12, 2024.

(51) Int. Cl. G06T 19/20; H04N 7/15

(52) U.S. Cl. CPC G06T 19/20; H04N 7/157; G06T 2219/2004; G06T 2219/2016

(57) ABSTRACT

In some embodiments, a computer system facilitates the update of a spatial arrangement of one or more virtual objects in a three-dimensional environment from the viewpoint of a first user of the computer system while in a real-time communication session that includes a plurality of users. In some embodiments, updating the spatial arrangement of one or more virtual objects includes collectively moving the one or more virtual objects in the three-dimensional environment relative to the viewpoint of the first user.

### CROSS-REFERENCE TO RELATED APPLICATIONS

This application claims the benefit of U.S. Provisional Application No. 63/656,519, filed Jun. 5, 2024, U.S. Provisional Application No. 63/646,885, filed May 13, 2024, and U.S. Provisional Application No. 63/620,767, filed Jan. 12, 2024, the contents of which are incorporated herein by reference in their entireties for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system facilitates the update of a spatial arrangement of one or more virtual objects in a three-dimensional environment from the viewpoint of a first user of the computer system while in a real-time communication session that includes a plurality of users.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the Figs.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flowchart illustrating a glint-assisted gaze tracking pipeline in accordance with some embodiments.

FIGS. 7A-7GG illustrate examples of a computer system facilitating updating the spatial arrangement of one or more virtual objects in a three-dimensional environment while in a real-time communication session that includes a plurality of users in accordance with some embodiments.

FIG. 8 is a flowchart illustrating an exemplary method of updating one or more spatial arrangements of a plurality of a virtual objects in a three-dimensional environment in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system facilitates the update of the spatial arrangement of one or more virtual objects in a three-dimensional environment from the viewpoint of a first user of the computer system while in a real-time communication session that includes a plurality of users of other computer systems. In some embodiments, a virtual object of the one or more virtual objects includes a movement element that when selected by the first user, updates the spatial arrangement of the one or more virtual objects in the three-dimensional environment in accordance with a movement input provided by the first user. In some embodiments, the spatial arrangement of a subsection of the one or more virtual objects is not updated in accordance with the movement input provided by the first user. In some embodiments, the movement input provided by the first user is not directed at the movement element. In this example, the spatial arrangement of the one or more virtual objects is not updated

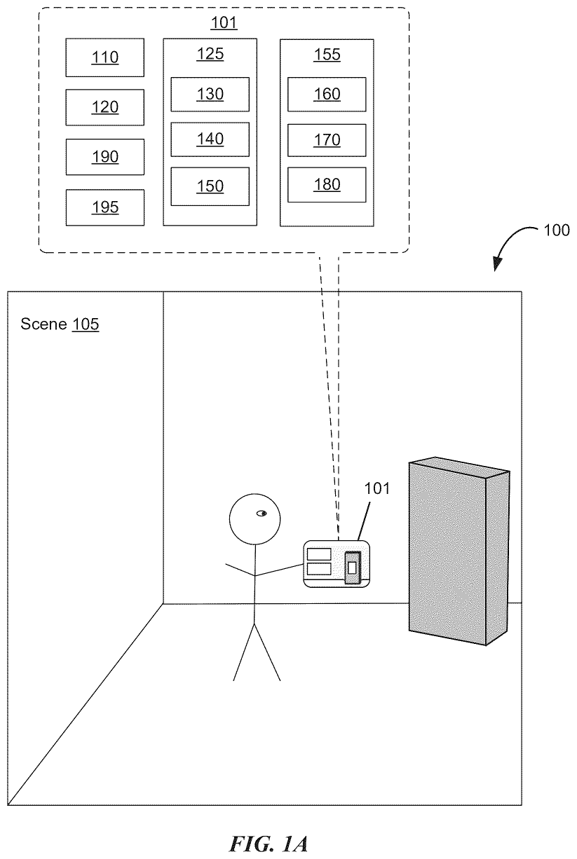

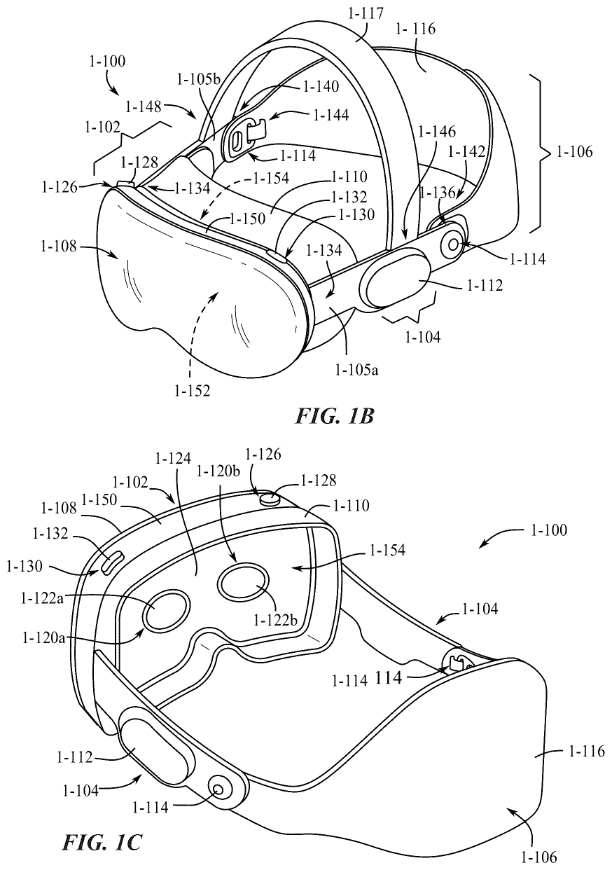

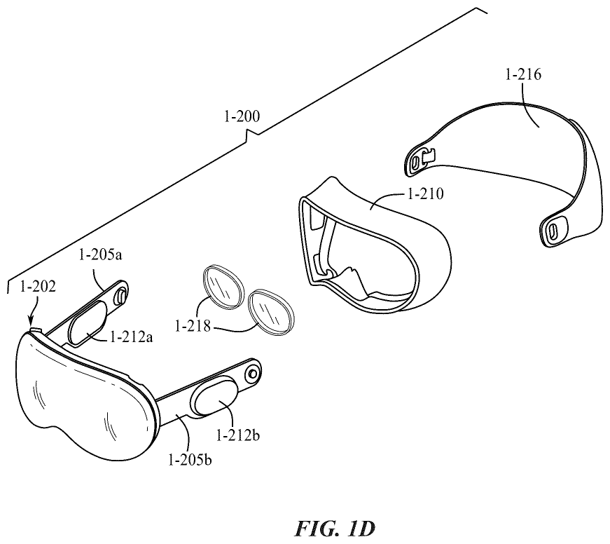

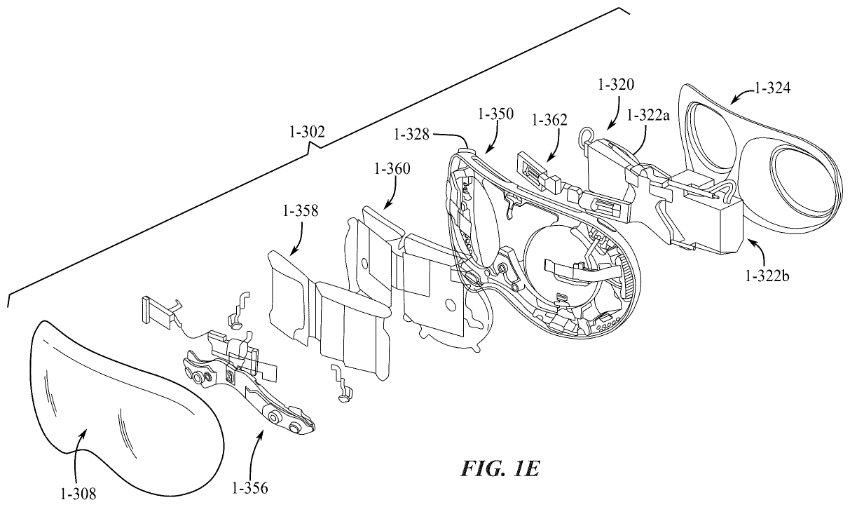

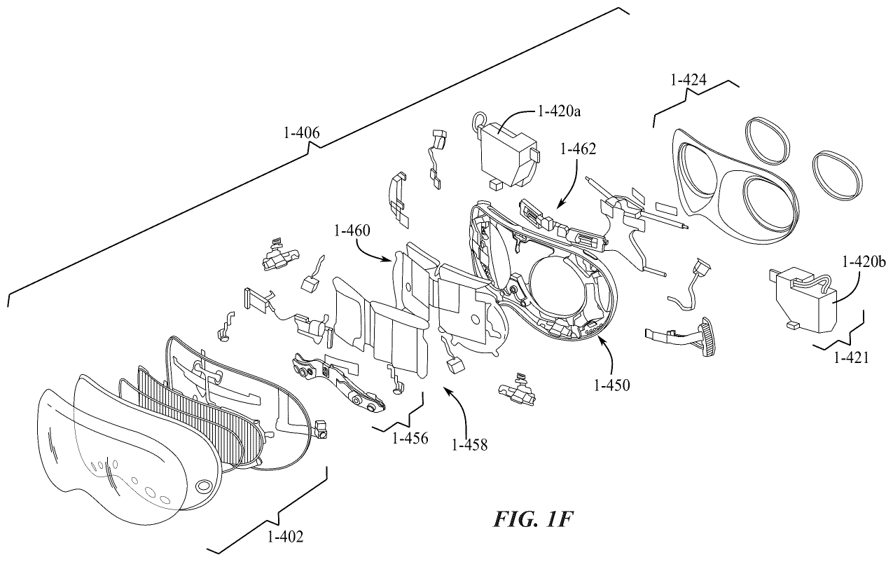

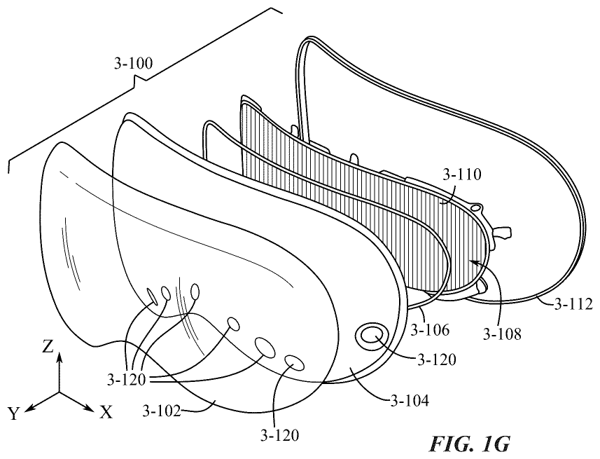

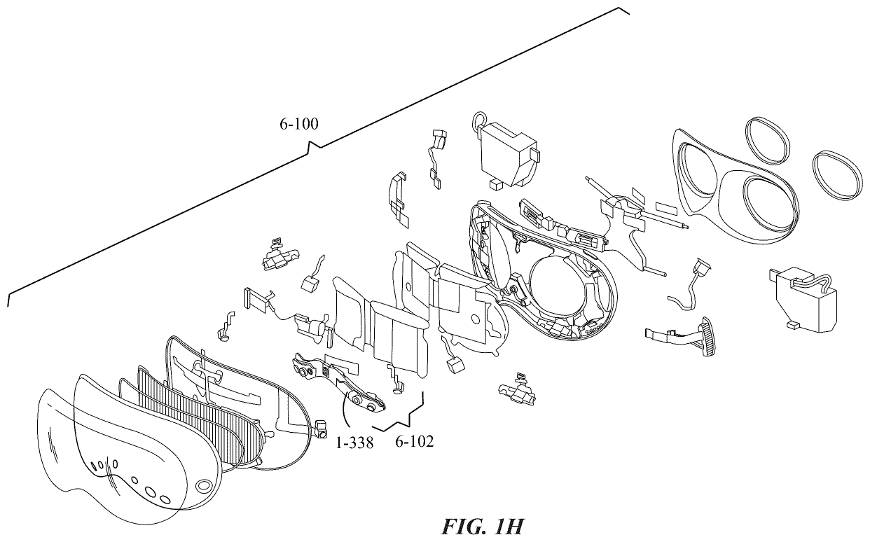

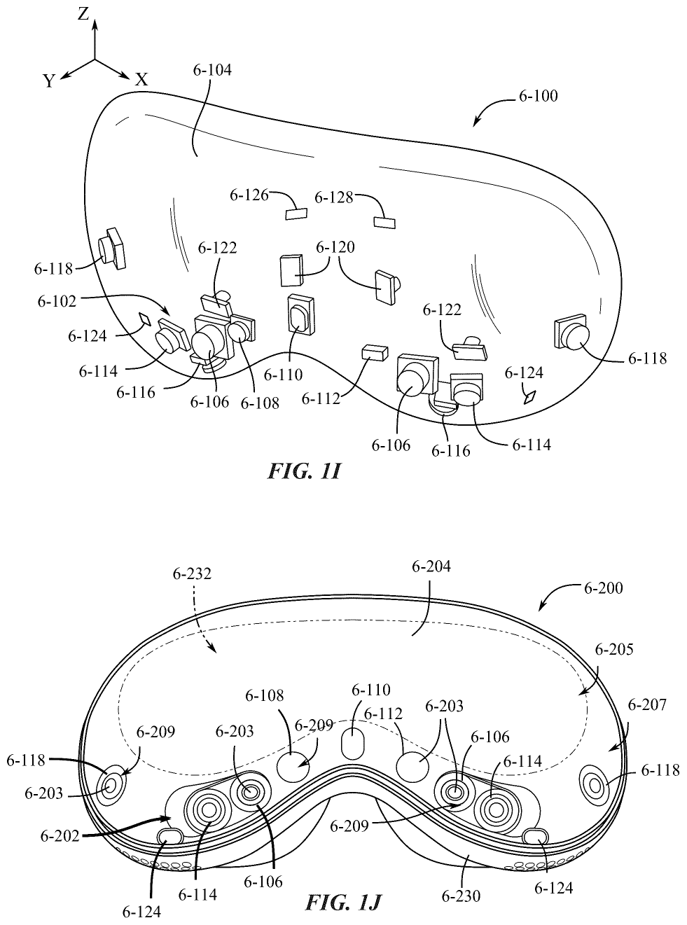

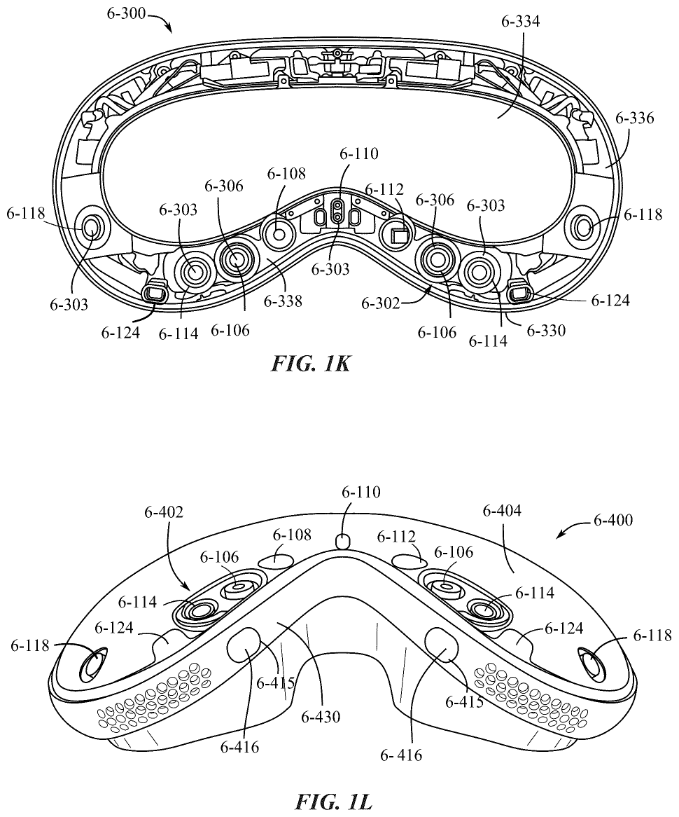

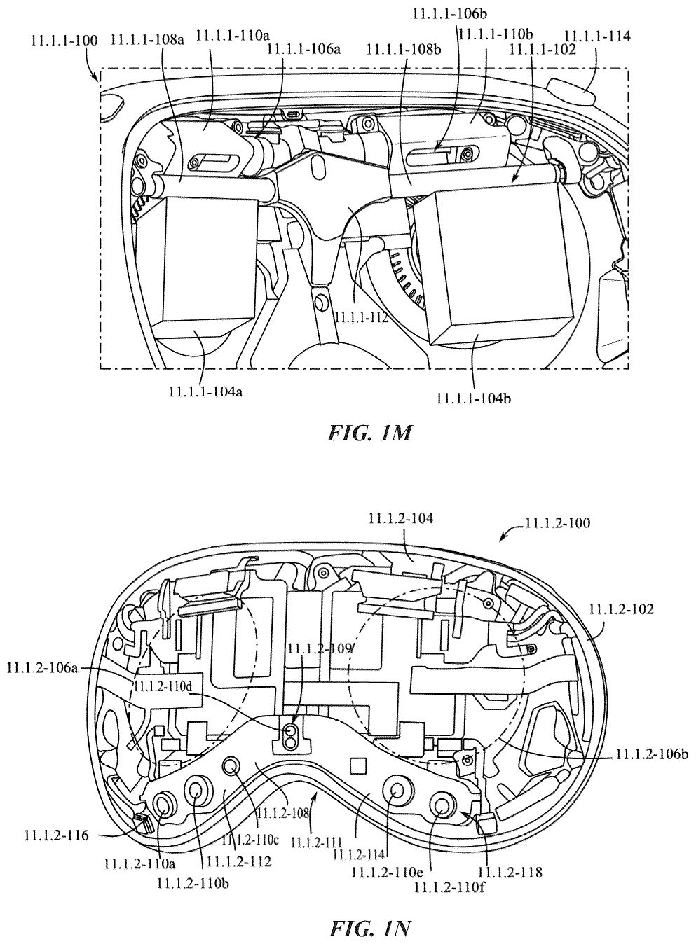

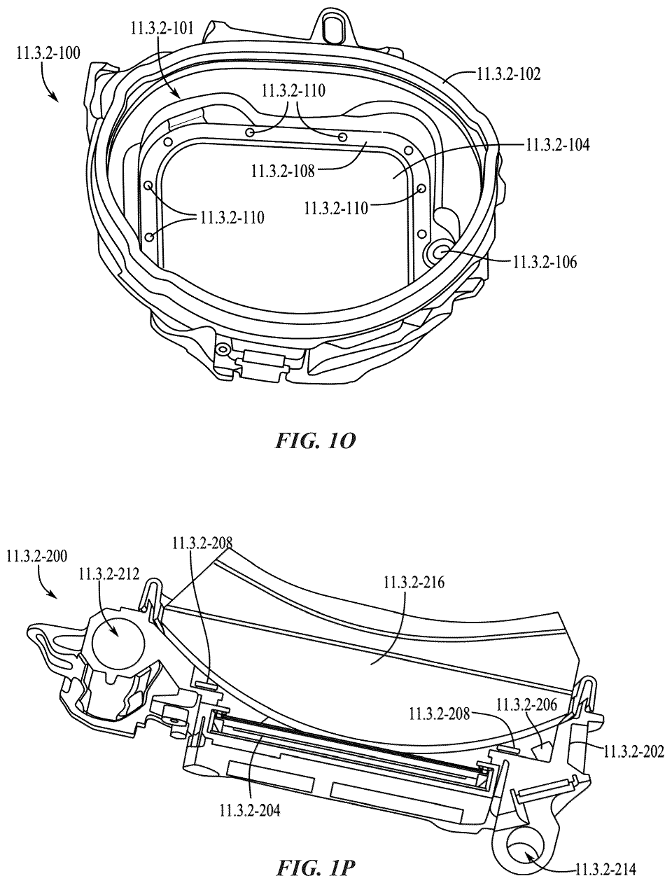

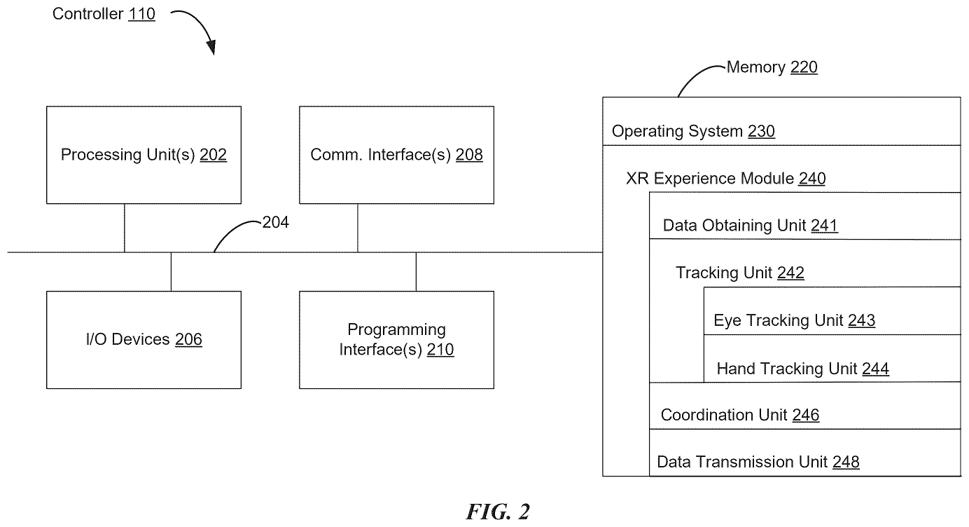

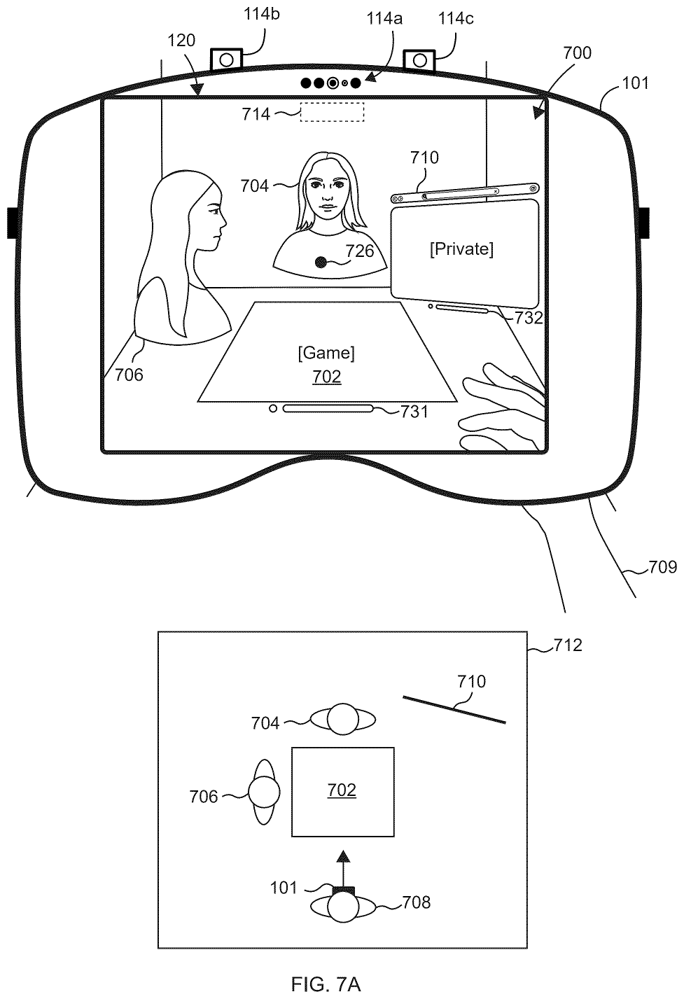

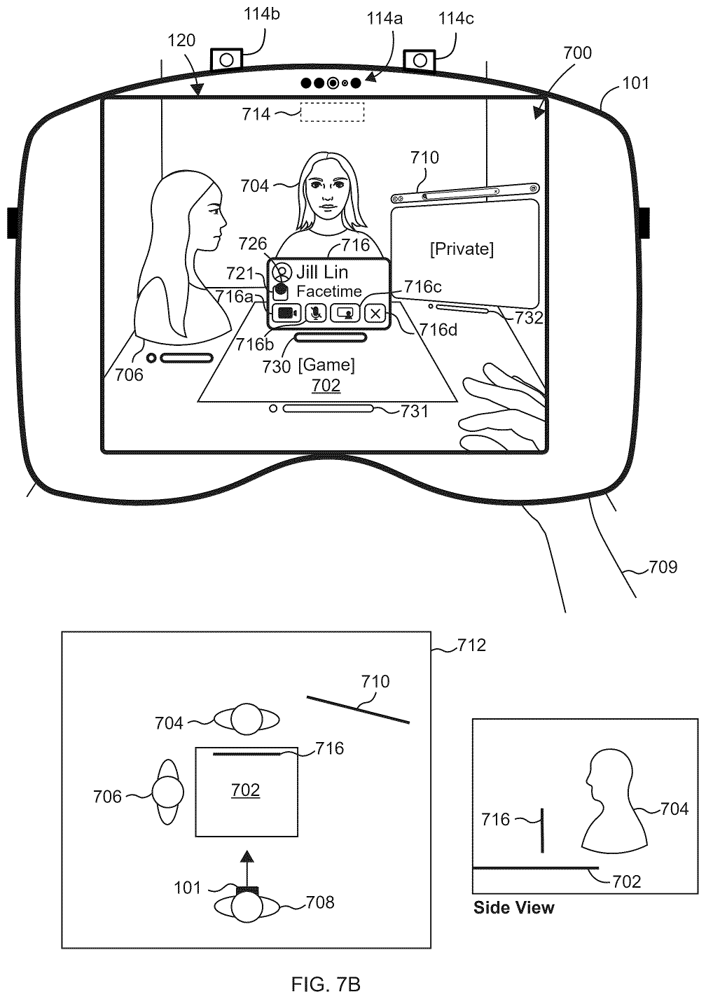

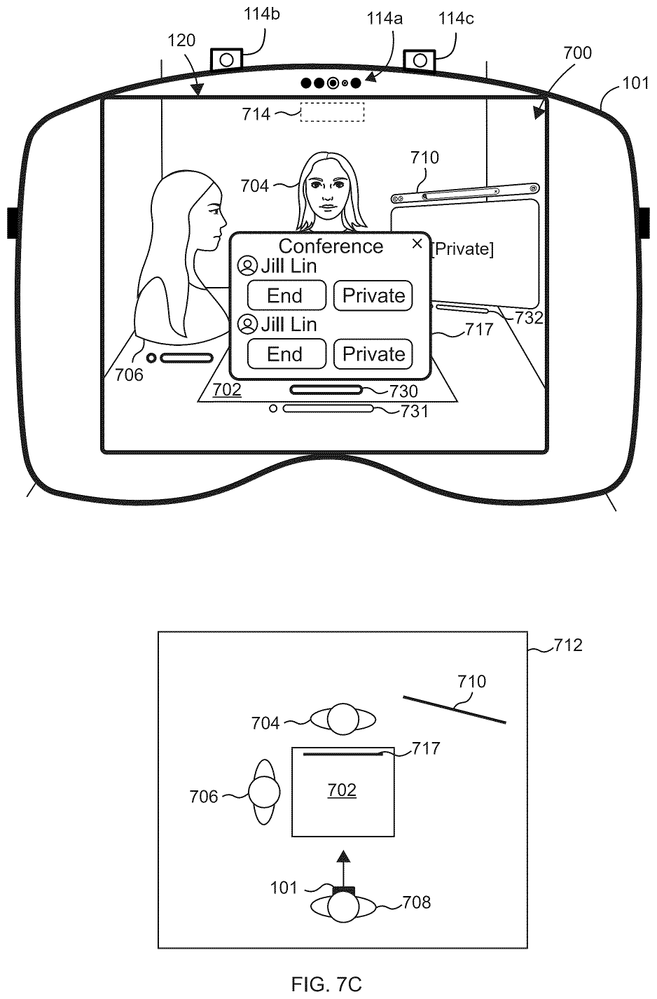

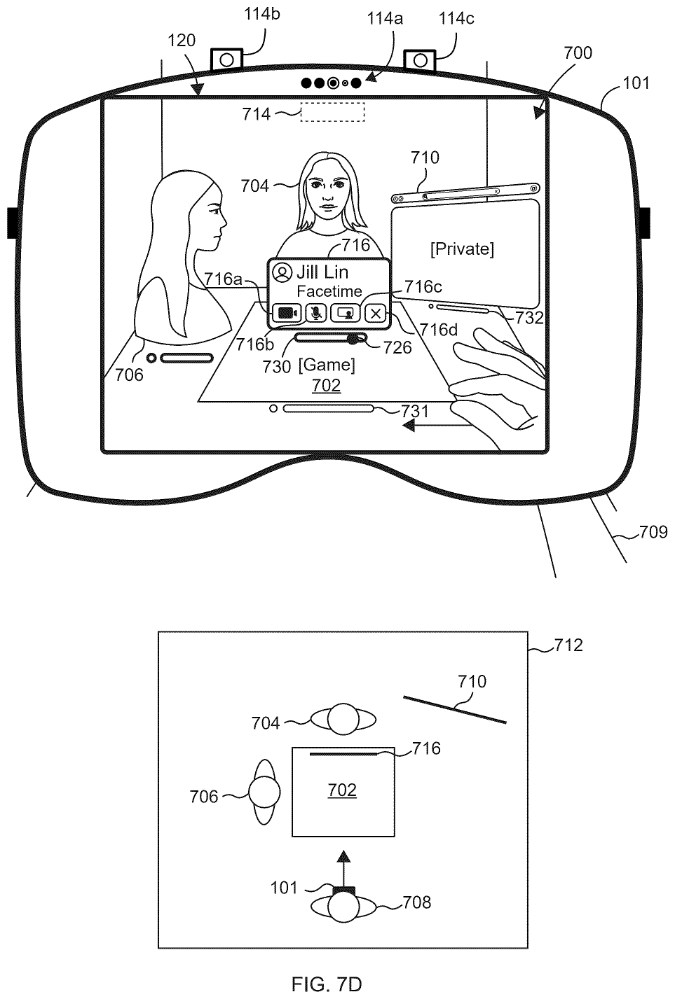

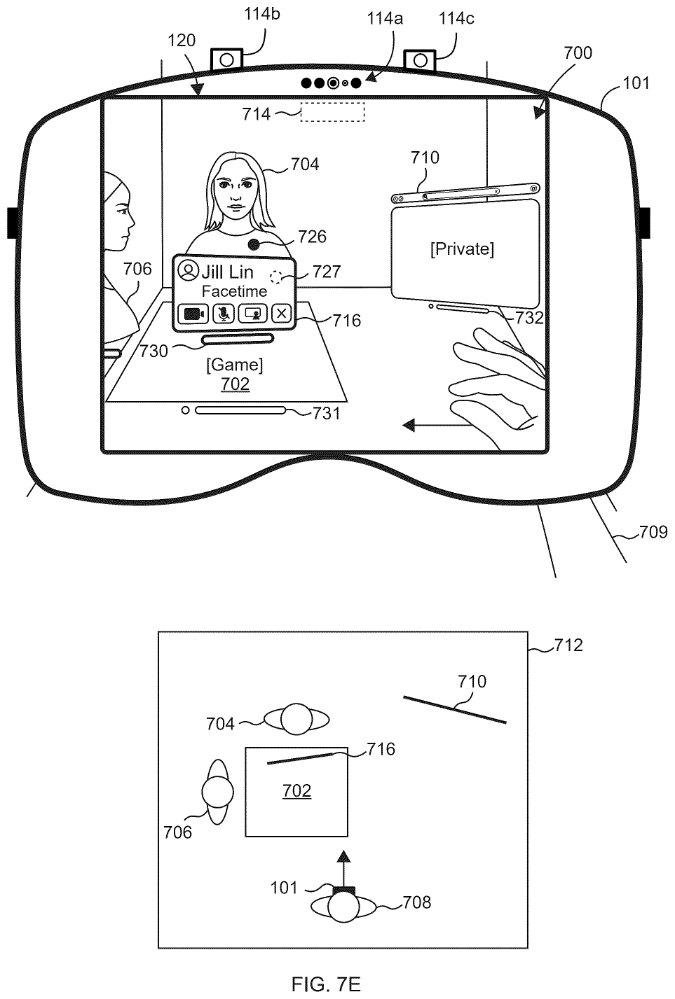

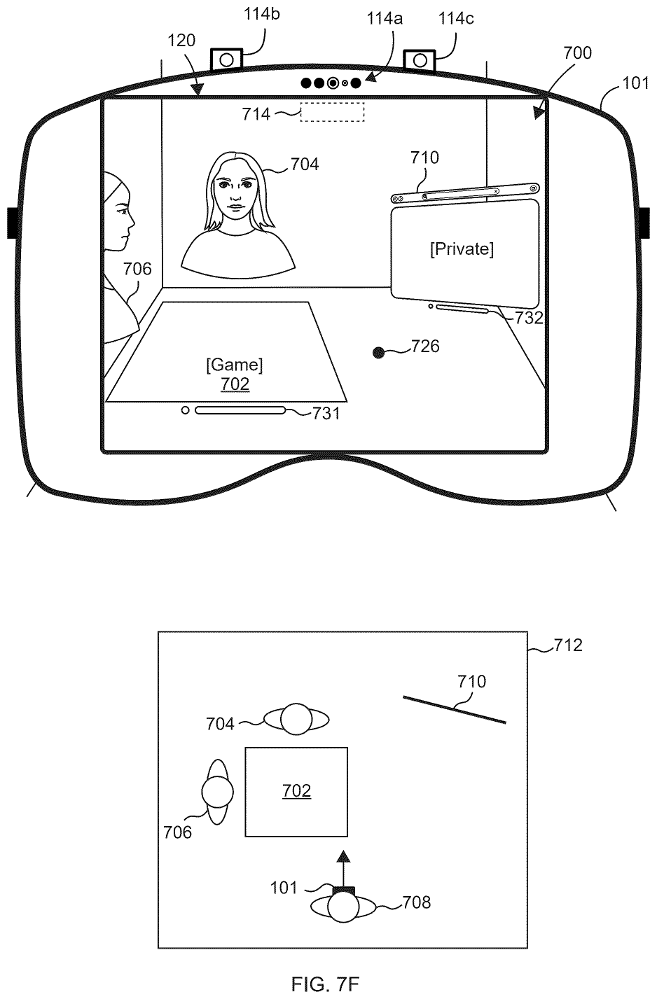

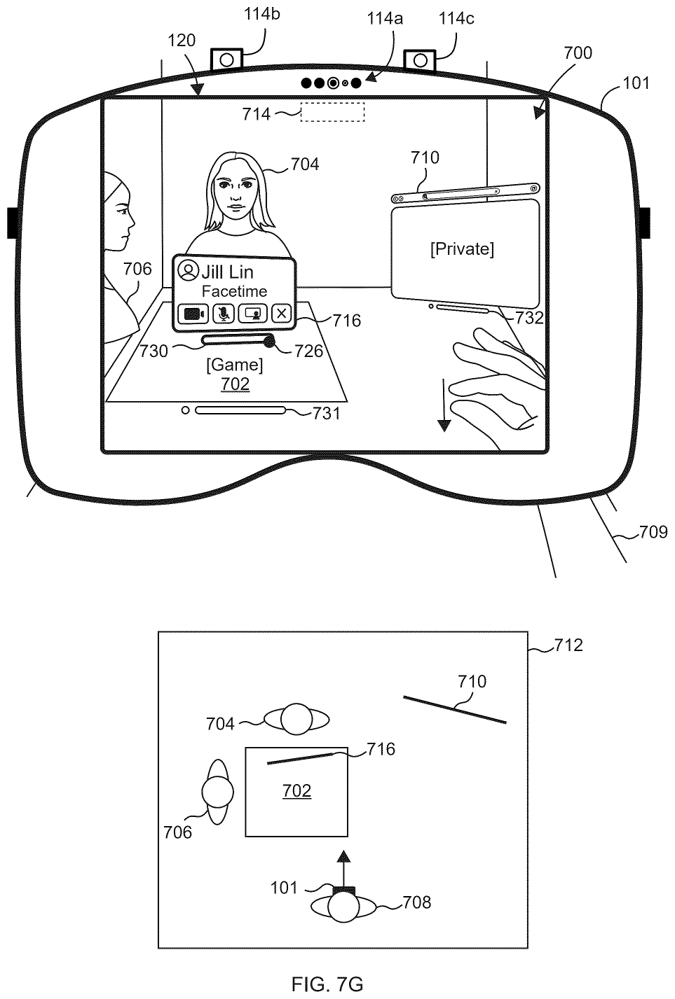

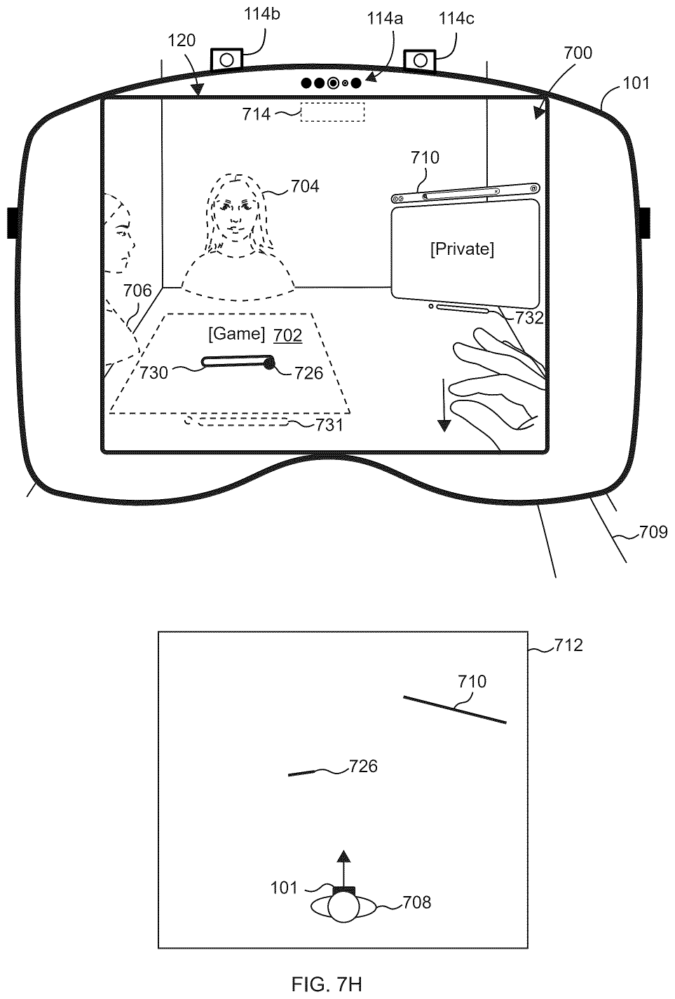

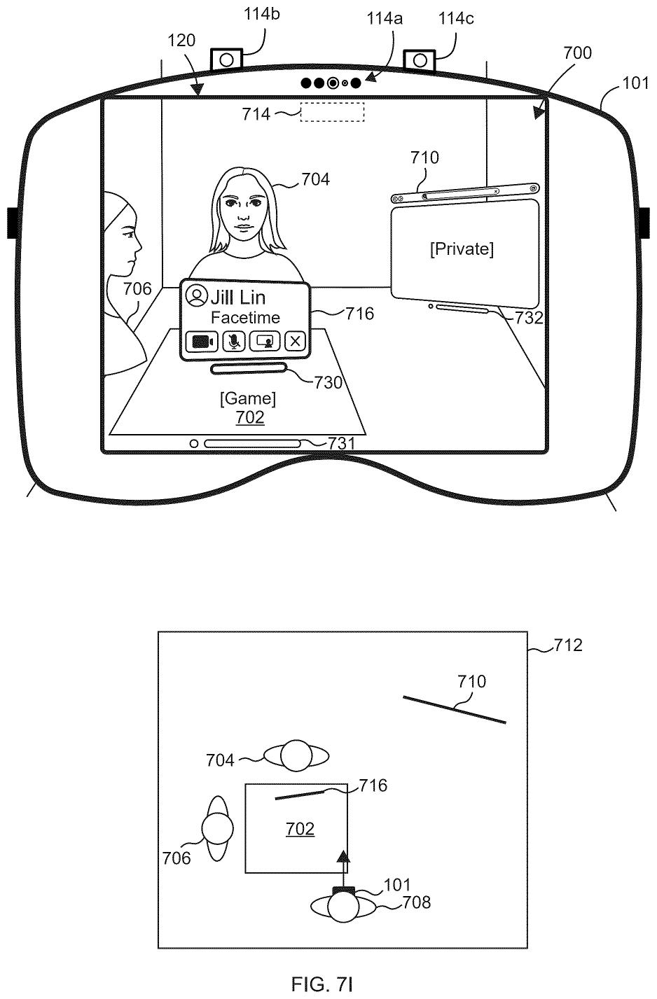

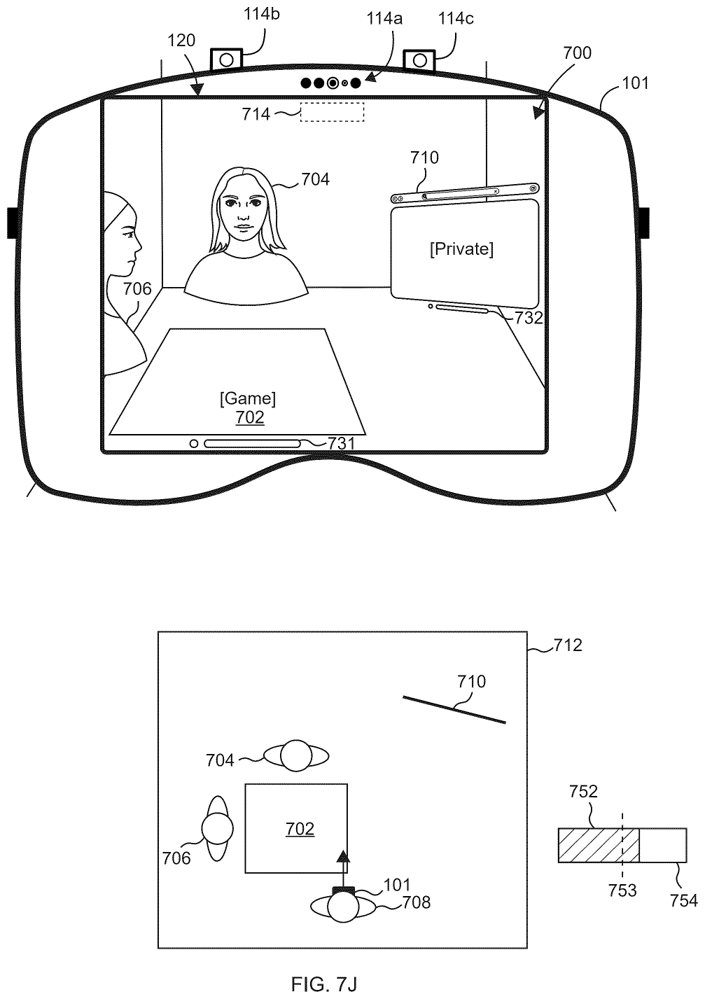

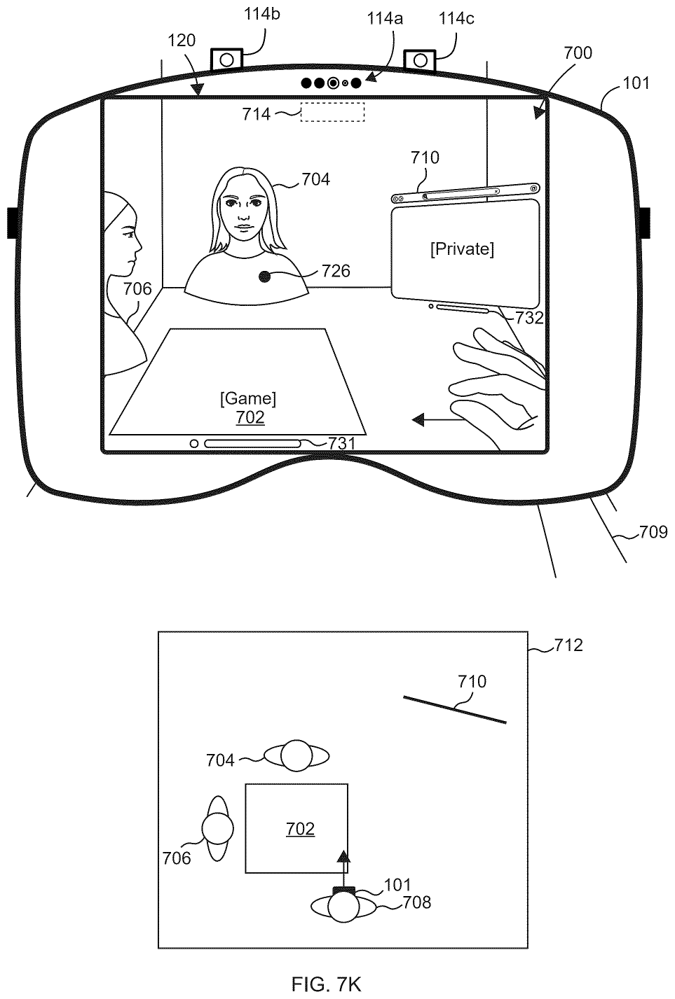

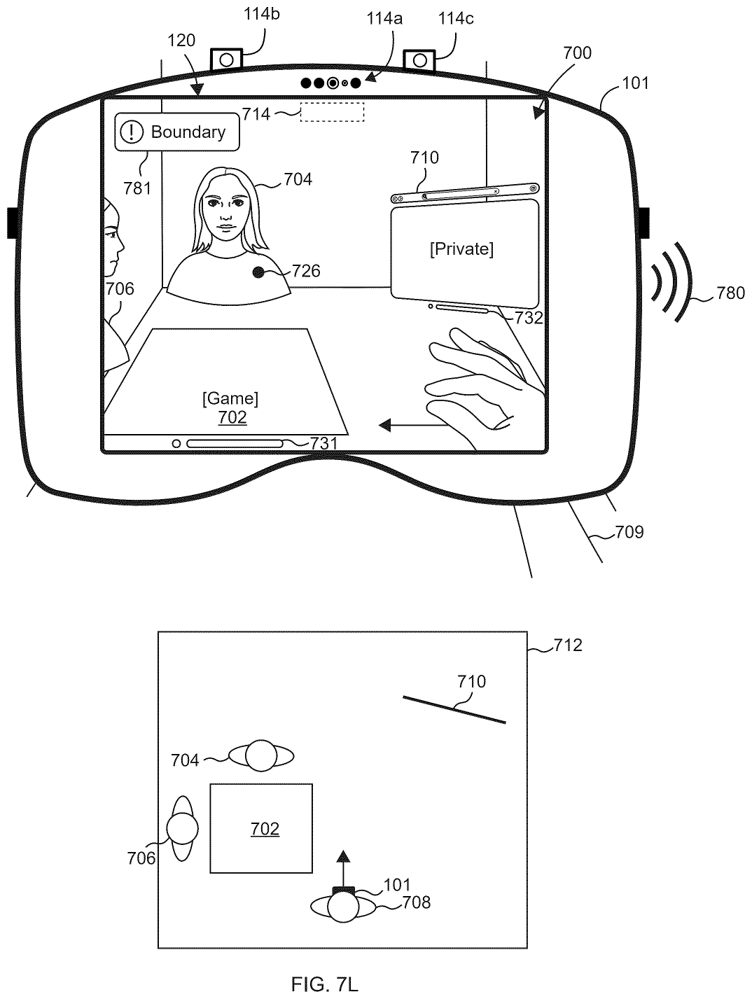

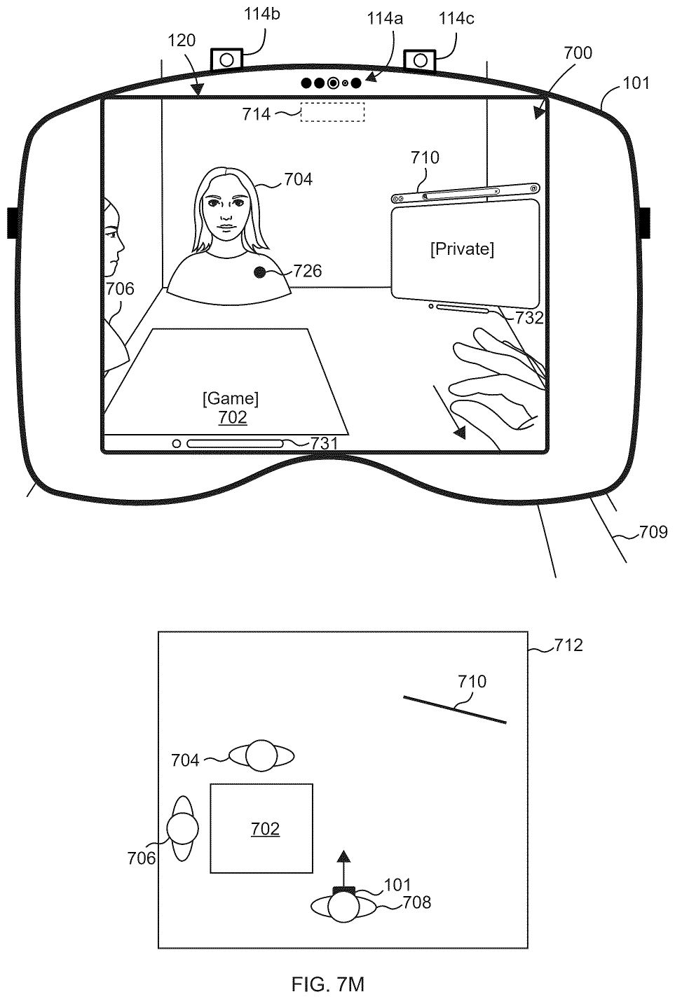

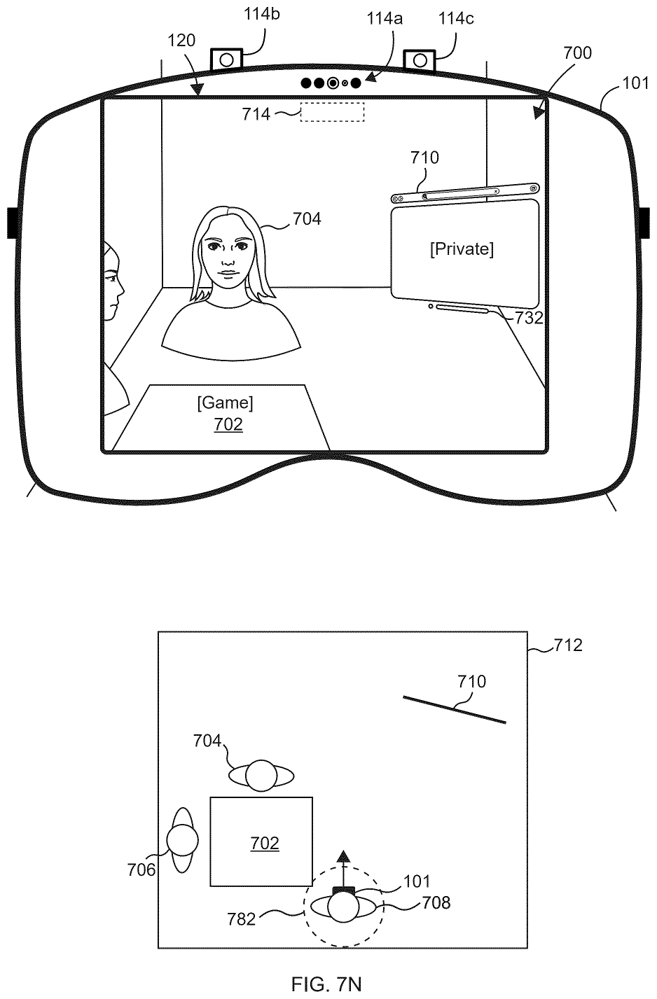

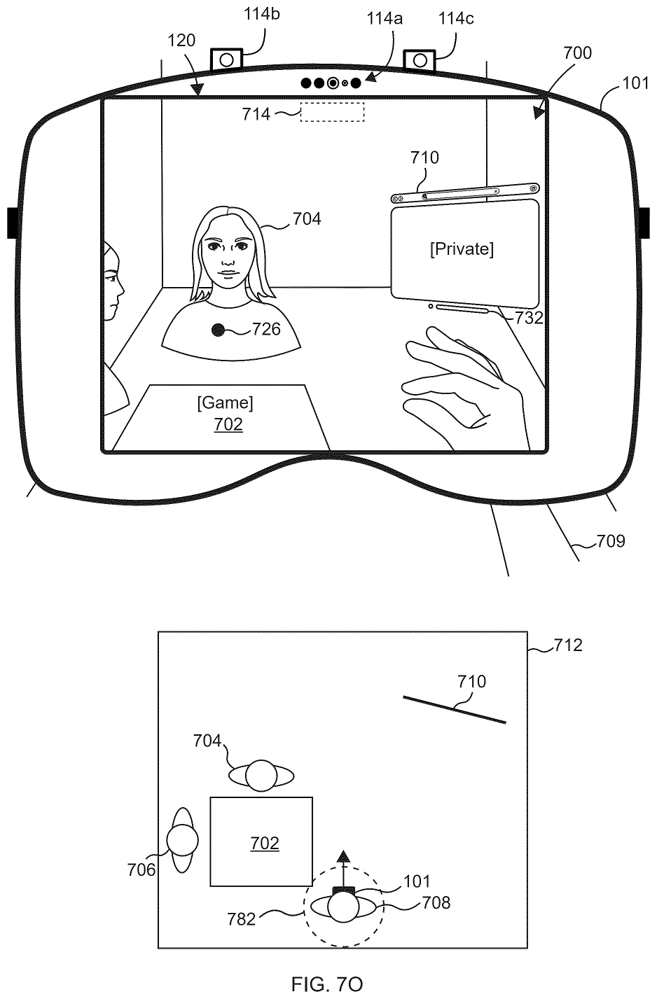

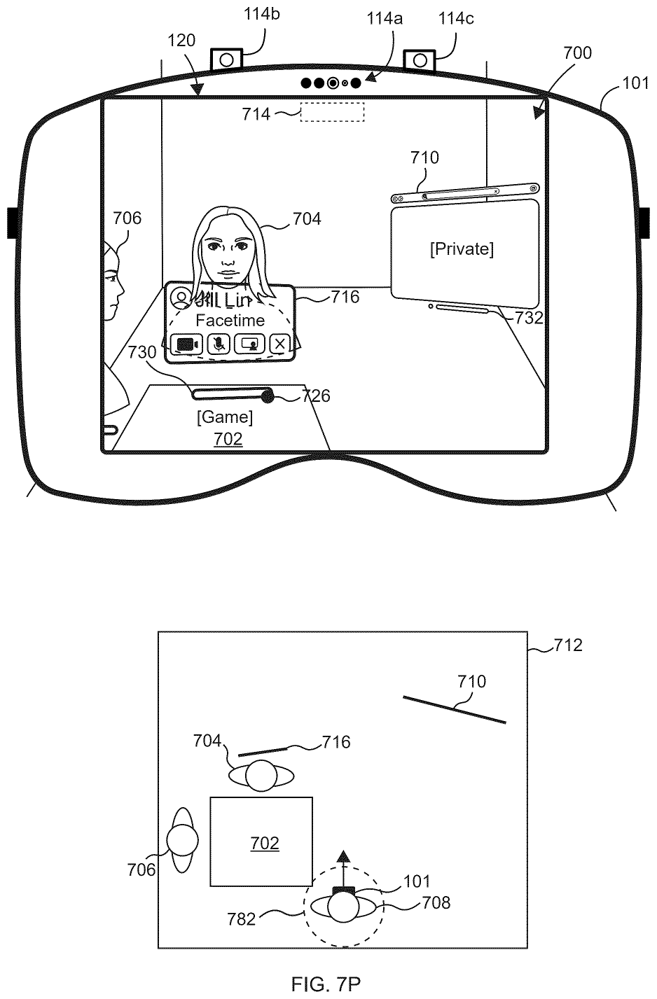

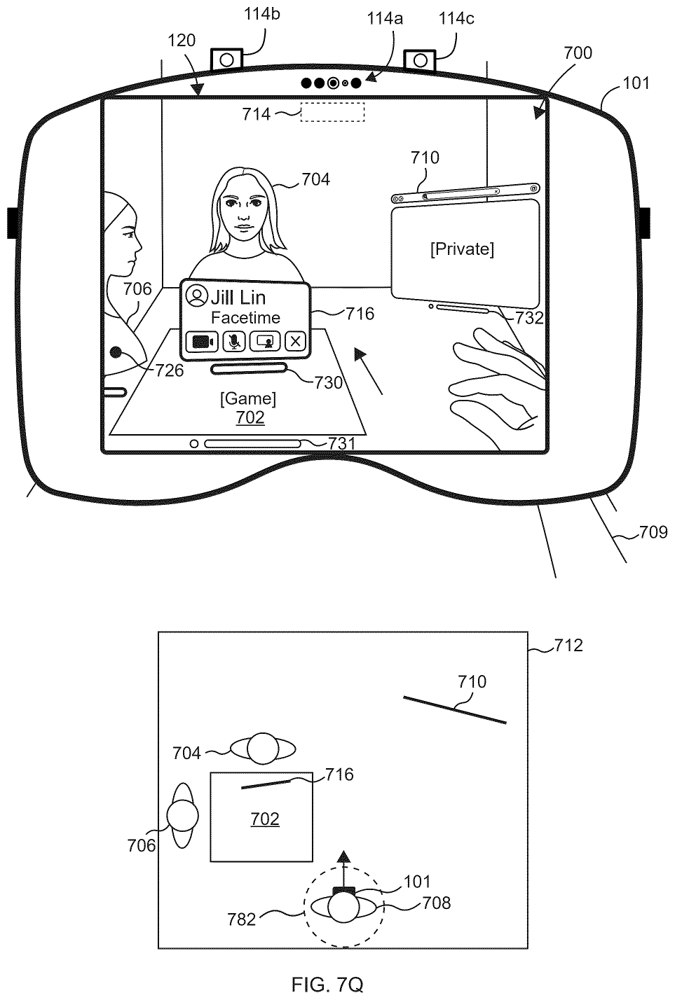

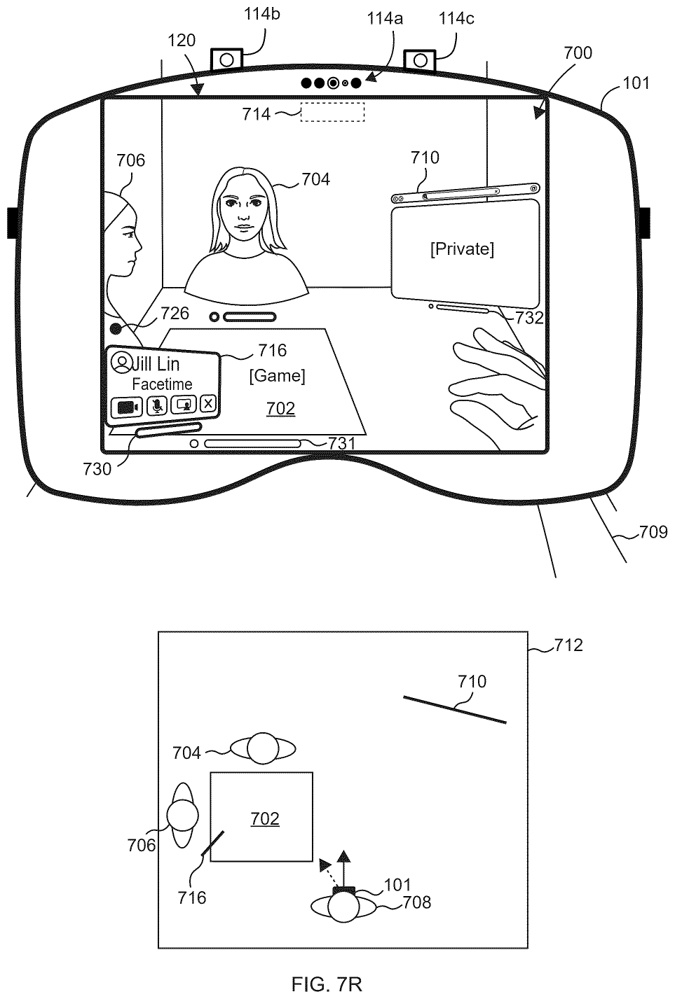

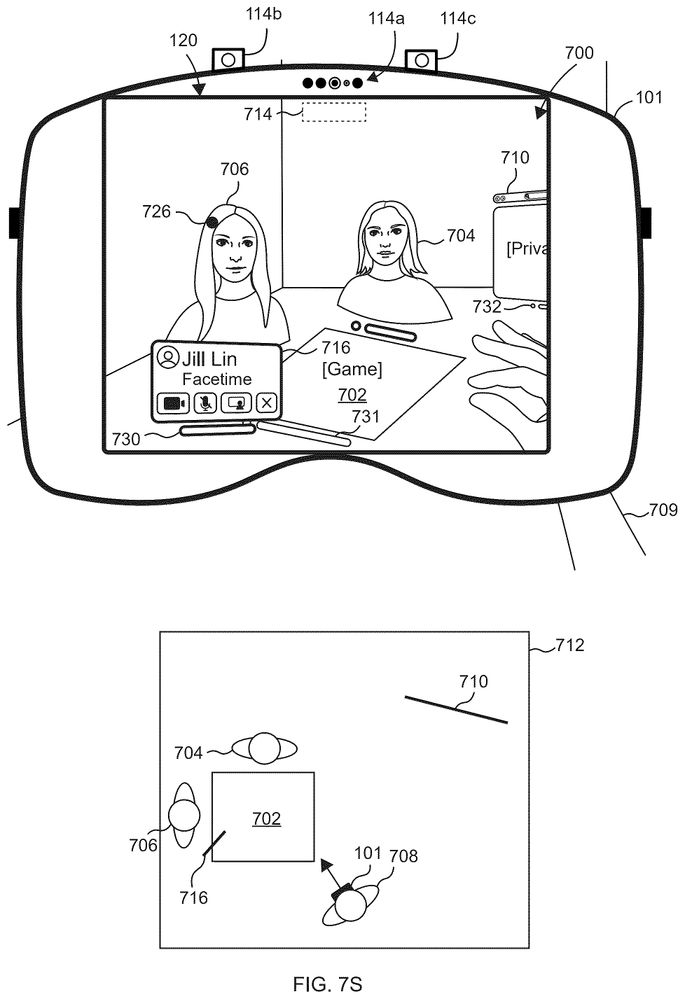

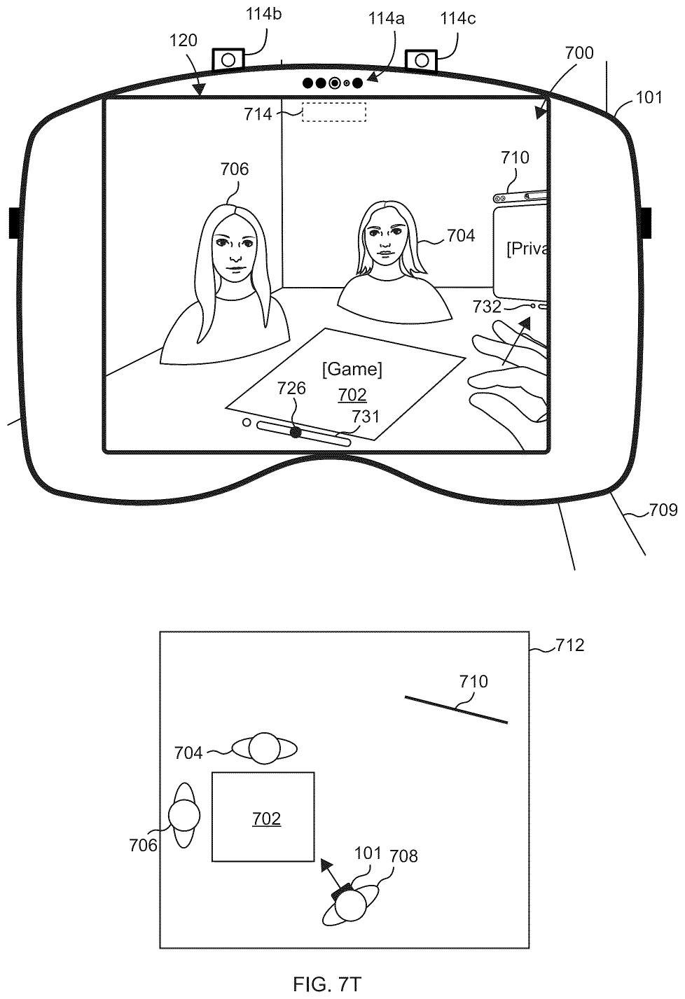

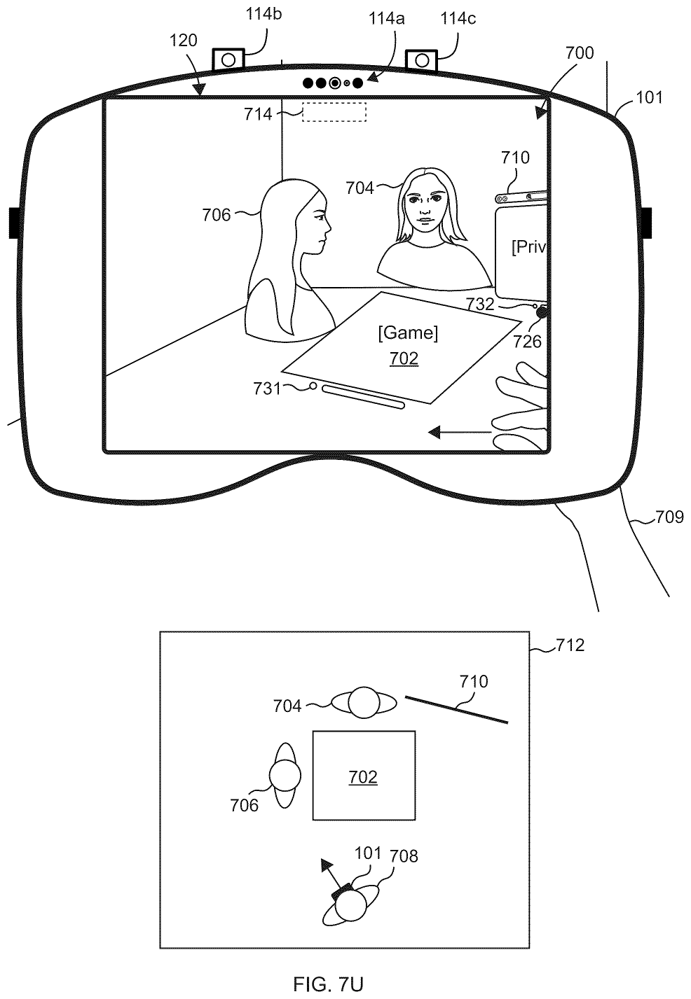

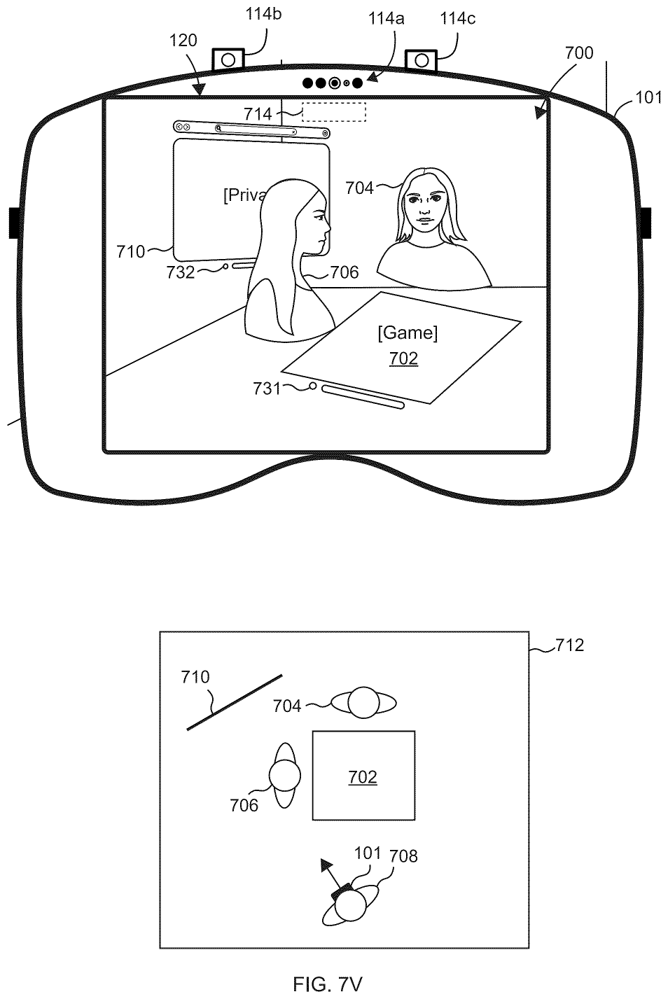

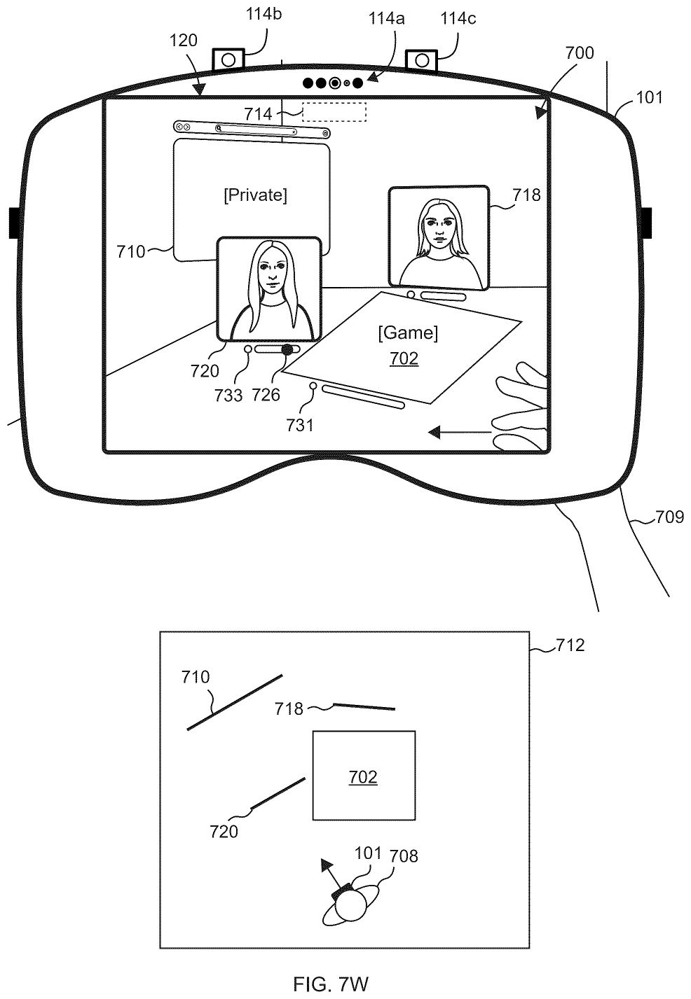

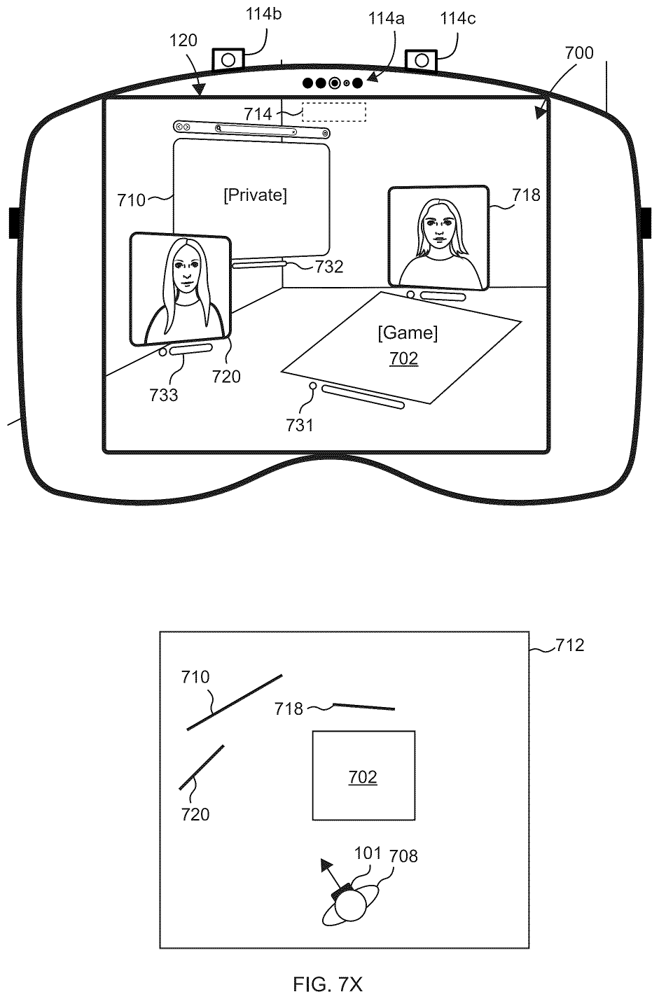

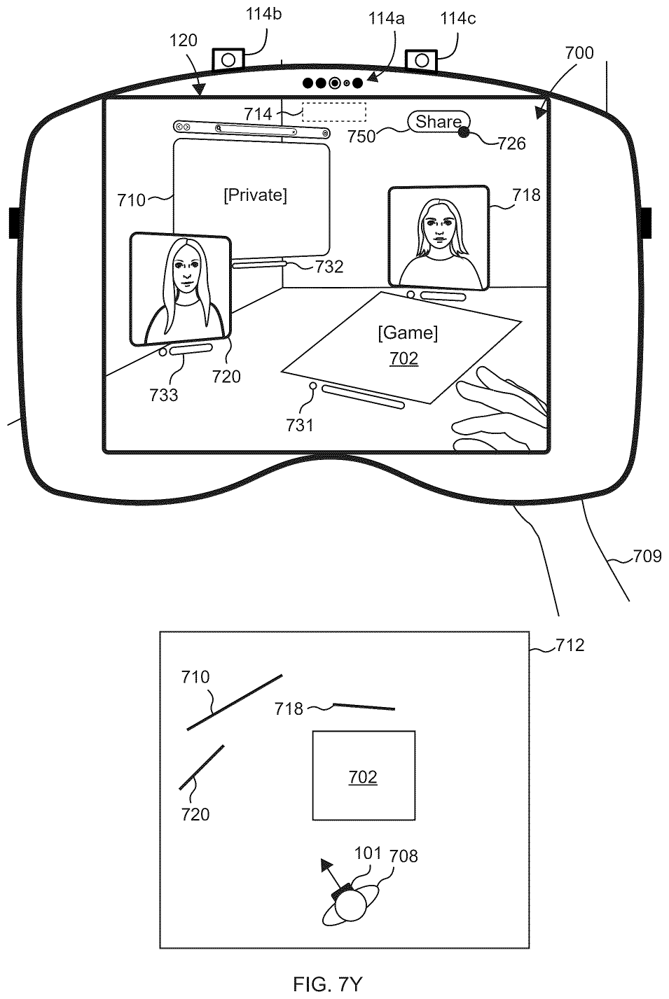

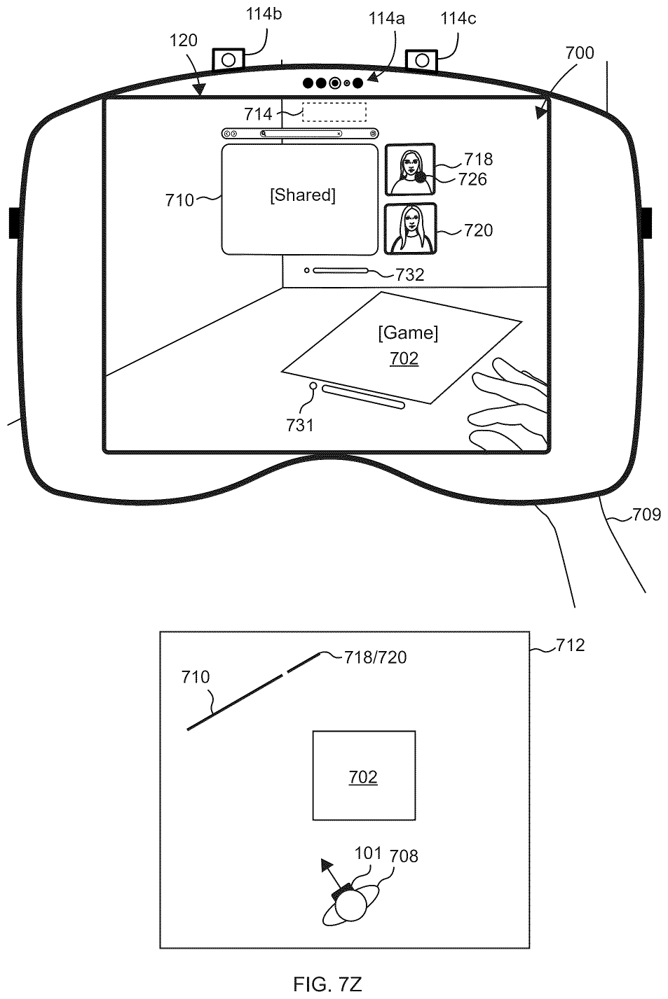

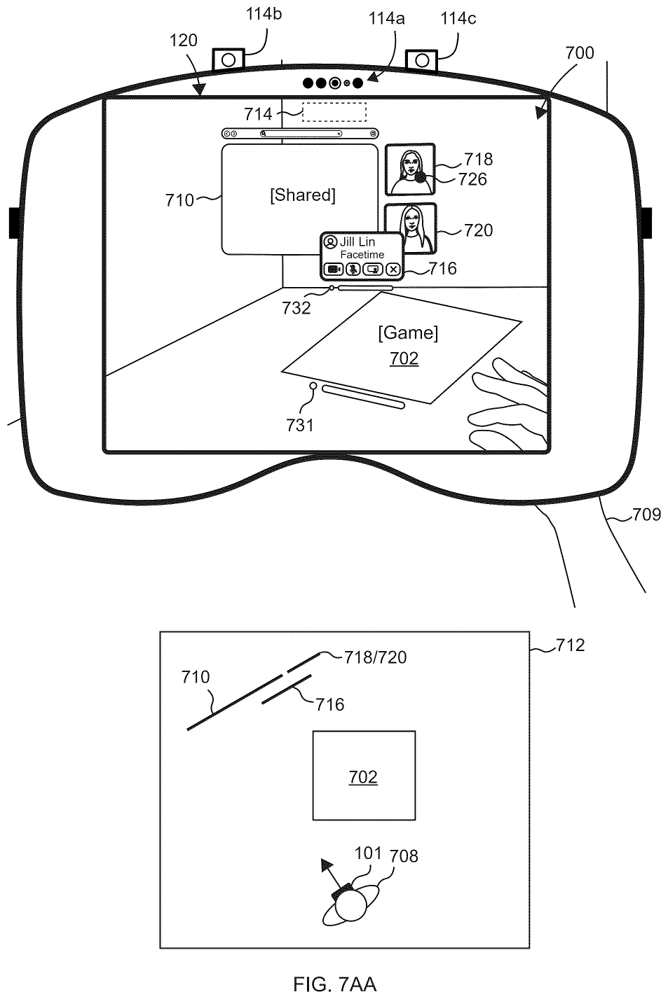

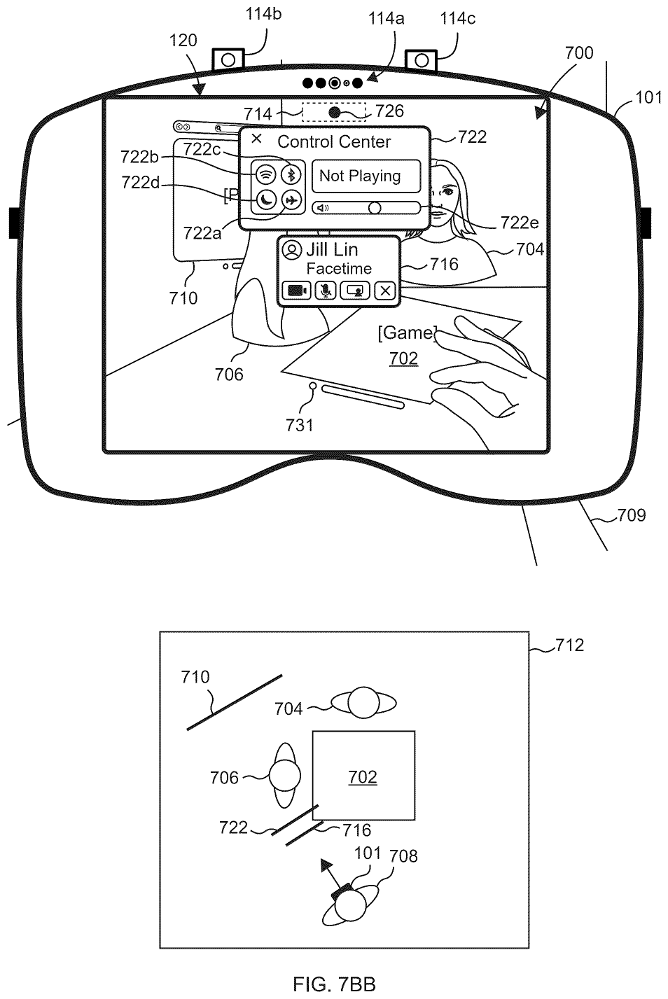

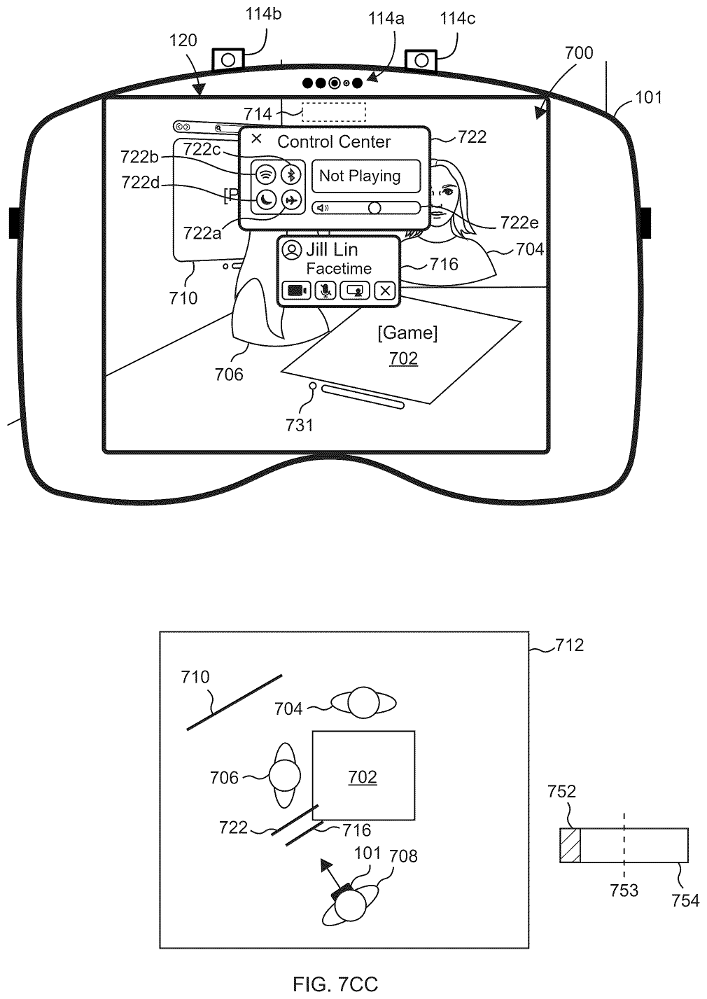

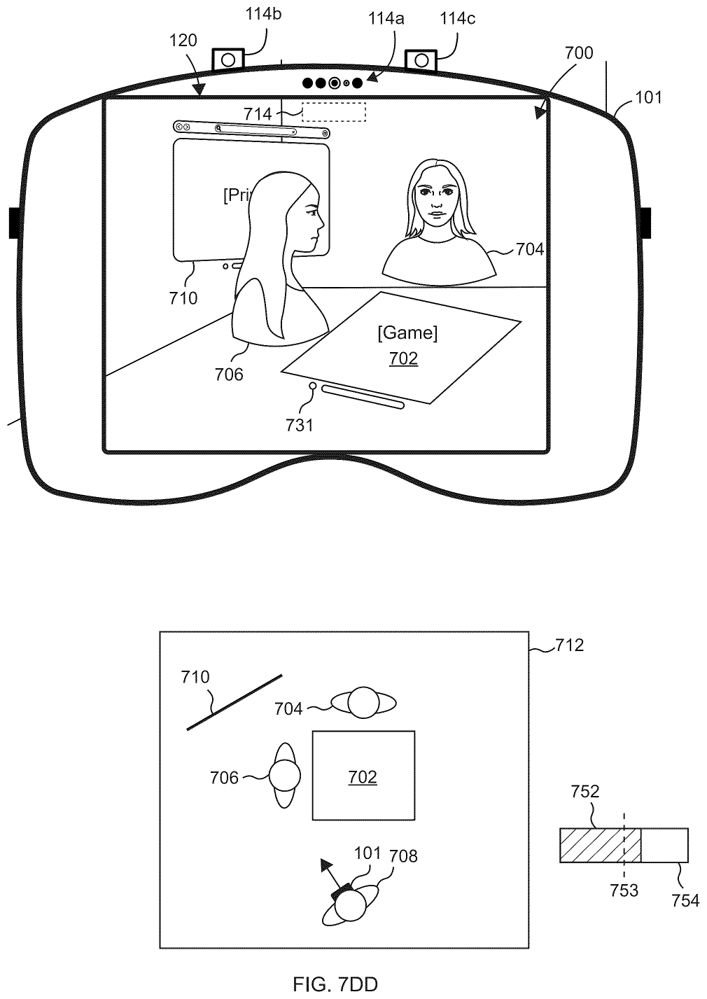

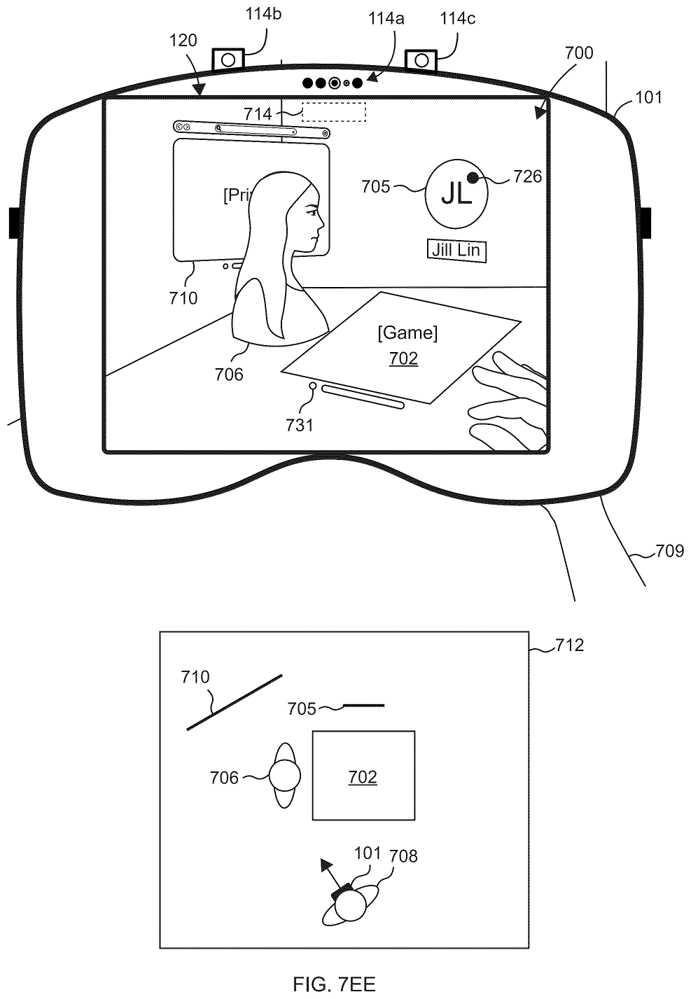

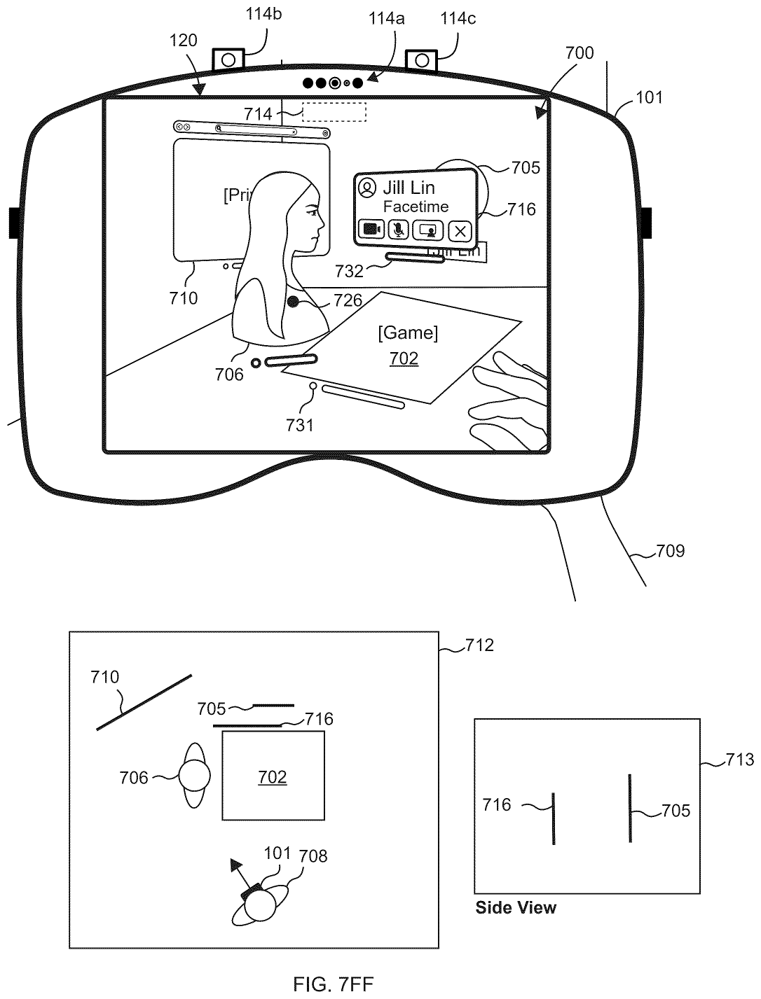

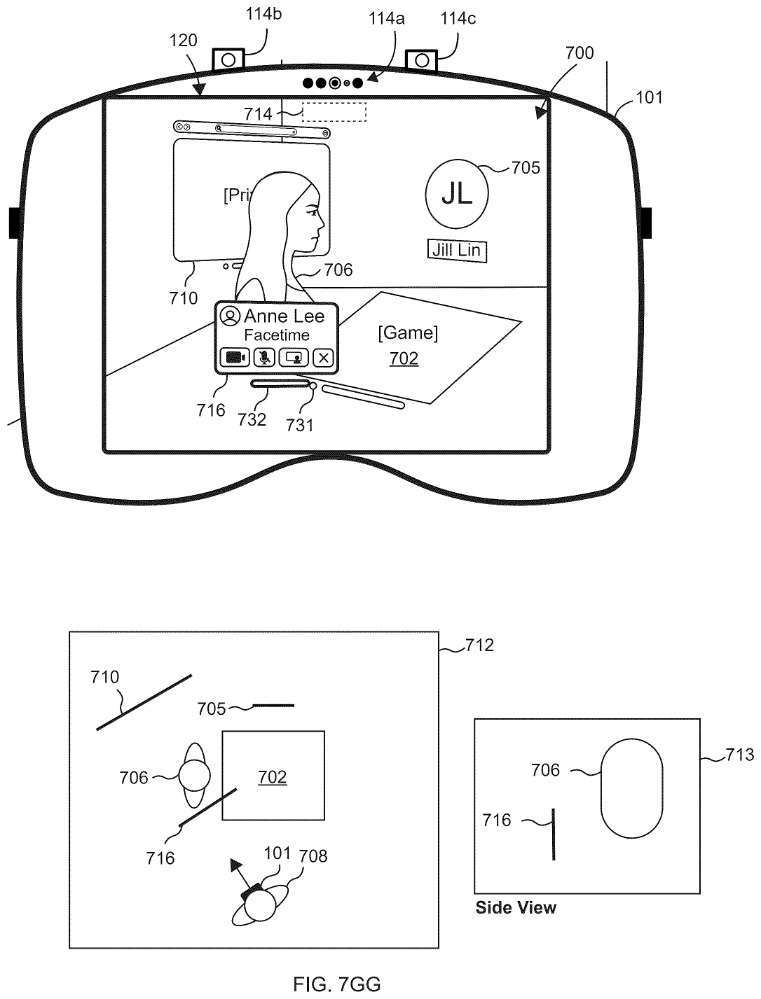

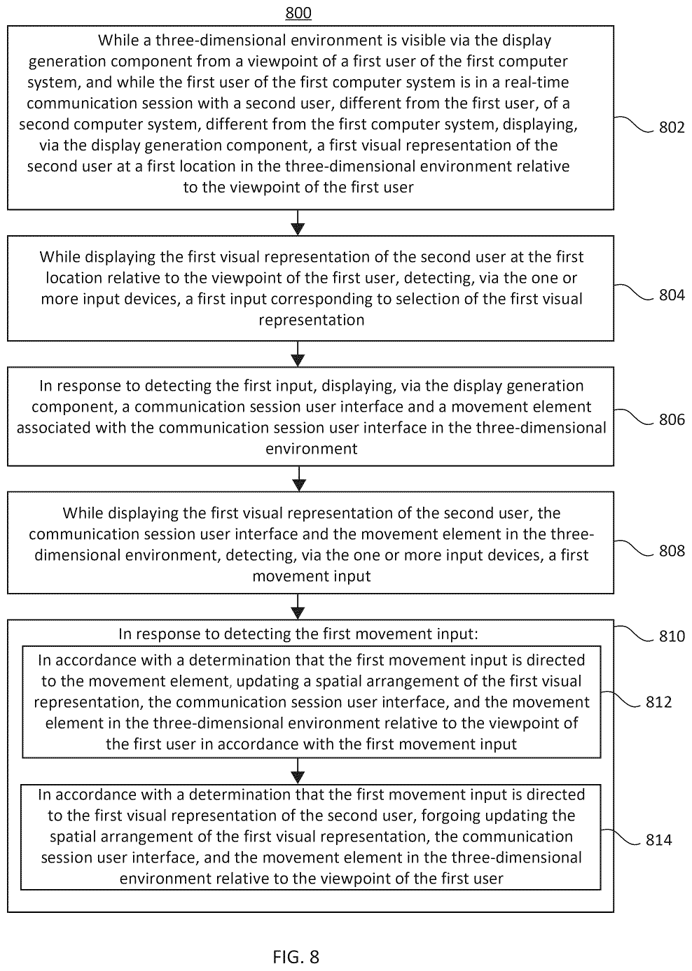

FIGS. 1A-6 provide a description of example computer systems for providing XR experiences to users (such as described below with respect to method 800). FIGS. 7A-7GG illustrate example techniques for facilitating updating the spatial arrangement of one or more virtual objects in a three-dimensional environment while in a real-time communication session that includes a plurality of users in accordance with some embodiments. FIG. 8 is a flowchart of methods of facilitating updating one or more spatial arrangements of a plurality of virtual objects in a three-dimensional environment in accordance with some embodiments. The user interfaces in FIGS. 7A-7GG are used to illustrate the processes in FIG. 8.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specfies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typcially move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objets such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environement or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movment of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

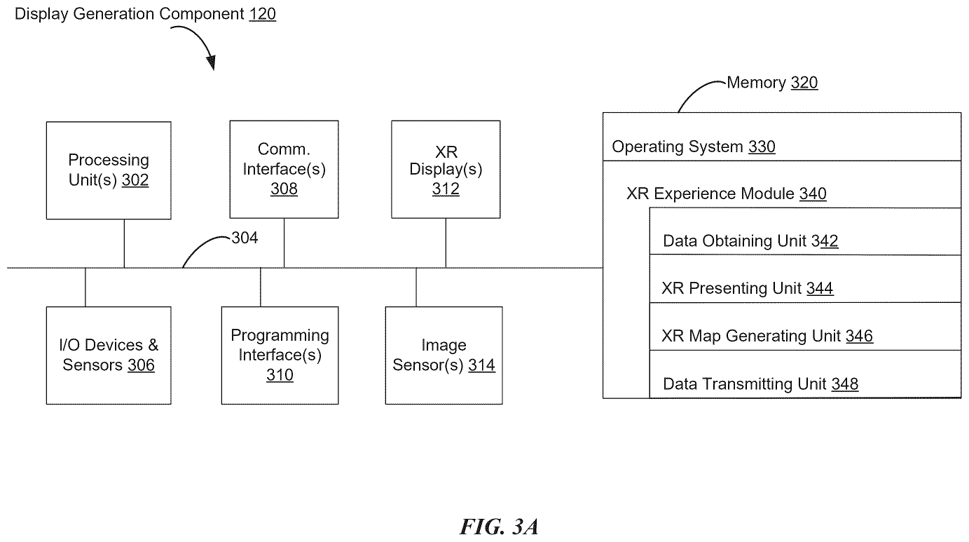

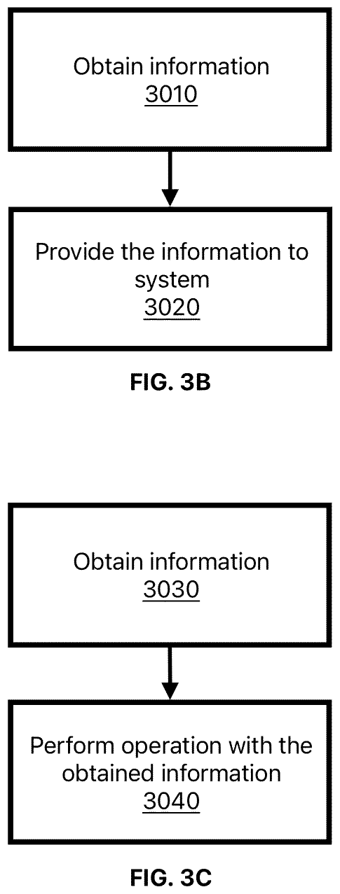

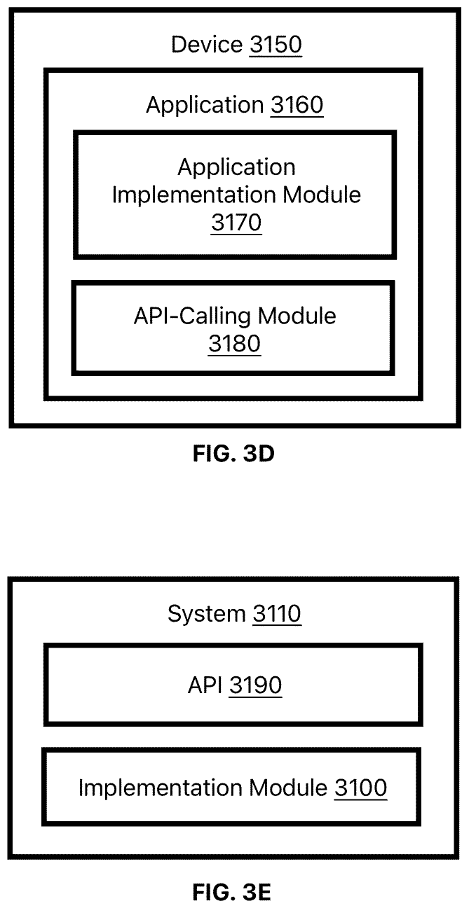

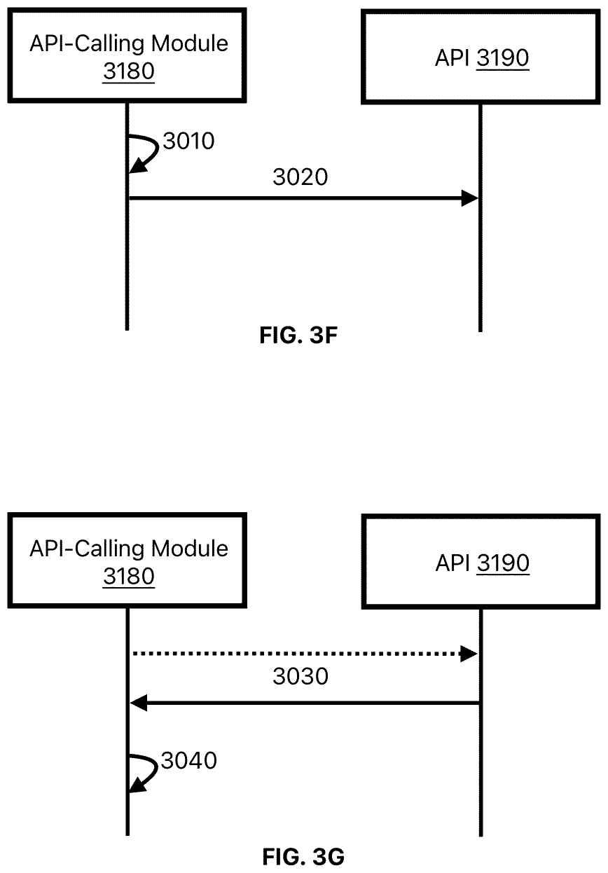

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user’ head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

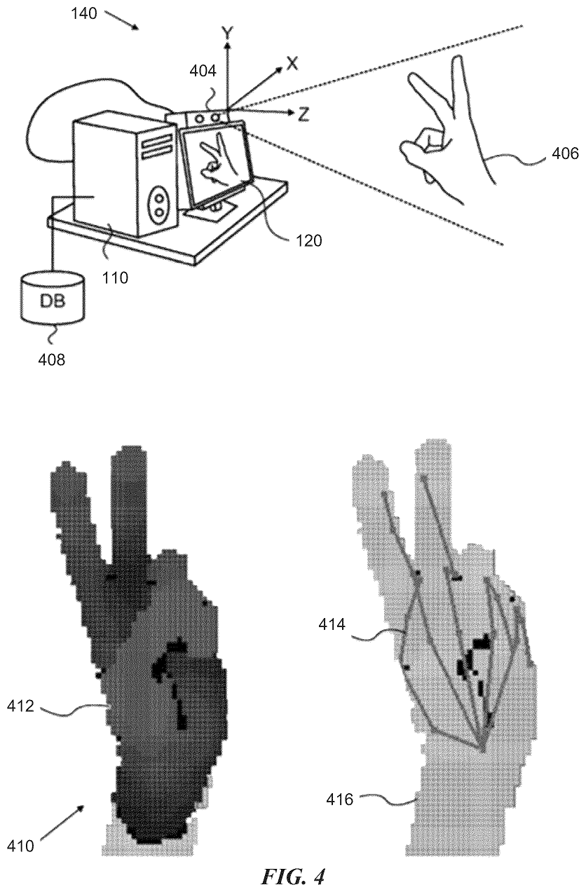

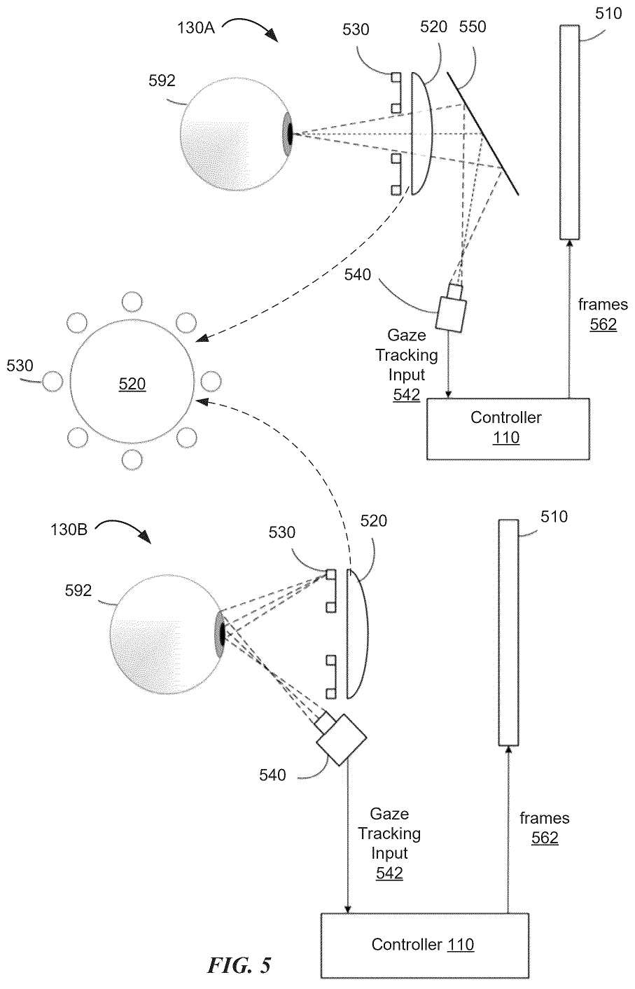

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 800 (FIG. 8) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application. FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

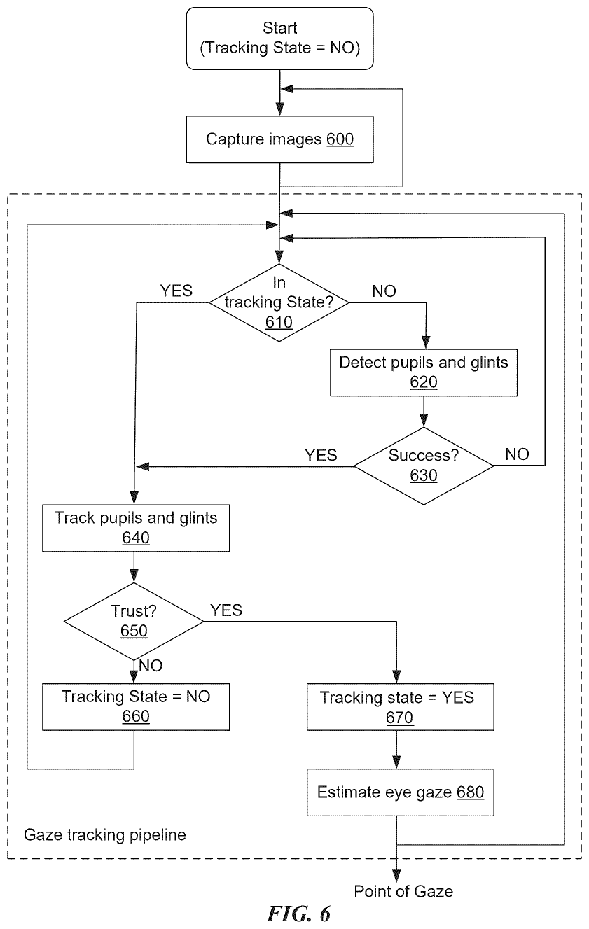

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7GG illustrate examples of a computer system facilitating updating the spatial arrangement of one or more virtual objects in a three-dimensional environment while in a real-time communication session that includes a plurality of users.

FIG. 7A illustrates a computer system 101 (e.g., an electronic device) displaying, via a display generation component 120 (e.g., display generation components 1-122a and 1-122b of FIG. 1), a three-dimensional environment 700 from a viewpoint of a first user (e.g., user 708 in overhead view 712) of the computer system 101 (e.g., facing the back wall of the physical environment in which computer system 101 is located).

In some embodiments, computer system 101 includes a display generation component 120. In FIG. 7A, the display generation component 120 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Display generation component 120 also includes external image sensors 114b and 114c facing outwards from the user to detect and/or capture the physical environment and/or movements of the user's hands.

As shown in FIG. 7A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 700. For example, three-dimensional environment 700 includes representations of the rear and side walls of the room in which the computer system 101 is located.

As discussed in more detail below, in FIG. 7A, display generation component 120 is illustrated as displaying content in the three-dimensional environment 700. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIGS. 7A-7GG.

Display generation component 120 has a field of view (e.g., a field of view captured by external image sensors 114b and 114c and/or visible to the user via display generation component 120) that corresponds to the content shown in FIG. 7A. Because display generation component 120 is optionally a head-mounted device, the field of view of display generation component 120 is optionally the same as or similar to the field of view of the user. For example, the view of three-dimensional environment 700 depicts what is visible to the user 708 (via display generation component 120) when the viewpoint of the user 708 is located as shown in the overhead view 712 and the computer system 101 is oriented in the direction indicated by the direction arrow emanating from the computer system 101 in the overhead view 712.

As discussed herein, the user 708 performs one or more air pinch gestures (e.g., with hand 709) to provide one or more inputs to computer system 101 to provide one or more user inputs directed to virtual objects displayed by computer system 101. Such depiction is intended to be exemplary rather than limiting; the user optionally provides user inputs using different air gestures and/or using other forms of input.

In the example of FIG. 7A, because the user's hand 709 is within the field of view of display generation component 120, it is visible within the three-dimensional environment 700. That is, the user can optionally see, in the three-dimensional environment, any portion of their own body that is within the field of view of display generation component 120.

As mentioned above, the computer system 101 is configured to display content in the three-dimensional environment 700 using the display generation component 120. In FIG. 7A, three-dimensional environment 700 also includes a plurality of virtual objects. For example, as shown in FIG. 7A, the three-dimensional environment 700 includes virtual object 702 and virtual object 710.

In some embodiments, the virtual object 710 is optionally a user interface of an application containing content. For example, in FIG. 7A, the virtual object 710 is a user interface of a web-browsing application containing website content, such as text, images, video, hyperlinks, and/or audio content, from the website, or a user interface of an audio playback application including a list of selectable categories of music and a plurality of selectable user interface objects corresponding to a plurality of albums of music. In some embodiments, the virtual object 702 is a user interface of a game application containing gaming content, such as a virtual boardgame containing virtual game pieces and/or other virtual elements. Additionally, in some embodiments, as shown in FIG. 7A, the virtual objects 710 and 702 are each displayed with an exit option and a grabber bar. In some embodiments, the grabber bar is selectable to initiate a process to move the virtual object 710 or the virtual object 702 within the three-dimensional environment 700. It should be understood that the content discussed above is exemplary and that, in some embodiments, additional and/or alternative content and/or user interfaces are provided in the three-dimensional environment 700, such as three-dimensional objects (e.g., virtual clocks, virtual balls, virtual cars, etc.) or any other element displayed by computer system 101 that is not included in the physical environment of display generation component 120.

In some embodiments, virtual objects 702 and 710 are displayed in three-dimensional environment 700 with respective orientations relative to a viewpoint of user 708 (e.g., prior to receiving input interacting with the virtual objects, which will be described later, in three-dimensional environment 700). As shown in FIG. 7A, for example, the virtual object 702 has a first orientation in the three-dimensional environment 700 (e.g., the front-facing surface/edge of the virtual object 702 that faces the viewpoint of user 708 is flat relative to the viewpoint of user 708). Additionally, the virtual object 710 optionally has a second orientation in the three-dimensional environment 700 (e.g., the front-facing surface of the virtual object 710 is angled rightward relative to the viewpoint of user 708). It should be understood that the orientation of any of the virtual objects in FIG. 7A is merely exemplary and that other orientations are possible.

In some embodiments, virtual objects 702 and 710 are displayed in three-dimensional environment 700 with respective sizes relative to a viewpoint of user 708 (e.g., prior to receiving input interacting with the virtual objects, which will be described later, in three-dimensional environment 700). As shown in FIG. 7A, for example, the virtual object 702 optionally has a first size in the three-dimensional environment 700 (e.g., determined by a width and/or length (e.g., an area) of the two-dimensional top surface of the virtual object 702 from the viewpoint of the user 708). Additionally, as shown in FIG. 7A, the virtual object 710 optionally has a second size in the three-dimensional environment 700 (e.g., determined by a width and/or height (e.g., an area) of the two-dimensional front-facing surface that faces the viewpoint of the user 708). It should be understood that the initial sizes of the virtual objects 702 and 710 in FIG. 7A are merely exemplary and that other sizes are possible (e.g., based on object type, a distance to the virtual object from the viewpoint of the user 708, and/or a dimensionality of the virtual object).

In some embodiments, virtual objects 702 and 710 are displayed in three-dimensional environment 700 at respective locations relative to the viewpoint of the user 708 (e.g., prior to receiving input interacting with the virtual objects, which will be described later, in three-dimensional environment 700). As shown in FIG. 7A, for example, the virtual object 702 is optionally displayed at a first location in the three-dimensional environment 700 (e.g., at a location centrally ahead of the viewpoint of the user 708, as indicated in the overhead view 712 in FIG. 7A). Additionally, in some embodiments, the virtual object 710 is located at a second location in the three-dimensional environment 700 (e.g., at a location to the right of and farther than the virtual object 702 relative to the viewpoint of the user 708, as indicated in the overhead view 712 in FIG. 7A). It should be understood that the initial locations of the virtual objects 702 and 710 in FIG. 7A are merely exemplary and that other locations are possible (e.g., based on object type, prior input directed to the virtual object provided by the user 708, and/or the application with which the virtual object is associated).

In some embodiments, the display generation component 120 includes predefined region 714 that is interactive to cause the computer system 101 to display system controls for the three-dimensional environment 700. For example, the predefined region 714 is a predefined portion of the three-dimensional environment 700 in which the system controls are displayed, such as the upper right edge or upper center of the three-dimensional environment 700. In some embodiments, as discussed in more detail below, in response to detecting input directed to the predefined region 714, the computer system 101 displays a system controls user interface 722 as an overlay to the user's current view of the three-dimensional environment 700. In some embodiments, the system controls user interface includes various user interface elements, such as controls, images, or system information (e.g., time, date, program information, text, cellular information, Wi-Fi connection, Bluetooth connectivity, and/or battery level).

FIG. 7A depicts an example in which three users are participating in a real-time communication session. For example, as indicated in the overhead view 712, the real-time communication session includes user 708, a second user (e.g., a user of a second computer system, different from the computer system 101), and a third user (e.g., a user of a third computer system, different from the computer system 101 and the second computer system). In some embodiments, while the three users are participating in the real-time communication session, the computer system 101 displays visual representations of the second user 704 and the third user 706 in the three-dimensional environment 700 from the viewpoint of the user 708. For example, as shown in FIG. 7A, the three-dimensional environment 700 includes a first representation 704 (e.g., an avatar) of the second user and a second representation 706 of the third user. In some embodiments, the user 708, the first representation 704 of the second user and the representation 706 of the third user in overhead view 712 correspond to positions (e.g., location and/or orientation (e.g., orientation is represented by arrows extending from the representations of the users in overhead view 712)) of the current viewpoints of the user 708, the second user and the third user relative to the three-dimensional environment 700. Details regarding the first representation 704 and the second representation 706 are provided below with reference to method 800. In the example of FIG. 7A, the participants are optionally not arranged according to a template (e.g., they are not arranged by computer system 101), and are instead at respective locations within the three-dimensional environment that have been chosen by the respective participants, such as by the participants moving within their respective physical environments (e.g., as detected by their respective computer systems) and/or by user 708 providing inputs as discussed further below.

In some embodiments, virtual elements in the three-dimensional environment 700 have a spatial arrangement that is based on positions of the virtual elements relative to the three-dimensional environment 700. For example, as illustrated by their corresponding positions in the overhead view 712 in FIG. 7A, the viewpoint of the user 708, the first representation 704 of the second user, the second representation 706 of the third user, the virtual object 702, and the virtual object 710 have a first spatial arrangement in the three-dimensional environment 700.

In some embodiments, while in the real-time communication session, a participant of the real-time communication session (e.g., user 708) is able to share content with other participants in the real-time communication session. For example, in FIG. 7A, the virtual object 702 corresponds to an object that is shared with the second user and the third user in the real-time communication session (e.g., the virtual object 702 corresponds to a shared game). In some embodiments, as described in more detail with reference to method 800, because the virtual object 702 corresponds to a shared object in the real-time communication session (e.g., shared by the user 708), the second computer system of the second user and the third computer system of the third user display the virtual object 702 in their respective three-dimensional environments. Accordingly, in some embodiments, the virtual object 702 is viewable by and/or interactive to the user 708, the second user, and the third user via their respective computer systems (e.g., including computer system 101). In some embodiments, while in the real-time communication session, a participant of the real-time communication session (e.g., user 708) is able to view and/or interact with content that private to the participant. For example, in FIG. 7A, the virtual object 710 corresponds to an object that is private to the user 708 (e.g., the virtual object 710 corresponds to a private application window). In some embodiments, as described in more detail with reference to method 800, because the virtual object 710 is private to the user 708 in the real-time communication session, the virtual object 710 is not displayed in the three-dimensional environments of the second computer system and the third computer system (e.g., and is therefore not visible to and/or interactive to the second user and the third user).

In some embodiments, the computer system 101 facilitates updating of the spatial arrangement of the virtual elements of the three-dimensional environment 700. For example, as discussed in more detail below, the computer system 101 is configured to display a communication session user interface and a grabber bar that is associated with the communication session user interface in the three-dimensional environment 700. In some embodiments, input directed to the grabber bar causes the computer system 101 to update the spatial arrangement of the virtual elements in the three-dimensional environment 700 in accordance with the input. In some embodiments, input that is directed to other virtual elements, such as a representation of a user or a private object, does not cause the computer system 101 to update the spatial arrangement of the virtual elements in the three-dimensional environment 700. Additional details of the above and below with respect to updating the spatial arrangement of the virtual elements in the three-dimensional environment 700 are provided with reference to method 800.

In FIG. 7A, the computer system 101 detects an input provided by hand 709 corresponding to a selection of the first representation 704 of the second user in the three-dimensional environment 700. For example, as shown in FIG. 7A, the computer system 101 detects hand 709 provide an air gesture, such as an air pinch gesture in which an index finger and thumb of the hand 709 of the user 708 come together to make contact, while a gaze 726 of the user 708 is directed to the first representation 704. In some embodiments, as shown in FIG. 7A, the computer system 101 detects the hand 709 provide the air pinch gesture without detecting movement of the hand 709 in space.

In some embodiments, as shown in FIG. 7B, in response to detecting the input provided by hand 709 corresponding to the selection of the first representation 704, the computer system 101 displays communication session user interface 716 in the three-dimensional environment 700. In some embodiments, the communication session user interface 716 includes interactive elements 716a-e for controlling one or more functionalities of the communication session between users and a name associated with a user in the communication session. In this example, as shown in FIG. 7B, the name displayed by the communication session user interface (e.g., Jill Lin) corresponds to the second user. In some embodiments, interactive element 716a is an option that, when selected, initializes a video-conferencing interface in the three-dimensional environment 700 (e.g., causing the user 708 (e.g., Jill Lin) to be represented in the three-dimensional environment 700 via video (e.g., captured via the internal image sensors 114a)). In some embodiments, interactive element 716b is an option that, when selected, mutes the audio for the user 708. In some embodiments, interactive element 716c is an option that, when selected, initiates the sharing of content within the communication session (e.g., which will subsequently be displayed in the three-dimensional environment 700, similar to virtual object 702 discussed above). In some embodiments, interactive element 716d is an option that, when selected, ends the communication session with the second user and the third user. In this embodiment, selection of interactive element 716d causes the computer system 101 to cease display of the first representation 704 and the second representation 706 (e.g., and/or the virtual object 702) in the three-dimensional environment 700. Additionally, in some embodiments, the communication session user interface 716 includes a caller details button 721, as discussed below.

In some embodiments, as shown by the side-view in FIG. 7B, the communication session user interface 716 is displayed at a height in the three-dimensional environment 700 that is based on a height of the first representation 704. For example, the computer system 101 displays the communication session user interface 716 with a height that is approximately half (or other proportion of) a display height of the first representation 704. Additionally, as shown by the side-view in FIG. 7B, a bottom edge of the communication session user interface 716 is displayed parallel to a bottom edge of the first representation 704 in the three-dimensional environment 700.

In FIG. 7B, the communication session user interface 716 is associated with (e.g., is displayed with) a movement element 730. In this embodiment, movement element 730 is represented as a grabber bar as similarly discussed above with reference to the virtual objects 702 and 710 of FIG. 7A. In this example, movement element 730 (e.g., the grabber bar) is displayed beneath the communication session user interface 716, partially overlaying the virtual object 702 from the viewpoint of the first user 708. In some embodiments, the movement element 730 is configured to be selectable to initiate the update of one or more spatial properties of the first representation 704, the second representation 706, and the virtual object 702 in accordance with the input provided by hand 709. In some embodiments, the orientation of the communication session user interface 716 is configured such that the front face continuously faces the viewpoint of the user 708 as the one or more spatial properties of the first representation 704, the second representation 706, and the virtual object 702 are updated as discussed further below with reference to FIG. 7B. In some embodiments, the respective orientations of the first representation 704, the second representation 706, and the virtual object 702 will not be updated with reference to FIG. 7B. Additionally, in some embodiments, as shown by FIG. 7B, in response to the input provided by the hand 709, the computer system 101 displays a second movement element (e.g., similar to movement element 730) below the second representation 706 in the three-dimensional environment 700. In some embodiments, the second movement element has one or more characteristics of the movement element 730 discussed above.

In FIG. 7B, the computer system detects an input provided by hand 709 directed to the call details button 721 displayed in the communication session user interface 716. For example, as shown in FIG. 7B, the computer system 101 detects the gaze 726 being directed towards the call details button 721 in the communication session user interface 716 and an air pinch gesture provided by the hand 709.

In FIG. 7C, in response to detecting the input directed at the call details button 721 of FIG. 7B, the computer system 101 displays a call details user interface 717 associated with the communication session user interface 716 in the three-dimensional environment 700. For example, as shown in FIG. 7C, the computer system ceases the display of the communication session user interface 716 and displays the call details user interface 717 in a location corresponding to a location of the previously displayed communication session user interface 716 in the three-dimensional environment 700. For example, as shown in the overhead view in FIG. 7C, the call details user interface 717 is displayed over/above the virtual object 702 in the location previously occupied by communication session user interface 716 as shown above with reference to the overhead view of FIG. 7B. In some embodiments, the contact user interface 717 includes contact information associated with the second user (e.g., phone number and/or email), a two-dimensional representation of the second user, and text categorizing the second user (e.g., username, contact name, and/or communication session name). In some embodiments, the contact user interface 717 includes the contact information associated with a plurality of users that include the information discussed previously above with reference to the second user.

In FIG. 7D, while displaying the communication session user interface 716 and the movement element 730 in the three-dimensional environment 700, the computer system 101 detects an input provided by hand 709 directed to the movement element 730 associated with the communication session user interface 716. For example, as shown in FIG. 7D, the computer system 101 detects the hand 709 provide an air pinch and drag gesture directed to the movement element 730, optionally while the gaze 726 is additionally directed towards the movement element 730. As shown in FIG. 7D, the air pinch and drag gesture optionally includes movement of the hand 709 leftward in space (e.g., relative to a body of the user 708), while the hand 709 remains in the pinch hand shape.

In FIG. 7E, in response to detecting the input directed to the first visual representation 704, the computer system 101 updates the one or more spatial properties of the first representation 704, the second representation 706, and the virtual object 702 in the three-dimensional environment 700. For example, as shown in FIG. 7E, the computer system 101 shifts the first representation 704, the second representation 706, and the virtual object 702 to the left in the three-dimensional environment 700, such that the first representation 704, the second representation 706, and the virtual object 702 are located in the left periphery of the viewpoint of the first user 708, in accordance with the leftward movement of the hand 709 in FIG. 7D. In some embodiments, such as shown in FIG. 7E, the one or more spatial properties of the virtual object 710 are not updated in the three-dimensional environment 700 in accordance with the input provided by hand 709 (e.g., because the virtual object 710 corresponds to a private object as previously discussed above). In some embodiments, the orientation of the communication session user interface 716 is automatically updated from a first orientation at a first position and a second orientation at a second position, the first and second position determined in accordance with the input provided by the hand 709. In this example, the first and second orientation of the communication session user interface 716 are configured by computer system 101 to have the front face of the communication session user interface 716 continually face the viewpoint of the user 708 regardless of the position of the communication session user interface 716 in the three-dimensional environment 700. In contrast, the respective orientations of the first representation 704, the second representation 706, and the virtual object 702 are not updated to continually face the viewpoint of the user 708.

In FIG. 7E, the computer system 101 detects an input corresponding to a request to update the one or more spatial properties of the first representation 704 and/or the communication session user interface 716. For example, as shown in FIG. 7E, while gaze 726 is directed at the first representation 704, the computer system 101 detects an air pinch and drag gesture as previously discussed above. Alternatively, in some embodiments, the computer system 101 detects the air pinch and drag gesture while gaze 727 of the user 708 is directed at communication session user interface 716, as shown in FIG. 7E. In some embodiments, as shown in FIG. 7E, the air pinch and drag gesture of user input includes a dragging motion across the left relative to the viewpoint of the user 708. It should be understood that while multiple gaze points and corresponding inputs are illustrated in FIG. 7E, such gaze points and inputs need not be detected by computer system 101 concurrently; rather, in some embodiments, the computer system 101 independently responds to the gaze points and/or inputs illustrated and described in response to detecting such gaze points and/or inputs independently.

In some embodiments, as shown in FIG. 7F, the one or more spatial properties of the first representation 704, the second representation 706, and the virtual object 702 are not updated in response to the input provided by hand 709 (e.g., the user input of FIG. 7E). In this embodiment, because the user input discussed above was directed at the communication session user interface 716 (or the first representation 704) and not the movement element 730, the one or more spatial properties of the first representation 704, the second representation 706, and the virtual object 702 are not updated in accordance with the air pinch and drag gesture associated with the user input.

In FIG. 7F, the computer system 101 detects gaze 726 directed at a location in the three-dimensional environment 700 that does not correspond to a location of the communication session user interface 716 in FIG. 7E, causing the computer system 101 to cease the display of the communication session user interface 716 and the movement element 730 in the three-dimensional environment 700 as previously shown above with reference to FIG. 7E. Additionally, in some embodiments, as shown in FIG. 7F, the gaze 726 is directed at a location within the three-dimensional environment 700 that does not correspond to the first visual representation 704, the second visual representation, the virtual object 702, or the virtual object 710 in the three-dimensional environment 700. In some examples, the position of the gaze 726 is the updated position of the gaze 727 as shown above in FIG. 7F. In some examples, the computer system 101 detects gaze 726 and ceases the display of the communication session user interface 716 and the movement element 730 in the three-dimensional environment 700 after a predetermined amount of time after detecting gaze 726. In some examples, FIG. 7F optionally includes an input by hand 709 (not shown) directed at any of the virtual objects in the three-dimensional environment 700, detected by computer system 101. In this example, because the computer system additionally detects gaze 726 directed at the location not associated with either the communication session user interface 716 or movement element 730, the computer system 101 ceases the display the communication session user interface 716 and the movement element 730.

In FIG. 7G, the computer system 101 detects an input provided by hand 709 directed to movement element 730 in the three-dimensional environment 700. For example, as shown in FIG. 7G, the input includes a selection of the movement element 730 provided by the hand 709 of the user 708, followed by movement of the hand 709 backward in the three-dimensional environment 700 relative to the viewpoint of the first user 708 (e.g., toward the body of the user 708). In some embodiments, the input directed to the movement element 730 corresponds to an air pinch and drag gesture as similarly discussed above.

In FIG. 7H, in response to (e.g., and/or while) detecting the input provided by hand 709 directed to the movement element 730, the computer system 101 updates one or more visual properties of the first representation 704, the second representation 706, the virtual object 702 and the movement element 731 associated with the virtual object 702. For example, as illustrated via the dashed outline of the first representation 704, the second representation 706, the virtual object 702, and the movement element 731 in FIG. 7H, the computer system 101 changes an opacity of the first representation 704, the second representation 706, the virtual object 702, and the movement element 731 in the three-dimensional environment 700. In some embodiments, the computer system 101 ceases the display of the first representation 704, the second representation 706, the virtual object 702, and the movement element 731 in accordance with the input provided by the hand 709, as illustrated in the overhead view 712 in FIG. 7H. In FIG. 7H, the computer system 101 continues to detect the input provided by hand 709 discussed above with reference to FIG. 7G. In some embodiments, the computer system 101 initiates updating the one or more spatial properties of the first representation 704, the second representation 706, the virtual object 702, and the movement element 731 according to the input provided by hand 709, as discussed in more detail below, while simultaneously altering the opacity of the first representation 704, the second representation 706, the virtual object 702, and the movement element 731 as discussed above.

In FIG. 7I, in response to detecting the input directed to the movement element 730, the computer system 101 updates the one or more spatial properties of the first representation 704, the second representation 706, and the virtual object 702 in the three-dimensional environment 700. For example, as shown in FIG. 7J, the computer system 101 shifts the first representation 704, the second representation 706, and the virtual object 702 forward in the three-dimensional environment 700 relative to the viewpoint of the first user 708, such that the first representation 704, the second representation 706, and the virtual object 702 are located closer to the viewpoint of the first user 708 than in FIG. 7H. In some embodiments, such as shown in FIG. 7I, the spatial arrangement of the virtual object 710 is not updated in accordance with the input provided by hand 709, as similarly discussed above.

In some embodiments, when the one or more spatial properties of the communication session user interface 716 are updated (e.g., when the communication session user interface 716 is moved) in the three-dimensional environment 700, the communication session user interface 716 is scaled (e.g., relative to the three-dimensional environment) to remain a consistent size relative to the viewpoint of the first user 708 in response to a change in distance between the communication session user interface 716 and the viewpoint of the first user 708 (e.g., to remain at a consistent display size). For example, as illustrated by the overhead view 712, the width of the communication session user interface 716 is narrower (in response to the communication session user interface 716 being arranged closer to the viewpoint of the first user 708) as compared to the width of the communication session user interface 716 illustrated by the overhead view 712 of FIG. 7G. In some embodiments, the communication session user interface 716 is positioned in front of and/or optionally closer to the first representation 704 relative to the viewpoint of the first user 708. In this example, the communication session user interface 716 is centered along a vector emanating from user 708 as illustrated with the arrow of the overhead view 712 of FIG. 7G. In another example, the communication session user interface 716 and the movement element 730 are displayed in the three-dimensional environment 700 a predetermined distance from the user 708. In this example, the predetermined distance of the communication session user interface and the movement element 730 corresponds to the distance the communication session user interface 716 and the movement element 730 are displayed in the three-dimensional environment as discussed above with reference to FIG. 7G. In some embodiments the vector emanating from user 708 aligns with the head of representation 704. In some embodiments, when the one or more spatial properties of the communication session user interface 716 are updated in the three-dimensional environment 700, the one or more spatial properties of the first representation 704, the second representation 706, and the virtual object 702 are concurrently updated in the three-dimensional environment 700 without dynamically scaling the sizes (e.g., dimensions) of the first representation 704, the second representation 706, and the virtual object 702 relative to the three-dimensional environment 700.

In FIG. 7J, computer system 101 ceases the display of the communication session user interface 716 and the movement element 730 in the three-dimensional environment 700. In this example, as shown in FIG. 7J, the computer system 101 ceases the display of the above listed virtual objects in response to an amount of time 752 exceeding a threshold amount of time 753. In this example, the amount of time 752 and the threshold amount of time 753 are represented by legend 754. In some embodiments, the computer system 101 immediately ceases the display of the communication session user interface 716 and the movement element 730 once the amount of time has exceeded the threshold amount of time 753. In some embodiments, the amount of time is triggered when the computer system 101 no longer detects the gaze 726 and/or a user 708 input as discussed above. In this example, the computer system 101 tracks the amount of time 752 contingent on the computer system 101 not detecting the gaze 726 and/or an input from the user 708.

In FIG. 7K, the computer system 101 detects the gaze 726 directed at the first representation 704 (e.g., and/or a movement element associated with the first representation 704) and a corresponding input by hand 709 of the user. In some embodiments, the input by hand 709 is a hand movement gesture in a leftward motion, as shown in FIG. 7K. In some embodiments, the computer system 101 initiates an update of the one or more spatial properties of the first representation 704, the movement element 730, the visual object 702, the movement element 731, and the second representation 706 in accordance with the input by hand 709, as discussed below. In some embodiments, the hand movement gesture provided by hand 709 is a leftward movement starting on a right side of the viewpoint of the user and moving across the three-dimensional environment 700 to a left side of the viewpoint of the user.

In FIG. 7L, the computer system 101 updates the one or more spatial properties of the first representation 704, the movement element 730, the visual object 702, the movement element 731, and the second visual representation 706 in accordance with the input by hand 709 discussed above with reference to FIG. 7K. In this example, the respective spatial positions of the aforementioned virtual objects are updated to positions to the left of the viewpoint of the user in the three-dimensional environment 700. In some embodiments, the virtual objects 710 and the movement element 732 remain stationary in the three-dimensional environment (e.g., as similarly discussed above) while the computer system 101 updates the one or more spatial properties of the aforementioned objects.

In some embodiments, the three-dimensional environment 700 includes environmental boundaries (not pictured) that the previously mentioned virtual objects are unable to cross. For example, as shown in FIG. 7L, in response to the virtual objects approaching the environmental boundary, computer system 101 generates a visual indication and/or an audio indication (e.g., visual indication 781 and audio indication 780). In some embodiments, the environmental boundary is defined as the walls of the physical environment that is visible in the three-dimensional environment 700. In some embodiments, the second visual representation 706 crosses the environmental boundary (e.g., the wall of the three-dimensional environment 700) and in response, the computer system 101 generates the visual indication 781 and/or the audio indication 780. In some embodiments, the computer system 101 automatically updates the one or more spatial properties of the virtual objects to one or more spatial properties within the environmental boundary in response to any of the virtual objects crossing the environmental boundary in accordance with the hand movement gesture of the hand 709.

In FIG. 7M, the computer system 101 detects a hand movement gesture from hand 709 moving towards the viewpoint of the user 708 in the three-dimensional environment 700. In some embodiments, as shown in FIG. 7M, the hand movement gesture is directed at the first representation 704 (e.g., a movement element associated with the first representation 704. In some embodiments, the gaze 726, as discussed previously above, is additionally and/or alternatively directed at the first representation 704. In some embodiments, the computer system 101 initiates an update of the one or more spatial properties of the first representation 704, the movement element 730, the virtual object 702, the movement element 731, and the representation 706 in accordance with hand movement gesture. In some embodiments, the computer system 101 does not update the one or more spatial arrangements of the virtual object 710 and the movement element 732 in the three-dimensional environment in response to the detection of the hand movement gesture.

In FIG. 7N, the computer system 101 updates the one or more spatial arrangements of the first representation 704, the second representation 706, the virtual object 702, and the movement element 731 in the three-dimensional environment 700. In some embodiments, the one or more spatial arrangements of the aforementioned virtual objects are updated in accordance with the hand movement gesture from user 708 discussed previously above with reference to FIG. 7M. In some embodiments, the computer system 101 updates the spatial positioning of the communication session user interface 716 (not shown) at a different magnitude than the updating of the one or more spatial arrangements of the first representation 704, the second representation 706, and the virtual object 702. In this example, the communication session user interface 716 (not shown) moves towards the viewpoint of the user 708 at a smaller rate in accordance with the magnitude of the hand movement gesture from user 708 discussed previously above than the movement of the first representation 704, the second representation 706, and the virtual object 702 towards the viewpoint of the user 708 in the three-dimensional environment 700. In this example, while the communication session user interface 716 (not shown) moves at a different rate than the aforementioned virtual objects, the spatial arrangement of the first representation 704, the second representation 706, and the virtual object 702 is maintained. In some embodiments, the one or more spatial arrangements of the aforementioned objects are updated at a smaller magnitude than a magnitude of the hand movement gesture from user 708 as previously discussed in response to the computer system 101 detecting the virtual object 702 encountering the threshold boundary 782. In this example, the user 708 optionally attempts to update the one or more spatial arrangements of the aforementioned virtual objects, but is prevented by the threshold boundary 782. In some embodiments, as shown in FIG. 7N, the virtual object 702 is displayed in the three-dimensional environment 700 partially outside the viewpoint of the user 708. For example, as shown in FIG. 7N, a bottom portion of the virtual object 702 and the movement element 732 are occluded from the viewpoint of the viewpoint of the user 708 relative to the three-dimensional environment 700. In some embodiments, the update of the one or more spatial arrangements of the aforementioned virtual objects in accordance with the hand movement gestures from hand 709 as discussed above with reference to FIG. 7M is limited by a threshold boundary 782 associated with the user 708 as shown in the overhead view 712. In some embodiments, the computer system 101 detects the virtual object 702 approaching the threshold boundary 782 and places the virtual object 702 at a location outside the boundary and places the first representation 704 and the second representation 706 at respective locations that preserve the one or more spatial arrangement. In some embodiments, as shown in FIG. 7N by the overhead view 712, a bottom right corner of the virtual object 702 is adjacent to the threshold boundary 782. In some embodiments, the threshold boundary is an invisible boundary (e.g., is not displayed in the three-dimensional environment 700) set by the computer system 101 as a boundary with a set radius encircling the user 708 (e.g., centered on the viewpoint of the user 708).

In FIG. 7O, the computer system 101 detects an input directed at the first representation 704. In some embodiments, as shown in FIG. 7O, the input optionally is an input by hand 709 while the gaze 726 is directed at the first representation 704. In some embodiments, the input provided by the hand 709 has one or more characteristics of the inputs discussed above.

In FIG. 7P, in response to the input described above with reference to FIG. 7O, the computer system 101 displays the communication session user interface 716 as being at least partially visible through at least a portion of the first representation 704 in the three-dimensional environment relative to the viewpoint of the user 708. For example, as illustrated in the overhead view 712 in FIG. 7P, because at least one of the virtual objects (e.g., the virtual object 702) is at the threshold boundary 782 in the three-dimensional environment 700, the computer system 101 displays the communication session user interface 716 behind the first representation 704 from the viewpoint of the user 708 at the predetermined distance discussed above. In some embodiments, as shown in FIG. 7P, a translucency of a lower portion of the first representation 704 is increased to enable the communication session user interface 716 to be visible through the lower portion of the first representation 704 relative to the viewpoint of the user 708. In some embodiments, the first representation 704 partially occludes the communication session user interface 716 in a similar manner as described above. In some embodiments, the computer system detects the gaze 726 directed at the movement element 730 in the three-dimensional environment 700, causing the computer system 101 to maintain display of the communication session user interface 716 and the movement element 730 in the three-dimensional environment 700.

In FIG. 7Q, as an alternative to FIG. 7P, in response to a detection by the computer system 101 of the input provided by the hand 709 in FIG. 7O, the one or more spatial arrangements of the first representation 704, the virtual object 702, the movement element 731, and the second representation 706 are updated to a location further from the viewpoint of the user 708 in the three-dimensional environment 700 than the initial respective positions of the aforementioned virtual objects in the three-dimensional environment 700. In some embodiments, the initial respective positions of the aforementioned virtual objects in the three-dimensional environment 700 correspond to the positions as shown in the three-dimensional environment 700 of FIG. 7O. In some embodiments, because the computer system 101 detects a portion of the virtual object 702 intersecting with the threshold boundary 782 as shown by the overhead view 712, the computer system 101 updates the spatial arrangements of the first representation 704, the virtual object 702, the movement element 731, and the second representation 706 to accommodate display of (e.g., create enough display space relative to the viewpoint of the user 708) the communication session user interface 716 and the movement element 730 in the three-dimensional environment 700 with respect to the threshold boundary 782.

In FIG. 7Q, the computer system 101 detects an input provided by the first user 708 corresponding to a selection of the second representation 706 of the third user in the three-dimensional environment 700. For example, while gaze 726 is directed to the second representation 706, the computer system 101 detects an air pinch gesture provided by the hand 709, as shown in FIG. 7W.

In some embodiments, as shown in FIG. 7R, in response to detecting the selection of the second representation 706, the computer system 101 updates the spatial arrangement of the communication session user interface 716 relative to the viewpoint of the user 708 in the three-dimensional environment 700. For example, the communication session user interface 716 is updated by the computer system 101 to be displayed at a location in front of the second representation 706 in the three-dimensional environment 700, as shown in FIG. 7R. In some embodiments, the input provided by the first user 708 causes the computer system 101 to cease the display of the communication session user interface 716 at a location based on the first representation 704 and initiates display of the communication session user interface 716 at a location based on the second representation 706. In some embodiments, the communication session user interface 716 is displayed at a location in the periphery of the viewpoint of the first user 708 partially overlaying the second representation 706 and the virtual object 702 in the three-dimensional environment 700. In some embodiments, from FIG. 7Q to 7R, the computer system 101 alters the orientation of the communication session user interface 716 while updating the spatial arrangement of the communication session user interface 716 to continuously face the viewpoint of the first user 708 (e.g., the front-facing surface/edge of the communication session user interface 716 that faces the viewpoint of user 708 is flat relative to the viewpoint of user 708). In some embodiments, the orientation of the communication session user interface 716 is updated while the respective orientations of the first representation 704, the second representation 706, and the virtual object 702 are not updated in response to the input provided by the hand 709, as shown in FIG. 7Q. In some embodiments, the orientation of the communication session user interface 716 is altered to face the viewpoint of the first user 708 after the spatial arrangement of the communication session user interface 716 is updated by the user 708. Additionally, as shown in FIG. 7R, the computer system 101 displays a movement element associated with the first representation 704 when the communication session user interface 716 and the movement element 730 are displayed in the three-dimensional environment 700.

From FIG. 7R to 7S, the computer system 101 detects movement of the viewpoint of the first user 708. For example, as shown in FIG. 7R, the computer system 101 detects a shift of the viewpoint of the user 708 leftward in the three-dimensional environment 700 as illustrated in the overhead view 712. In this embodiment, the shift of the viewpoint and/or the destination of the shift of the viewpoint of the user 708 is represented by a dashed arrow emanating from computer system 101 as illustrated in the overhead view 712. In some embodiments, the shift of the viewpoint of user 708 is caused by a rotation of their body (e.g., head and/or torso), which causes the computer system 101 to shift accordingly.

In FIG. 7S, in response to detecting the shift in the viewpoint of the user 708, the computer system 101 updates the field of view of the three-dimensional environment 700 in accordance with the shift in the viewpoint of user 708 as illustrated in the overhead view 712. For example, the viewpoint of the user 708 in FIG. 7S is shifted/rotated counterclockwise, as shown in overhead view 712, which causes the first representation 704, the second representation 706, the virtual object 702, and the virtual object 710 to be shifted rightward relative to the updated viewpoint of the first user 708, such that the first representation 704, the second representation 706, and the virtual object 702 are located centrally in the first user's field of view.

In some embodiments, as shown in FIG. 7S, user 708 directs an input, provided by hand 709, at the second representation 706 in the three-dimensional environment 700. For example, the computer system 101 detects an air pinch gesture while gaze 726 is directed at the second representation 706, as shown in FIG. 7S. In some embodiments, as shown in FIG. 7T, in response to detecting the air pinch gesture provided by hand 709 and directed at the second representation 706, the computer system 101 ceases the display of the communication session user interface 716 in the three-dimensional environment 700. Additionally, in some embodiments, as shown in FIG. 7S, in response to detecting the input provided by the hand 709, the computer system 101 ceases display of the movement element associated with the first representation 704 in the three-dimensional environment 700.

In FIG. 7T, the computer system 101 detects an input provided by hand 709 directed to a movement element 731 associated with the virtual object 702 in the three-dimensional environment 700. For example, as shown in FIG. 7A, the computer system 101 detects hand 709 provide an air gesture as similarly discussed above while gaze 726 is directed to the movement element 731. In some embodiments, as indicated in FIG. 7T, the air gesture provided by hand 709 includes a right upward movement in space. In some embodiments, the movement element 731 is associated with the virtual object 702 as an interaction point for the content that is shared in the real-time communication session, including the first representation 704 and the second representation 706 (e.g., the virtual object 702 is shared with the other users of the real-time communication session as previously discussed). In this example, the input provided by hand 709 directed to the movement element 731 causes the computer system 101 to update the one or more spatial properties of the first representation 704, the second representation 706, and the virtual object 702, as discussed below.

In FIG. 7U, in response to detecting the input directed to the movement element 731, the computer system 101 updates the one or more spatial arrangements of the first representation 704, the second representation 706, and the virtual object 702 in the three-dimensional environment 700. For example, as shown in FIG. 7U, the computer system 101 shifts the first representation 704, the second representation 706, and the virtual object 702 to the upper right in the three-dimensional environment 700 in accordance with the movement of the hand 709, such that the first representation 704, the second representation 706, and the virtual object 702 are located farther from the viewpoint of the first user 708 than in FIG. 7T.

In some embodiments, as shown in FIG. 7U, the computer system 101 detects the hand 709 provide an air pinch and drag gesture directed to movement element 732 associated with the virtual object 710 in the three-dimensional environment 700. In this embodiment, computer system 101 detects movement of the hand 709 in the leftward direction relative to the viewpoint of the first user 708 in the three-dimensional environment 700, while the gaze 726 is directed at the movement element 732.

In FIG. 7V, the computer system 101 updates the spatial arrangement of the virtual object 710 relative to the viewpoint of the first user 708 in the three-dimensional environment 700 in response to the input provided by hand 709 as discussed above with reference to FIG. 7U, without updating the one or more spatial properties of the first representation 704, the second representation 706, and the virtual object 702. For example, as shown in FIG. 7V, the computer system 101 moves the virtual object 710 in the three-dimensional environment 700 in accordance with the movement of the hand 709 while the first representation 704, the second representation 706, and the virtual object 702 remain stationary in the three-dimensional environment 700 relative to the viewpoint of the first user 708. In this example, the orientation of the virtual object 710 is updated in a similar fashion in accordance to the movement of the hand 709 as discussed above with reference to the communication session user interface 716 in FIG. 7R. In some embodiments, the second representation 706 partially overlays the virtual object 710 relative to the viewpoint of the first user 708. In some embodiments, as previously discussed above with reference to FIG. 7A, the virtual object 710 is a private window (e.g., private application running on computer system 101 that includes media content being played back via virtual object 710) not viewable by the second user and/or the third user in the real-time communication session. Accordingly, in this example, the one or more spatial properties of the first representation 704, the second representation 706, and the virtual object 702 are not updated when the spatial arrangement of the virtual object 710 is updated because the virtual object 710 is a private virtual object to the first user 708 (e.g., not viewable by the second user or the third user).

In FIG. 7W, the first representation 704 and second representation 706 are replaced with a first virtual panel 718 and a second virtual panel 720 respectively. In some embodiments, the first representation 704 and the second representation 706 are replaced with the first virtual panel 718 and the second virtual panel 720 respectively in response to an input provided by hand 709 directed to one or more of the interactive elements 716a-e of the communication session user interface 716 for transitioning the spatial real-time communication session of FIGS. 7A-7V to a non-spatial real-time communication session. In some embodiments, the first virtual panel 718 and the second virtual panel 720 are non-spatial representations of the first representation 704 and second representation 706 respectively. For example, the first virtual panel 718 and the second virtual panel 720 are and/or include user interfaces of a video conferencing application. Accordingly, in the example of FIG. 7W, the first user 708, the second user (e.g., represented by the first virtual panel 718) and the third user (e.g., represented by the second virtual panel 720) are communicating in a non-spatial real-time communication session. In some embodiments, the first virtual panel 718 and the second virtual panel 720 are orientated to face the viewpoint of the first user 708 in the three-dimensional environment. In this example, the orientations of the first virtual panel 718 and the second virtual panel 720 are updated so that the front face of the first virtual panel 718 and the second panel 720 continuously face the viewpoint of the first user 708 independent of their respective positions in the three-dimensional environment 700 in a similar fashion to the communication session user interface 716 as discussed above with reference to FIG. 7R. In some embodiments, the second virtual panel is displayed partially overlaying a section of the virtual object 710 in the three-dimensional environment 700 from the viewpoint of the first user 708.

In FIG. 7W, the computer system 101 detects an input provided by hand 709 directed to movement element 733 associated with the second virtual panel 720. For example, as shown in FIG. 7W, the computer system 101 detects an air pinch and drag gesture provided by hand 709 while gaze 726 is directed to the movement element 733. In some embodiments, as shown in FIG. 7W, the input provided by hand 709 includes a movement of hand 709 leftward in space relative to the viewpoint of the first user 708.

In FIG. 7X, in response to detecting the input provided by the hand 709, the computer system 101 updates the spatial arrangement of the second virtual panel 720 in the three-dimensional environment 700 relative to the viewpoint of the first user 708. For example, as shown in FIG. 7X, the computer system 101 shifts the second virtual panel 720 leftward in the three-dimensional environment 700, such that the second virtual panel 720 is located in the left periphery of the viewpoint of the first user 708. In some embodiments, the second virtual panel 720 is displayed partially overlaying a section of the virtual object 710, different than the section overlayed discussed above with reference to FIG. 7W, in the three-dimensional environment 700. In some embodiments, while updating the spatial arrangement of the second virtual panel 720 in accordance with the input provided by hand 709, the orientation of the second virtual panel 720 continuously updates to face the viewpoint of the first user 708 in the three-dimensional environment 700. In this example, while updating the spatial arrangement of the second virtual panel 720, the computer system 101 does not update the one or more spatial properties of the first virtual panel 718, the virtual object 702, or the virtual object 710. In some embodiments, when the first user 708 is engaging in a non-spatial communication session (e.g., the second user and the third user being represented by the first virtual panel 718 and the second virtual panel 720, respectively), the spatial arrangement of virtual objects within the three-dimensional environment 700 are not updated in tandem with an update of the spatial arrangement of the first virtual panel 718 and/or the second virtual panel 720 (e.g., as similarly described above with reference to the movement of the virtual object 710 in FIG. 7V).

In FIG. 7Y, the computer system 101 detects an input corresponding to a request to share the virtual object 710 in the real-time communication session. For example, in FIG. 7Y, the computer system 101 detects an air pinch gesture provided by the hand 709, optionally while the user 708 directs the gaze 726 to a share button 750 (previously not displayed). In some embodiments, the computer system 101 initializes the display of the share button 750 automatically, without an input by user 708. In some embodiments, the share button 750 initiates sharing content displayed on the screen of the virtual object 710 with the second user and the third user. In some examples, as shown in FIG. 7Y, the share button is associated with the virtual object 710. In some embodiments, the computer system 101 initiates the display of the share button 750 in the three-dimensional environment 700 in response to an input by the first user 708 (e.g., an input directed to the virtual object 710).

In FIG. 7Z, in response to the user input discussed above with reference to FIG. 7Y, the computer system 101 shared the content of the virtual object 710 in the real-time communication session. In some embodiments, as shown in FIG. 7Z, when the virtual object 710 becomes a shared virtual object in the three-dimensional environment 700, the computer system 101 updates the one or more spatial properties of the first virtual panel 718 and the second virtual panel 720. For example, the first virtual panel 718 and the second virtual panel 720 are docked (e.g., with the first virtual panel 718 being above the second virtual panel 720, as illustrated in the overhead view 712) adjacent to the virtual object 710 from the viewpoint of the user 708 in the three-dimensional environment 700. In some embodiments, as shown in FIGS. 7Y-7Z, the computer system 101 updates the orientation of the virtual object 710 in accordance with the user input to directly face the viewpoint of the first user 708. Additionally, in some embodiments, as illustrated in FIG. 7Z, the computer system 101 decreases a size of the first virtual panel 718 and the second virtual panel 720 (e.g., decreases the length and width of the virtual panels 718/720). In some embodiments, while updating the one or more spatial properties of the first virtual panel 718 and the second virtual panel 720, the computer system 101 updates the orientations of the aforementioned virtual objects to align with the orientation of the virtual object 710 relative to the viewpoint of the first user 708.

In FIG. 7Z, after updating the one or more spatial properties of the first virtual panel 718 and the second virtual panel 720 as discussed previously above, the computer system 101 detects an input directed to the first virtual panel 718. In some embodiments, the input corresponds to an air pinch gesture by the hand 709 while the gaze 726 is directed at the first virtual panel 718. In some embodiments, in response to detecting the input directed at the first virtual panel 718, the computer system 101 initiates the display of the communication session user interface 716 as described in further detail below with reference to FIG. 7AA.

In FIG. 7AA, the computer system 101 displays the communication session user interface 716 partially overlaying the second virtual panel 720 in response to the input by the first user 708 directed at the first virtual panel 718 as discussed above with reference to FIG. 7Z. In some embodiments, as shown in the overhead view 712, the communication session user interface 716 is displayed in a location in the three-dimensional environment 700 closer to the user 708 relative to the first virtual panel 718 and the second virtual panel 720. In some embodiments, the size of the communication session user interface 716 is consistent with the size of the communication session user interface 716 as shown in previous examples but appears to be a smaller size from the viewpoint of the first user 708 as compared to previous examples of the communication session user interface 716. In this example, the size communication session user interface 716 is not scaled in accordance with its position in the three-dimensional environment 700 relative to the viewpoint of the first user 708. In some embodiments (not shown), the user 708 directs a hand movement input by hand 709 at the movement element 732. In this example, in response to the hand movement input by hand 709, the computer system 101 updates the spatial arrangement of the first virtual panel 718, the second virtual panel 720, the communication session user interface 716, the movement element 732, and the virtual object 710 in accordance to the hand movement while maintaining the respective spatial arrangements of the aforementioned virtual objects relative to one another. In some embodiments, the computer system 101 maintains the display of the communication session user interface 716 while the gaze 726 is directed at the first virtual panel 718 as shown in FIG. 7AA. In some embodiments, the communication session user interface 716 is associated with the first virtual panel 718. In an alternative embodiment, computer system 101 detects the gaze 726 directed at the second virtual panel 720. In this example, the computer system 101 automatically updates the communication session user interface 716 to be associated with the second virtual panel 720 while maintaining the communication session user interface 716 location in the three-dimensional environment 700 as discussed above.

In FIG. 7BB, the computer system 101 has detected an input by the first user 708 directed at the predefined region 714 discussed previously above with reference to FIG. 7A. For example, as shown in FIG. 7BB, the computer system 101 has detected the gaze 726 being directed at the predefined region 714 (e.g., for a threshold amount of time, such as 0.5, 1, 2, 3, 5, 8, 10, or 15 seconds). Additionally, or alternatively, in some examples, as shown in FIG. 7BB, detecting the input includes detecting an air pinch gesture provided by the hand 709 (e.g., while the gaze 726 is directed to the predefined region 714). In some embodiments, as shown in FIG. 7BB, in response to detecting the input provided by the hand 709 directed to the predefined region 714, the computer system 101 initiates the display of the system controls user interface 722 in the three-dimensional environment 700. In some embodiments, the system controls user interface 722 is displayed partially overlaying the first representation 704, the second representation 706, and the virtual object 702 relative to the viewpoint of the first user, as shown in FIG. 7BB.

In some embodiments, the system controls user interface 722 and the communication session user interface 716 are each displayed in a fixed position in the three-dimensional environment 700 relative to the viewpoint of the first user 708, independent of changes to the location and/or orientation of the viewpoint of the first user 708. In this example, the respective positions of the system controls user interface 722 and the communication session user interface 716 are located closer to the viewpoint of the user 708 than the first representation 704, the second representation 706, the virtual object 702, and the virtual object 710. In some embodiments, when the system controls user interface 722 is displayed, the communication session user interface 716 is displayed (e.g., or redisplayed) at a position lower than the displayed position relative to the viewpoint of the first user 708, as discussed above with reference to FIG. 7S. In this example, the position at which the communication session user interface 716 is displayed is independent of the positions of the first representation 704 and the second representation 706, as compared to the communication session user interface 716 being displayed at a fixed distance from the selected representation (e.g., first representation 704 or second representation 706) as discussed above with reference to FIGS. 7D and/or 7J-7R. In some embodiments, the system controls user interface 722 includes selectable options 722a-e. System controls user interface 722 is optionally a control center user interface for controlling one or more functionalities of computer system 101. In some embodiments, selectable option 722a is an option that, when selected, toggles on or off airplane mode for computer system 101. In some embodiments, airplane mode disables Bluetooth, Wi-Fi, cellular, and/or data connections on computer system 101. In some embodiments, selectable option 722b is an option that, when selected, toggles on or off Wi-Fi capabilities for computer system 101. In some embodiments, selectable option 722c is an option that, when selected, toggles on or off Bluetooth for computer system 101. In some embodiments, selectable option 722d is an option that, when selected, toggles on or off on a do not disturb mode of computer system 101. In some embodiments, selectable option 722e is an option for adjusting the volume of the playback of content on computer system 101, such as the content associated with virtual object 702 or 710. In some embodiments, the system controls user interface 722 includes a visual representation playback content on computer system 101.

In some embodiments, the communication session user interface 716 is displayed concurrently with the system controls user interface 722 in the three-dimensional environment 700. In this example, while the communication session user interface 716 and system controls user interface 722 are concurrently displayed in response to detecting the input directed to the predetermined region 714, the computer system 101 omits displaying the movement element 730 discussed previously above. In some embodiments, as shown in the overhead view 712, the system controls user interface 722 is arranged at a location behind the communication session user interface 716 relative to viewpoint of the first user 708 in the three-dimensional environment 700. In some embodiments, the one or more spatial arrangements of the communication session user interface 716, the first representation 704, the second representation 706, and the virtual object 702 are not updated in accordance to the input provided by hand 709 directed at the communication session user interface 716 (e.g., in the manner discussed above with reference to FIG. 7D). As mentioned above, movement element 730 is not displayed in the three-dimensional environment 700 in FIG. 7BB, thus visually signifying to the user 708 that the one or more spatial arrangements of the communication session user interface 716, the first representation 704, the second representation 706, and the virtual object 702 is not able to be updated via the system controls user interface 722.

In FIG. 7CC, the computer system 101 no longer detects the gaze 726 of the first user 708 directed at the predefined region 714 for the amount of time 752 as shown by the legend 754. In some embodiments, the system controls user interface 722 is displayed in the three-dimensional environment 700 by the computer system 101 until the threshold amount of time 753 is reached as discussed in further detail below with reference to FIG. 7DD. In some embodiments, the legend 754 is not displayed by the display generation component 120 to be viewable from the viewpoint of the user 708. In some embodiments, the user 708 is viewing the three-dimensional environment 700, but is not directing an input into the three-dimensional environment 700 by the hand 709 (not shown) and/or the gaze 726 (not shown).

In FIG. 7DD, the computer system determines the amount of time 752 has exceeded the threshold amount of time 753, and in response, ceases the display of the system controls user interface 722, including the communication session user interface 716, in the three-dimensional environment 700. In some embodiments, the computer system 101 ceases the display of the system controls user interface 722 in the three-dimensional environment 700 when the amount of time 752 is equal to the threshold amount of time 753.

In FIG. 7EE, the first representation 704 is replaced with coin 705 (e.g., a non-spatial two-dimensional representation) by the computer system 101. In some embodiments, coin 705 includes contextual information corresponding to the second user. In some embodiments, as shown by FIG. 7EE, the coin 705 includes a name associated with the second user. In some embodiments, the coin 705 is displayed in the same location in the three-dimensional environment 700 as previously occupied by the first representation 704 relative to the viewpoint of the first user 708 as described above with reference to FIG. 7DD. In some embodiments, the coin 705, as shown by FIG. 7EE, is displayed in the three-dimensional environment 700 as a two-dimensional circle accompanied by a boxed card below the two-dimensional circle that includes the name associated (e.g., Jill Lin) with the second user. In this example, the two-dimensional circle includes the initials of the name (e.g., J. L.) displayed by the boxed card. Alternatively, in some embodiments, the two-dimensional circle includes an image corresponding to the second user.

In some embodiments, as shown in FIG. 7EE, the computer system 101 detects an input corresponding to a selection of the coin 705 in the three-dimensional environment. 700. For example, as shown in FIG. 7EE, computer system 101 detects the gaze 726 directed at the two-dimensional circle of the coin 705 while the hand 709 performs a hand gesture (e.g., an air pinch gesture).

In FIG. 7FF, in response to detecting the input provided by the hand 709, the computer system 101 displays the communication session user interface 716 and the movement element 732 in the three-dimensional environment 700 partially overlaying a portion of the coin 705 relative to the viewpoint of the user 708. In some embodiments, as shown by the overhead view 712, the communication session user interface 716 is displayed in a location in the three-dimensional environment 700 closer to the viewpoint of the user 708 as compared to the location of the coin 705 in the three-dimensional environment 700. Additionally, as shown in FIG. 7FF, the computer system 101 displays a movement element that is associated with the second representation 706 in the three-dimensional environment 700, as similarly discussed above. In some embodiments, as previously discussed herein, the computer system 101 displays the communication session user interface 716 at a height in the three-dimensional environment 700 relative to the viewpoint of the user 708 that is based on the height of the representation with which the communication session user interface 716 is displayed. In some embodiments, as illustrated in the side view 713, because the representation of the second user is a two-dimensional representation (e.g., the coin 705), the communication session user interface 716 is displayed at a first height overlaying the coin 705 relative to the viewpoint of the first user 708. In some embodiments, as shown by the side view 713 and as similarly discussed above, the communication session user interface 716 is displayed at a predetermined distance from the coin 705.

In some embodiments, as shown in FIG. 7FF, at a time after the computer system 101 displays the communication session user interface 716 and the movement element 732 in the three-dimensional environment 700, the computer system detects an input corresponding to a selection of the second representation 706 in the three-dimensional environment 700. For example, the computer system 101 detects the gaze 726 directed at the second representation 706 while the hand 709 performs an air pinch gesture, as shown in FIG. 7FF. In some embodiments, in response to the air pinch gesture by hand 709, the computer system 101 updates the spatial arrangement of the communication session user interface 716 and the movement element 732 as discussed in further detail below with reference to FIG. 7GG.

In FIG. 7GG, in response to the input provided by hand 709 in FIG. 7FF, the spatial arrangement of the communication session user interface 716 and the movement element 732 is updated. For example, as shown in FIG. 7GG, the computer system 101 redisplays and/or moves the communication session user interface 716 to a location in the three-dimensional environment 700 that is based on the location of the second representation relative to the viewpoint of the first user 708, as similarly discussed herein. In some embodiments, as shown in FIG. 7GG, the communication session user interface 716 is displayed by the computer system 101 at a position partially overlaying the second representation 706 from the viewpoint of the user 708. Additionally, in some embodiments, when the communication session user interface 716 is redisplayed/moved in the three-dimensional environment 700 to be based on the location of the second representation 706, the name displayed on the front face of the communication session user interface 716 is updated from the name associated with the second user (e.g., Jill Lin) to a name associated with the third user (e.g., Anne Lee).

In some embodiments, when the computer system 101 displays the communication session user interface 716 at the location that is based on the location of the second representation 706 relative to the viewpoint of the first user 708 as discussed above, the communication session user interface 716 is displayed at a height that is based on a height of the second representation 706 in the three-dimensional environment 700. For example, as shown by the side view 713 in FIG. 7GG, the communication session user interface 716 is displayed at a second height overlaying the second representation 706 relative to the viewpoint of the user 708. In some embodiments, because the second representation 706 corresponds to a spatial three-dimensional representation of the third user, the second height is different from (e.g., lower than) the first height discussed above with reference to FIG. 7FF relative to the viewpoint of the first user 708.

FIG. 8 is a flowchart illustrating an exemplary method 800 of updating one or more spatial arrangements of a plurality of a virtual objects in a three-dimensional environment in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at a first computer system (e.g., 101) in communication with a display generation component (e.g., 120) and one or more input devices (e.g., 114a-114c). In some embodiments, the first computer system is or includes an electronic device, such as a mobile device (e.g., a tablet, a smartphone, a media player, or a wearable device), or a computer. In some embodiments, the display generation component is a display integrated with the first computer system (optionally a touch screen display), external display such as a monitor, projector, television, or a hardware component (optionally integrated or external) for projecting a user interface or causing a user interface to be visible to one or more users. In some embodiments, the one or more input devices include an electronic device or component capable of receiving a user input (e.g., capturing a user input or detecting a user input) and transmitting information associated with the user input to the electronic device. Examples of input devices include an image sensor (e.g., a camera), location sensor, hand tracking sensor, eye-tracking sensor, motion sensor (e.g., hand motion sensor) orientation sensor, microphone (and/or other audio sensors), touch screen (optionally integrated or external), remote control device (e.g., external), another mobile device (e.g., separate from the electronic device), a handheld device (e.g., external), and/or a controller.

In some embodiments, while a three-dimensional environment (e.g., three-dimensional environment 700 in FIG. 7A) is visible via the display generation component from a viewpoint of a first user (e.g., user 708 in FIG. 7A) of the first computer system, and while the first user of the first computer system is in a real-time communication session with a second user, different from the first user, of a second computer system, different from the first computer system, the first computer system displays (802), via the display generation component, a first visual representation of the second user (e.g., first representation 704 in FIG. 7A) at a first location in the three-dimensional environment relative to the viewpoint of the first user. In certain embodiments, the three-dimensional environment, generated, displayed, or otherwise made viewable by the first computer system, is perceptible from the viewpoint of the first user. In some embodiments, the three-dimensional environment is generated, displayed, or otherwise caused to be viewable by the first computer system. For example, the three-dimensional environment is an extended reality (XR) environment, such as a virtual reality (VR) environment, a mixed reality (MR) environment, or an augmented reality (AR) environment. In some embodiments, the three-dimensional environment includes one or more virtual objects and/or representations of objects in a physical environment of a user of the computer system. In some embodiments, the communication session is a real-time (e.g., or nearly real-time) communication session that includes audio (e.g., real-time voice audio from the first user and/or the second user, and/or audio content from media shared between the first user and the second user), video (e.g., real-time video of the environment of the first user and/or second user, and/or video content from media shared between the first user and the second user) and/or other shared content (e.g., images, applications, and/or interactive media (e.g., video game media)). In some embodiments, the first computer system optionally initiates and/or receives a request to join the communication session with the second computer system. In some embodiments, in response to initiating and/or receiving the request to join the communication session, the first and/or second computer systems initiate display of the three-dimensional environment to facilitate communication between the first user of the first computer system and the second user of the second computer system. In some embodiments, the first visual representation of the second user corresponds to a virtual avatar. For example, the virtual avatar corresponds to the second user (e.g., having one more visual characteristics corresponding to one or more physical characteristics of the user, such as the user's height, posture, skin color, eye color, hair color, relative physical dimensions, facial features and/or position within the three-dimensional environment). In some embodiments, the computer system displays the representation of the second user with a visual appearance having a degree of visual prominence relative to the three-dimensional environment. The degree of visual prominence optionally corresponds to a form of the representation of the user (e.g., an avatar having a human-like form and/or appearance or an abstracted avatar including less human-like form (e.g., corresponding to a generic two-dimensional or three-dimensional object, such as a virtual coin or a virtual sphere)). For example, the degree of visual prominence optionally includes and/or corresponds to a simulated blurring effect, a level of opacity, a simulated lighting effect, a saturation, and/or a brightness of a portion or all of the avatar. In an embodiment, the three-dimensional environment includes the first visual representation at a location visible from the perspective of the first user (e.g., inside of the viewport of the first user). In some embodiments, the first visual representation is located outside the perspective of the first user. For example, the first visual representation is located behind the viewport of the first user within the three-dimensional environment (e.g., outside of the viewport of the first user).

In some embodiments, while displaying the first visual representation of the second user at the first location relative to the viewpoint of the first user, the first computer system detects (804), via the one or more input devices, a first input (e.g., an air gesture (further described below) or interaction with a hardware input device) corresponding to selection of the first visual representation, such as the input provided by hand 709 in FIG. 7A. In some embodiments, the first input includes a voice command, an air gesture (e.g., an air pinching of a plurality of fingers contacting one another, an air pointing of one or more fingers, and/or air closing of one or more fingers), selection of a physical button and/or selection of a virtual button, and/or movement of the first user's viewpoint (e.g., the first user's position and/or orientation relative to the physical environment). In some embodiments, the computer system detects an air pinch gesture performed by a hand of the user of the computer system—such as the thumb and index finger of the hand of the user starting more than a threshold distance (e.g., 0.1, 0.2, 0.5, 1, 2, or 5 cm) apart and coming together and touching at the tips—that is detected by the one or more input devices (e.g., a hand tracking device) in communication with the first computer system. In some embodiments, the first input includes attention (e.g., including gaze) of the first user directed to the first visual representation in the three-dimensional environment. In some embodiments, the computer system detects the selection of the first visual representation via a hardware input device (e.g., a controller operable with six degrees of freedom of movement, or a touchpad or mouse) in communication with the computer system. For example, the computer system detects a selection input (e.g., a tap, touch, or click) via the one or more input devices corresponding to a gesture by the one or more fingers of the hand of the first user. In certain embodiments, the first input originates from the second computer system. For example, the second computer system uses a wireless communication infrastructure to direct the first input at a representation of the first user in the three-dimensional environment of the second computer system.

In some embodiments, in response to (and/or while) detecting the first input, the first computer system displays (806), via the display generation component, a communication session user interface (e.g., communication session user interface 716 in FIG. 7G) and a movement element associated with the communication session user interface (e.g., movement element 730 in FIG. 7G) in the three-dimensional environment. For example, in response to detecting the first input, the first computer system displays a communication session interface including a movement element concurrently with the first visual representation of the second user in the three-dimensional environment from the viewpoint of the first user. In some embodiments, the communication session user interface includes one or more standalone virtual buttons. For example, the one or more standalone virtual buttons are configured to be selectable by the first user. For instance, the one or more standalone buttons include a video conferencing button, a mute button configured to mute the first user, an exit button, and a screenshare button configured to share media content from the first computer system at the second computer system (e.g., in the communication session). In some embodiments, the communication session user interface and/or the movement element are displayed overlaid on the first visual representation of the second user or otherwise in front of the first visual representation of the second user from the viewpoint of the first user, and/or in proximity to (e.g., arranged adjacent to a border of) any media content shared between the first user and the second user in the three-dimensional environment (e.g., in the communication session). In some embodiments, the movement element allows the first user to interact with the first visual representation. For instance, the first visual representation is associated with (e.g., via proximity) the movement element (e.g., a grabber bar) that, when selected by the user (for instance by applying an air gesture such as an air pinch to the affordance while directing their gaze to the movement element), is used to move virtual objects (e.g., including the first visual representation and any shared virtual content) to various locations (optionally different from the first location) within the three-dimensional environment. In certain embodiments, the movement element is displayed as a grabber bar running parallel with and positioned below the communication session user interface. In some embodiments, the communication session user interface is displayed while the three-dimensional environment is visible.

In some embodiments, while displaying the first visual representation of the second user, the communication session user interface and the movement element in the three-dimensional environment, the first computer system detects (808), via the one or more input devices (e.g., 114a-114c in FIG. 7G), a first movement input, such as the input provided by hand 709 in FIG. 7G. In some embodiments, the first movement input includes the first user performing a hand air gesture while attention of the first user is directed to the movement element (e.g., an air tap, air pinch, air drag and/or air long pinch (e.g., optionally over a threshold period of time (e.g., 0.1, 0.5, 1, 2, 5 or 10 seconds)). The first user optionally performs hand movement while concurrently performing the above-described hand air gesture (e.g., moving their hand while in an air pinch hand shape in a direction relative to the three-dimensional environment (e.g., toward a location in the three-dimensional environment) to which the first user desires to move the virtual objects in the three-dimensional environment). In some embodiments, the first movement input corresponds to a touch input on a touch-sensitive surface in communication with the first computer system (e.g., a trackpad or a touch screen). In some embodiments, the first input corresponds to an input provided through a keyboard and/or mouse in communication with the first computer system. In some embodiments, the first movement input corresponds to an audio input (e.g., a verbal command) provided by the first user.

In some embodiments, in response to (and/or while) detecting the first movement input (810) (e.g., the first movement input is optionally ongoing and/or maintained while the computer system detects a maintaining of an air gesture (e.g., an air pinch gesture), a maintaining of a gaze, and/or maintaining of a selection of a virtual button of the one or more virtual buttons. In certain embodiments, the first movement input comprises a gaze directed at the representation of the second user), in accordance with a determination that the first movement input is directed to the movement element (e.g., the gaze and/or the air pinch gesture of the first user is directed to the movement element in the three-dimensional environment when the first movement input is detected), the first computer system updates (812) a spatial arrangement (e.g., position and/or orientation) of the first visual representation, the communication session user interface, and the movement element (e.g., and/or any other virtual objects/content that is shared between the first user and the second user) in the three-dimensional environment relative to the viewpoint of the first user (e.g., from a first spatial arrangement to a second spatial arrangement relative to the viewpoint) in accordance with the first movement input, such as the input provided by hand 709 in FIG. 7G. In certain embodiments, because the first movement input (e.g., comprising a gaze and/or an air pinch gesture, as discussed above) is determined to be directed at the movement element, the first movement input corresponds to a request to update the spatial arrangement of the first visual representation, the communication session interface and/or the movement element. In some embodiments, the first movement input corresponds to a request to update and/or results in updating the spatial arrangement of a plurality of virtual objects in accordance with a determination that the plurality of virtual objects are shared between at least the first user and the second user in the communication session within the three-dimensional environment (e.g., the plurality of virtual objects are displayed and/or accessible from the first and the second computer systems). In certain embodiments, the three-dimensional environment includes one or more virtual private objects (e.g., the private objects are private to the first computer system such that they are not displayed by one or more of the computer systems of the one or more users that are part of the communication session other than the first computer system) associated with the first user, and in response to the input directed to the movement element, the spatial arrangement of the one or more virtual private objects is maintained relative to the viewport of the first user during the update of the spatial arrangement of the aforementioned virtual objects (e.g., the shared virtual objects). In some embodiments, the request to update the spatial arrangement of the aforementioned list of virtual objects includes updating the positions of the virtual objects without altering the spatial arrangement (e.g., orientation and/or position) of the viewpoint of the first user relative to the three-dimensional environment. In some embodiments, the aforementioned virtual objects are moved from one or more first locations (e.g., including the first location of the first visual representation) in the three-dimensional environment to one or more second locations, different from the one or more first locations, in the three-dimensional environment relative to the viewpoint of the first user. For example, the first computer system moves the first visual representation from the first location to a second location, different from the first location, in accordance with the first movement input. In some embodiments, moving the first visual representation from the first location to the second location in the three-dimensional environment includes changing the distance of the first visual representation relative to the viewpoint of the first user (e.g., the second spatial arrangement includes a different depth from the viewpoint of the first user compared to the first spatial arrangement). In some embodiments, updating the spatial arrangement of the first visual representation, the communication session user interface, and the movement element in the three-dimensional environment includes moving the first visual representation, the communication session user interface, and the movement element laterally relative to the viewpoint of the first user (e.g., the second spatial arrangement includes a different lateral position (e.g., more leftward or rightward relative to the viewpoint of the first user compared to the first spatial arrangement) in the three-dimensional environment. For example, when updating the spatial arrangement of the aforementioned virtual objects, each of the virtual objects is laterally moved by the same magnitude (e.g., of distance and/or speed). In addition, as the virtual objects are moved by the same magnitude relative to the viewpoint of the first user, the spatial arrangement of the virtual objects relative to one another optionally remains unaltered. In some embodiments, when updating the spatial arrangement of the aforementioned virtual objects relative to the viewpoint of the first user, the magnitude and/or direction of the movement of the virtual objects (e.g., the magnitude and/or direction of the change in spatial arrangement) corresponds to a magnitude and/or the direction of the first movement input (the first movement input optionally comprising hand gestures such as a pinch and drag motion). In some embodiments, updating the spatial arrangement of the aforementioned virtual objects includes changing the orientation of each of the virtual objects relative to the viewpoint of the first user in the three-dimensional environment (e.g., according to polar or spherical coordinates relative to a reference location in the three-dimensional environment (e.g., the reference location corresponding to a location of the viewpoint of the first user in the three-dimensional environment)). For example, when updating the spatial arrangement of the aforementioned virtual objects, each orientation of the virtual objects is rotated an equal degree and/or a same direction (e.g., clockwise or counterclockwise) relative to the reference location. Furthermore, in other embodiments, moving and changing the orientation of the aforementioned virtual objects relative to the viewpoint of the first user in the three-dimensional environment occurs simultaneously (e.g., while detecting the first input). In some embodiments, the change in the spatial arrangement of the virtual objects relative to the viewpoint of the first user (e.g., corresponding to the distance and/or direction of the air pinch gesture) is a result of movement of the virtual objects in the three-dimensional environment corresponding to the first movement input (e.g., the distance and/or direction of the air pinch) relative to the three-dimensional environment. In some embodiments, the update to the spatial arrangement of the first visual representation, the communication user interface, and the movement element relative to the viewpoint of the first user does not include an update to the spatial arrangement of the corresponding virtual objects relative to one or more viewpoints of the second user. In certain embodiments, when the first computer system updates the spatial arrangement of the aforementioned virtual objects from the viewpoint of the first user, the second computer system updates display of a second visual representation (e.g., a virtual avatar as previously discussed above) of the first user in a three-dimensional environment (e.g., different from the three-dimensional environment of the first user) presented at the second computer system (e.g., by changing its position and/or orientation) relative to a viewpoint of the second user in that three-dimensional environment. For example, the second computer system moves the virtual avatar of the first user from a third location (e.g., different from the first and/or the second locations) to a fourth location, different from the third location, within the three-dimensional environment relative to a viewpoint of the second user. In some embodiments, the movement of the second visual representation of the first user is based on the updating of the spatial arrangement of (e.g., the movement and/or rotation of) the first visual representation, the communication session user interface, and the movement element caused by the first movement input (e.g., in direction and/or magnitude).

In some embodiments, in accordance with a determination that the first movement input is directed to the first visual representation of the second user (and/or the communication session user interface), the first computer system forgoes (814) updating the spatial arrangement of the first visual representation, the communication session user interface, and the movement element in the three-dimensional environment relative to the viewpoint of the first user, such as user 708 in FIG. 7E. In some embodiments, the first movement input includes the first user directing the first movement input (e.g., through attention directed to the virtual objects and/or the hand air gesture and/or movement described above) toward a location and/or object in the three-dimensional environment different from the movement element. For example, the first movement input is directed to the first visual representation. In certain embodiments, the first computer system does not update the spatial arrangement of the first visual representation, the communication session user interface, and the movement element in the three-dimensional environment relative to the viewpoint based on a determination that the first movement input is directed to the first visual representation, and instead performs an alternative operation. For example, such an input instead causes the first computer system to cease display of the communication session user interface and the movement element in the three-dimensional environment. Dynamically updating the spatial arrangement of elements in a real-time communication session, such as a visual representation of a second user, a user interface, and a movement element, based on whether user input for updating the spatial arrangement is directed to the movement element or the visual representation allows the user to manipulate the spatial arrangement of the elements in the real-time communication session in real-time, thereby improving the overall user experience during the real-time communication session, and helps avoid erroneous user input related to updating the spatial arrangement of the elements.

In some embodiments, while displaying the first visual representation of the second user (e.g., first representation 704 in FIG. 7E), the communication session user interface (e.g., communication session user interface 706 in FIG. 7E), and the movement element (e.g., movement element 730) in the three-dimensional environment (e.g., three-dimensional environment 700 in FIG. 7F) in the updated spatial arrangement (e.g., after detecting the first movement input discussed above) the first computer system detects, via the one or more input devices (e.g., 114a-114c), termination of the first movement input (e.g., hand 709 in FIG. 7E) directed to the movement element in the three-dimensional environment.

In some embodiments, in response to detecting the termination of the first movement input, ceasing display of the communication session user interface (e.g., communication session user interface 716 in FIG. 7F) and the movement element (e.g., movement element 730 in FIG. 7F) in the three-dimensional environment (e.g., three-dimensional environment 700 in FIG. 7F). In some embodiments, the movement element maintains display in the three-dimensional environment contingent on the constant detection of the first movement input. In some examples, the first movement input is a pinch and/or gaze initiated by the first user. In some embodiments, the display of the communication session user interface in the three-dimensional environment is ceased upon a determination that the first movement input is no longer detected at the moment element. In some embodiments, the detection of the termination of the first movement input being directed at the movement element is in response to a detection of a release of a hand gesture (e.g., an air pinch gesture) and/or a detection that the gaze of the first user is no longer directed toward the movement element. For example, the first user directs their gaze to a location in the three-dimensional environment that is not the movement element, in response, the display of the movement element in the three-dimensional environment is terminated. In some embodiments, the first computer system determines the termination of the first movement input according to a detection by the one or more input devices that the position of the hand of the first user of the first computer system is at a location proximate to a side of the first user. For example, the one or more input devices detects the first movement input as a gesture that results in the user dropping their hand outside the viewport, such as the user moving their arm from a folded position across their chest to a relaxed pose with the user's arm by their side. Ceasing the display of the communication session user interface after updating the spatial arrangement of the virtual objects in the three-dimensional environment reduces the visual clutter in the viewpoint of the first user and streamlines their attention towards virtual objects of interest.

In some embodiments, updating the spatial arrangement of the first visual representation (e.g., first representation 704 in FIG. 7G), the communication session user interface (e.g., communication session user interface 716 in FIG. 7G), and the movement element (e.g., movement element 730 in FIG. 7G) in the three-dimensional environment (e.g., three-dimensional environment 700 in FIG. 7G) relative to the viewpoint of the first user (e.g., user 708) includes moving the first visual representation, the communication session user interface, and the movement element in the three-dimensional environment relative to the viewpoint of the first user in accordance with the first movement input, such as the movement of the first representation 704, the communication session user interface 716, and the movement element 730 in accordance with the movement of the hand 709 in FIG. 7G. In some embodiments, the plurality of virtual objects (e.g., the first visual representation, the communication session user interface, and the movement element) is moved from first positions in the three-dimensional environment to second positions in the three-dimensional environment in accordance with a direction and/or magnitude (e.g., of distance and/or speed) of the first movement input (e.g., as indicated by the user (i.e., the first user)). For example, as previously discussed above, in response to detecting the first movement input directed to the movement element (e.g., the gaze of the user directed to the movement element while the hand of the user is moved in space (e.g., in an air pinch shape)), the first computer system updates the special arrangement of the plurality of virtual objects in the same way based on the user's manipulation of the movement element. In some embodiments, updating the position of the movement element is mirrored in distance and position by the rest of the virtual objects, resulting in a consistent spatial arrangement of the virtual objects in the three-dimensional environment following the first movement input (e.g., after the first movement input ends). The dynamic adjustment of the spatial arrangement of virtual objects in the three-dimensional environment relative to the viewpoint of the first user in response to detecting movement of the movement element allows the first user to control the positioning of virtual objects within the three-dimensional environment, thereby improving the overall user experience during the real-time communication session, and helps avoid erroneous user input related to updating the spatial arrangement of the virtual objects.

In some embodiments, while updating the spatial arrangement of the first visual representation (e.g., first representation 704 in FIG. 7G), the communication session user interface (e.g., communication session user interface 716 in FIG. 7G), and the movement element (e.g., movement element 730 in FIG. 7G) in the three-dimensional environment (e.g., three-dimensional environment 700 in FIG. 7G) relative to the viewpoint of the first user (e.g., user 708 in FIG. 7G) in accordance with the first movement input (e.g., input provided by hand 709 in FIG. 7G) in accordance with the determination that the first movement input is directed to the movement element (e.g., gaze 726 directed to movement element 730 in FIG. 7G), in accordance with a determination that the first movement input corresponds to movement of the movement element in a first direction away from the viewpoint of the first user (e.g., from a first location to a second location different than the first location) within the three-dimensional environment relative to the viewpoint of the first user, such as movement of hand 709 toward the viewpoint of the user 708 in FIG. 7G, the first computer system scales up the size of the communication session user interface (and optionally the movement element) relative to the three-dimensional environment in proportion to the first movement input (and optionally wherein the communication session user interface and the movement element remain the same displayed size relative to the viewpoint of the first user), such as scaling communication session user interface 716 in FIG. 7G.

In some embodiments, in accordance with a determination that the first movement input corresponds to a movement of the movement element in a second direction towards the viewpoint of the first user (e.g., input provided by hand 709 in FIG. 7G) (e.g., from the first location to a third location different than the first location and the second location) within the three dimensional environment relative to the viewpoint of the first user, the first computer system scales down the size the communication session user interface (and optionally the movement element) relative to the three-dimensional environment and in proportion to the first movement input (and optionally wherein the communication session user interface and the movement element remain the same displayed size relative to the viewpoint of the first user), as similarly described with reference to FIG. 7G. In some embodiments, during the updating of the spatial arrangement of a plurality of virtual objects, the first computer system leverages the user's movement input to update a size of the communication session user interface and the movement element within the three-dimensional environment. In some embodiments, upon determining that the first movement input is directed to the movement element and corresponds to movement in the first direction within the three-dimensional environment relative to the first user's viewpoint, the first computer system dynamically scales the communication session user interface and the movement element to maintain a consistent apparent size of the communication session user interface and movement element from the viewpoint of the user. For example, if the first direction corresponds to movement of the movement element toward the viewpoint of the user, the first computer system decreases the size of the communication session user interface and (optionally) the movement element in the three-dimensional environment to maintain an apparent size of the respective virtual objects relative to the viewpoint of the user. In some embodiments, in response to the user input corresponding to arranging the communication session user interface and the movement element in a second direction (e.g., away from the viewpoint of the user), different from the first direction, that causes the distance between the communication session user interface and the viewpoint of the user to increase, the first computer system increases the size of the communication session user interface and the movement element in the three-dimensional environment to maintain the apparent size of the respective virtual objects relative to the viewpoint of the user. In some embodiments, the apparent size of the communication session user interface from the viewpoint of the user is scaled up/down in proportion to the magnitude of the first direction. For example, the user moves the communication session user interface via the movement element to a position twice the distance away from the initial position of the communication session user interface, and in turn, the first computer system implements a corresponding increase in size of the communication session user interface by a factor of four. In certain embodiments, the dynamic scaling of the communication session user interface from the first location to the second location is accompanied by a corresponding scaling up of the size of the virtual buttons/controls included in the communication session user interface as discussed above. In certain embodiments, the communication session user interface and/or the movement element are a first size comprising a first length and a first width at a first distance from the viewpoint of the first user in the three-dimensional environment, where in accordance with the magnitude of the first movement input, the communication session user interface and/or the movement element are scaled to a second size comprising a scaled second length and a scaled second width at a second distance from the viewpoint of the first user, different than the first distance in the three-dimensional environment. For example, the second distance from the viewpoint of the first user is a greater distance than the first distance from the viewpoint of the first user; and so, the scaled second length and the second scaled width are greater than the first length and the first width in accordance with the magnitude of the first movement input. Introducing a conditional and directional aspect to the spatial arrangement update, where the scaling of interface elements is dynamically influenced by the user's movement input directed to a specific element within the three-dimensional environment, provides a nuanced adjustment that contributes to a more immersive and context-aware user interaction within the three-dimensional environment by enabling the interface elements to remain visible and therefor interactive to the user.

In some embodiments, displaying the communication session user interface (e.g., communication session user interface 716 in FIG. 716) in the three-dimensional environment (e.g., three-dimensional environment in FIG. 7B) in response to detecting the first input (e.g., gaze 726 and air pinch gesture provided by hand 709 in FIG. 7B) (e.g., an air gesture (further described below) or interaction with a hardware input device) includes displaying the communication session user interface at a first height relative to the viewpoint of the first user (e.g., user 708 in FIG. 7B) (e.g., and/or relative to gravity or a ground of the physical environment in which the display generation component is located) in the three-dimensional environment, such as displaying the communication session user interface 716 at the height indicated in the side view 713 in FIG. 7GG.

In some embodiments, the first height is based on a height of the first visual representation (e.g., second representation 706 in FIG. 7GG) in the three-dimensional environment. In some embodiments, the communication session user interface is displayed at a height that aligns to and/or corresponds to a height of the first visual representation. For example, the communication session user interface is displayed at a height relative to a floor of the three-dimensional environment, such that the communication session user interface has a particular angle of elevation relative to a reference vector or plane extending from the viewpoint of the first user to a center point of the horizon of the field of view of the first user and/or of the three-dimensional environment (e.g., a horizontal axis or plane extending across a center of the field of view). In this example, a center of the communication session user interface aligns with the shoulders, waist, and/or torso of the first user relative to the viewpoint of the first user. In some embodiments, the communication session user interface is initially displayed at a height that is based on the height of the first visual representation by a predetermined range of factors (e.g., 0.25× the first visual representation height, 0.5× the first visual representation height, 0.75× the first visual representation height). In some embodiments, the initial display height of the communication session user interface is determined to be a height proportional to the display height of the first visual representation chosen by the first user. For example, prior to initiating the display of the communication session user interface within the three-dimensional environment, the first user selects amongst a variety of affordances, an initial display height of the communication session user interface in at system settings of the first computer system. In some embodiments, the computer system displays the first visual representation at a plurality of heights including at least a first height and/or a second height in the three-dimensional environment relative to the viewpoint of the first user. For example, the computer system displays the first visual representation at the first height in the three-dimensional environment and displays the communication session user interface at a third height, corresponding to the first height, in the three-dimensional environment. In this example, the computer system updates the display of the first visual representation from the first height to the second height in the three-dimensional environment and, in response, the computer system automatically updates the communication session user interface from the third height to a fourth height, the fourth height corresponding to the second height. Displaying the height of the communication session user interface as proportional to the height of the avatar corresponding to another user increases the cohesiveness of the virtual objects displayed in the three-dimensional environment and/or reduces the number of virtual objects that the user will have to modify once the three-dimensional environment is initialized.

In some embodiments, for a given height of the first visual representation in the three-dimensional environment, in accordance with a determination that the first user is engaging in a non-spatial communication session with the second user, such as the second user being represented by the coin 705 in FIG. 7FF, the first height is a second height, such as the height of the communication session user interface 716 in the side view 713 in FIG. 7FF. In some embodiments, in accordance with a determination that the first user is engaging in a spatial communication session with the second user, such as the third user being represented by the second representation 706 in FIG. 7GG, the first height is a third height, different from the second height, such as the height of the communication session user interface 716 in the side view 713 in FIG. 7GG. In some embodiments, the placement of the communication session user interface relative to a ground within the three-dimensional environment is set according to a determination of communication session type. In some embodiments, the first user is determined to be in a non-spatial communication session (e.g., as discussed in more detail below) with the second user, resulting in the display of the communication session user interface within the three-dimensional environment at a height that does not overlay the non-spatial representation of the second user relative to the viewpoint of the first user. In some embodiments, the first user is determined to be in a spatial communication session (e.g., as discussed in more detail below) with the second user, resulting in the display height of the communication session user interface, relative to the ground of the three-dimensional environment, to be at a height different than the display height of the communication session user interface while in a non-spatial communication session from the viewpoint of the first user. In some embodiments, the height of the communication session user interface while in the spatial communication session is a height that allows the first user to view a face of the second user in its entirety straight on. For example, the communication session user interface is positioned at the chest-level corresponding to the virtual avatar of the second user, allowing the first user to view the entire face of the virtual avatar of the second user unobstructed, relative to the viewpoint of the first user in the three-dimensional environment. The communication session user interface being displayed at varying heights depending on the type of communication session serves as an additional indication to the user the type of communication session the user is engaging in and/or helps accommodate the different visual space occupied by a non-spatial versus spatial representation of another user in the communication session, thereby improving user-device interaction.

In some embodiments, the communication session user interface (e.g., the communication session user interface 716 in FIG. 7D) is displayed at a respective location in the three-dimensional environment (e.g., three-dimensional environment 700 in FIG. 7D) that has a respective spatial arrangement relative to the first location of the first visual representation (e.g., first representation 704 in FIG. 7D) in the three-dimensional environment. In some embodiments, the communication session user interface is positioned between the viewpoint of the first user and the first visual representation within the three-dimensional environment. For example, the communication session user interface is displayed at a location partially overlaying the first visual representation relative to the viewpoint of the first user. In certain embodiments, the respective spatial arrangement of the communication session user interface includes an initial position and/or orientation relative to the first visual representation. For example, from the viewpoint of the first user relative to the three-dimensional environment, the initial position is displayed at a location in the three-dimensional environment closer to the viewpoint of the first user than the first visual representation. In some embodiments, the communication session user interface has a fixed position and/or orientation relative to the first visual representation. In certain embodiments, in accordance with updating the spatial arrangement of the virtual objects as discussed above, the communication session user interface maintains the fixed position and/or orientation relative to the first visual representation. By tethering the communication session user interface's location to the coordinates of the first visual representation, this emphasizes that communication session user interface is tied to and influenced by the spatial arrangement of the first visual representation and enhances the cohesiveness of the three-dimensional environment.

In some embodiments, the respective location is a predefined ratio of a first distance away from the first visual representation (e.g., first representation 704 in FIG. 7A), wherein the first distance is between the viewpoint of the first user in the three-dimensional environment and the first visual representation when the communication session user interface is displayed in response to the first input, and the respective location is a second distance away from the first visual representation when the communication session user interface is displayed in response to the first input, as shown by the distance between the communication session user interface 716 and the first representation 704 in the side view in FIG. 7B. In some embodiments, the second distance is a shorter distance than the first in the three-dimensional environment. In some embodiments, the predefined ratio is set by the system settings of the computer system within in a range of ratios (e.g., 50%, 60%, 70%). In some embodiments, the second distance in which the communication session user interface is displayed lies within a range dependent on the first distance in which the first visual representation is displayed. In one example, the second distance is set to display the communication session user interface at a position that is 20% (or other suitable percentage, such as 25%, 30%, 35%, or 40%) of the distance of the first distance at which the first visual representation is displayed. Accordingly, as previously described herein, when the communication session user interface is displayed in the three-dimensional environment, the communication session user interface is displayed closer to the viewpoint of the first user than the first visual representation in the three-dimensional environment relative to the viewpoint of the first user. Displaying the communication session user interface at a location closer to the viewpoint of the first user than the first visual representation in the three-dimensional environment provides a point of stability and/or consistency in the three-dimensional environment as the first user manipulates their environment, thereby improving user-device interaction.

In some embodiments, in response to (and/or while) detecting the first movement input and in accordance with the determination that the first movement input is directed to the movement element, updating the spatial arrangement of the first visual representation, the communication session user interface, and the movement element in the three-dimensional environment relative to the viewpoint of the first user in accordance with the first movement input includes maintaining the display of the communication session user interface at the second distance away from the first visual representation in the three-dimensional environment relative to the viewpoint of the first user, such as shown by the distance between the communication session user interface 716 and the first representation 704 in FIGS. 7G-7I. In some embodiments, after and/or during the updating of the spatial arrangement, the communication session user interface is displayed at a position within the three-dimensional environment, different than respective positions of the movement element and the first visual representation. In some embodiments, as discussed previously above, the computer system displays the communication session user interface at a position in the three-dimensional environment that is calculated by the predetermined ratio of the first distance, and in response to the computer system detecting the first movement input, maintaining the predetermined ratio of the respective distances of the communication session user interface and the first visual representation when updating the respective virtual objects from a first group position to a second group position in the three-dimensional environment. In some embodiments, while updating the spatial arrangement of the first visual representation, the communication session user interface, and the movement element from their respective initial positions, the communication session user interface remains in its initial position within the three-dimensional environment relative to the first visual representation in the three-dimensional environment. For example, the spatial arrangement of the first visual representation, the communication session user interface, and the movement element are arranged in a position directly in front of the viewpoint of the first user within the three-dimensional environment. In this example, in accordance with the first movement input being a leftward gesture by the first user, the first visual representation and the movement element are moved to a position left of their initial respective positions from the viewpoint of the first user, while the communication session user interface remains directly in front of the first visual representation, relative to the viewpoint of the first user in the three-dimensional environment. In some embodiments, the first movement input comprises a “pull forward” gesture by the first user directed at the movement element, resulting in the first visual representation, the communication session user interface, and the movement element being moved closer to the viewpoint of the first user from their respective initial positions while the communication session user interface remains at the same distance from the first visual representation in the three-dimensional environment. In some embodiments, after updating the spatial arrangement of the first visual representation, the communication session user interface, and the movement element in the three-dimensional environment, the communication session user interface and the movement element are displayed at a location in the three-dimensional environment that is the fixed distance from the viewpoint of the first user in response to an additional input directed at the communication session user interface, such as a tap gesture. Maintaining the communication session user interface at a same distance from the first visual representation in the three-dimensional environment relative to the viewpoint of the first user while updating the spatial arrangement of various virtual objects helps retain visibility of the communication session interface, which increases the usability of the communication session user interface while performing other functions in the three-dimensional environment, thereby improving user-device interaction.

In some embodiments, the respective location of the communication session user interface (e.g., communication session user interface 716 in FIG. 7I) is a fixed distance from the first visual representation (e.g., first representation 704 in FIG. 7I) in the three-dimensional environment relative to the viewpoint of the first user. In some embodiments, the display of the first visual representation in the three-dimensional environment is at a location that is tied to the location of the first visual representation in the three-dimensional environment. In some embodiments, the location of the communication session user interface in the three-dimensional environment is determined by a pre-determined measurable distance from a front face of the communication session user interface to a front portion of the first visual representation in the three-dimensional environment. In one example, the pre-determined measurable distance is a range of numbers (e.g., 10 cm, 25 cm, 50 cm, 75 cm, or 100 cm). In some embodiments, while the computer system updates the respective spatial arrangements of the communication session user interface and the first visual representation, the communication session user interface remains at the fixed distance from the first visual representation in the three-dimensional environment. In this example, after the computer system completes updating the spatial arrangement of the communication session user interface and the first visual representation, the updated positions of the aforementioned virtual objects are the fixed distance apart in the three-dimensional environment. Displaying the communication session at a fixed distance away from the first visual representation relative to the viewpoint of the first user reduces the number of moving virtual objects in the three-dimensional environment and lowers the amount of split attention for the user, thereby improving user-device interaction.

In some embodiments, after updating the spatial arrangement of the first visual representation, the communication session user interface, and the movement element in the three-dimensional environment relative to the viewpoint of the first user in accordance with the first movement input, in accordance with the determination that the first movement input is directed to the movement element in response to detecting the first movement input, in accordance with a determination that attention (e.g., a gaze of the first user) of the first user is detected as being directed to the communication session user interface in the three-dimensional environment, the first computer system maintains the display of the communication session user interface (e.g., maintaining display of the communication session user interface 716 shown in FIG. 7E) and the movement element in the three-dimensional environment (e.g., maintaining display of the movement element 732 in FIG. 7E). In some embodiments, the spatial arrangement of the plurality of virtual objects is updated in accordance with the first movement input discussed above. In some embodiments, the first movement input corresponds to an air pinch and drag gesture by the first user from the viewpoint of the first user, resulting in updating the spatial arrangement of the plurality of objects to locations different from their respective initial locations in the three-dimensional environment from the viewpoint of the first user.

In some embodiments, the gaze of the first user is detected by the computer system as being directed at the communication session user interface after the first movement input ends. In this example, the gaze (i.e., the attention) satisfies a display requirement of the communication session user interface to continue being displayed in the three-dimensional environment. In some embodiments, the first movement input (e.g., a user gesture/movement) satisfies the determination that the attention of the first user is directed at the communication session user interface, thus resulting in the communication session user interface continuing to be displayed in the three-dimensional environment. In some embodiments, the attention of the first user does not correspond to a direction of the first movement input. For example, the first movement input comprises a gesture to the right relative to the viewpoint of the first user, while the attention of the first user simultaneously directed towards the communication session user interface located in a position directly in front of the viewpoint of the first user within the three-dimensional environment.

In some embodiments, in accordance with a determination that the attention of the first user is not detected as being directed to the communication session user interface in the three-dimensional environment, such as the gaze 726 not being directed to the communication session user interface 716 as shown in FIG. 7F, the first computer system ceases the display of the communication session user interface and the movement element in the three-dimensional environment, such as the communication session user interface 716 and the movement element 730 no longer being displayed as shown in FIG. 7F. In some embodiments, the computer system determines that the gaze (e.g., the attention) of the first user is no longer directed at the communication session user interface and triggers the cessation of the display of the communication session user interface within the three-dimensional environment. In some embodiments, the attention of the user is determined by one or more criteria including but not limited to: a gaze length threshold, one or more eye movements determined to be in the vicinity of the communication session and/or an alertness level. In some embodiments, the gaze of the first user is determined to be no longer directed at the communication session user interface by a detection of the gaze input exiting a boundary of the communication session user interface (e.g., and being directed to a different location in the three-dimensional environment). Requiring the communication session user interface to be displayed only if satisfying a gaze requirement reduces the number of virtual objects splitting the attention of the first user is lowered, which frees up the user to direct their attention to other virtual objects in the three-dimensional environment, and/or reduces the number of inputs needed to cease display of the communication session user interface in the three-dimensional environment, thereby improving user-device interaction.

In some embodiments, while displaying the first visual representation of the second user, the communication session user interface (e.g., communication session user interface 716 in FIG. 7I) and the movement element in the three-dimensional environment (e.g., detecting the first input or the first movement input discussed above), the first computer system determines that a threshold amount of time (e.g., threshold amount of time 753 in FIG. 7J) (e.g., 1 second, 5 seconds, 10 seconds, or 15 seconds) has elapsed since displaying the communication session user interface and the movement element in the three-dimensional environment, such as shown by amount of time 752 in FIG. 7J. In some embodiments, the threshold amount of time is a predetermined time set by the first computer system. In some embodiments, the threshold amount of time is a configurable metric changeable by the first user. For example, the first computer system defines a predetermined threshold time of five seconds but includes, in the system settings of the first computer system, an affordance for the first user to change the threshold time between an upper time limit and a lower time limit. In some embodiments, the threshold amount of time is configurable by the first user to be set as infinity.

In some embodiments, in response to determining that the threshold amount of time has elapsed (e.g., the 1 second, the 5 seconds, the 10 seconds, or the 15 seconds has elapsed) including in accordance with a determination that an input (e.g., such as the first movement input or another user input, optionally directed to the communication session user interface) is not detected within the threshold amount of time, the first computer system ceases the display of the communication session user interface and the movement element in the three-dimensional environment, such as ceasing display of the communication session user interface 716 and the movement element 730 as shown in FIG. 7J. In some embodiments, the first computer system includes one or more sensors configured to detect an input directed by the first user in the three-dimensional environment. In some embodiments, the first computer system ceases the display of one or more of the virtual objects in the three-dimensional environment after detecting that the threshold amount of time has elapsed without detecting any input via the one or more sensors. For example, after the threshold amount of time has elapsed since displaying the communication session user interface and the movement element, the first computer system ceases the display of the communication session user interface and the movement element in the three-dimensional environment. In some embodiments, the cessation of the communication session user interface and the movement element occurs instantaneously from the viewpoint of the first user once the threshold amount of time has elapsed. In some embodiments, once the threshold amount of time has elapsed, the communication session user interface will cease being displayed within the three-dimensional environment before the movement element ceases to be displayed. In some embodiments, the communication session user interface and the movement element cease their respective display in the three-dimensional environment with an animation (e.g., a fade-out animation, a dissolve animation, a shrinking circle animation). In some embodiments, the display of the communication session user interface and the movement element begins to cease displaying as the threshold amount of time approaches. For example, if the threshold amount of time is configured to be five seconds, at four seconds the communication session user interface and the movement begin the dissolving animation. In some embodiments, as the display of the communication session user interface and the movement element begins to cease displaying (e.g., according to the animation discussed above), if the first computer system detects, via the one or more input devices, a user input directed to the movement element, the first computer system reverses the cessation of displaying the communication session user interface and the movement element (e.g., reverses the animated fade out) to display or redisplay the communication session user interface and the movement element in the three-dimensional environment. The cessation of the display of certain virtual objects in the three-dimensional environment serves as a visual prompt to the user of inactivity after a threshold amount of time, and additionally serving to conserve computational power of the computer to be directed towards virtual objects in the three-dimensional environment that the user is directing their attention towards thereby enhancing the user experience.

In some embodiments, the communication session user interface is displayed at a respective location in the three-dimensional environment that has a respective spatial arrangement (e.g., shown by the location of the communication session user interface 716 in FIG. 7B) relative to the viewpoint of the first user in the three-dimensional environment (e.g., a predetermined spatial arrangement, such as distance and/or orientation, relative to the viewpoint of the first user) when the communication session user interface is displayed in response to the first input (e.g., gaze 726 and/or air pinch gesture provided by hand 709 in FIG. 7A). In some embodiments, the communication session user interface is displayed at a predetermined location in the three-dimensional environment from the viewpoint of the first user. In some embodiments, the display location of the communication session user interface is predetermined by the first computer system prior to an input provided by the first user to display the communication session user interface. In some embodiments, a respective location of the communication session user interface is predetermined to be a fixed distance from the viewpoint of the first user in the three-dimensional environment when initialized by the computer system and/or the first user. In some embodiments, the predetermined distance of the communication session user interface from the viewpoint of the first corresponds to a scaled real-world distance (i.e., is displayed at a distance in the three-dimensional environment to give the appearance, for example, of being five meters from the viewpoint of the first user). By determining a predetermined fixed distance from the user's viewpoint, the computer system maintains a stable position for the communication session user interface regardless of the user's movement within the three-dimensional environment, thereby enhancing user experience by providing a reliable reference point for accessing essential controls and information at the communication session user interface without causing distraction or disorientation.

In some embodiments, while updating the spatial arrangement of the first visual representation, the communication session user interface, and the movement element in the three-dimensional environment relative to the viewpoint of the first user in accordance with the first movement input in accordance with the determination that the first movement input is directed to the movement element in response to detecting the first movement input, such as while updating the spatial arrangement of the first representation 704, the communication session user interface 716, and the movement element 730 as shown in FIGS. 7G-7I, the computer system maintains the display of the communication session user interface with the respective spatial arrangement relative to (e.g., at a first distance from) the viewpoint of the first user in the three-dimensional environment, such as the communication session user interface 716 remaining at the same distance from the viewpoint of the user 708 between FIGS. 7G and 7H as shown in the overhead view 712. In some embodiments, the communication session user interface stays at a fixed distance from the viewpoint of the first user in the three-dimensional environment that is independent of the movement of other virtual objects in the three-dimensional environment. In some embodiments, as previously discussed above, the first user directs a movement input (e.g., the air pinch and drag gesture) at the movement element associated with the communication session user interface to update the spatial arrangement of one or more of the virtual objects in the three-dimensional environment while maintaining the fixed distance, from the viewpoint of the first user, of the communication session user interface in the three-dimensional environment. For example, the first user updates the spatial arrangement of the first visual representation from a position directly in front of the viewpoint of the first user to a position left and farther from the viewpoint of the first user, while the position of the communication session user interface is concurrently updated from the position directly in front of the viewpoint of the first user to the position left of the viewpoint of the first user while maintaining the fixed distance from the viewpoint of the first user. In some embodiments, the spatial arrangement of the first visual representation is updated according to a user air gesture to a position outside the viewpoint of the first user, while the spatial arrangement of the communication session user interface is maintained to be within the viewpoint of the first user. In some embodiments, the fixed distance of the displayed communication session user interface is determined by the first computer system to be a distance that is always within the viewpoint of the first user while updating the spatial arrangement of the communication session user interface within the three-dimensional environment. Maintaining a fixed distance of the communication session user interface while updating the spatial arrangement of the first visual representation, the communication session user interface, and the movement element facilitates user comfort and reduces motion sickness commonly associated with a virtual reality experience by providing a stable reference point for the user (i.e., maintaining the fixed distance of the communication session user interface) amidst the movement of other virtual objects

In some embodiments, while updating the spatial arrangement of the first visual representation, the communication session user interface, and the movement element in the three-dimensional environment relative to the viewpoint of the first user in accordance with the first movement input in accordance with the determination that the first movement input is directed to the movement element in response to detecting the first movement input, the first computer system ceases the display of the communication session user interface in the three-dimensional environment, such as ceasing display of the communication session user interface 716 as shown in FIG. 7H.

In some embodiments, in accordance with detecting termination of the first movement input, such as detecting an end of the input provided by the hand 709 as shown in FIG. 7I, the first computer system displays, via the display generation component, the communication session user interface with the respective spatial arrangement relative to (e.g., is displayed at the first distance from) the viewpoint of the first user, such as displaying the communication session user interface 716 as shown in FIG. 7I. In some embodiments, the first computer system ceases the display of one or more virtual objects in the three-dimensional environment while updating the spatial arrangements of the one or more virtual objects, such as the first visual representation, the communication session user interface, and the movement element. In some embodiments, in response to the movement input directed at the movement element, the first computer system ceases the display of the communication session user interface but not the display of the first visual representation or the movement element while updating the spatial arrangement of the respective virtual objects in the three-dimensional environment. In some embodiments, when updating the spatial arrangement of the communication session user interface, the cessation of the display of the communication session user interface comprises altering the opacity of the communication session user interface. For example, while updating the spatial arrangement of the communication session user interface, the communication session user interface is displayed with an opacity in a range of opacities under 100% (e.g., 75% opacity, 50% opacity, 25% opacity). In some embodiments, the first computer system ceases the display of the communication session user interface while updating the spatial arrangement of the communication session user interface and displays the first visual representation in the range of opacities under 100% while updating their respective spatial arrangements. In some embodiments, after the first computer system determines the first user is no longer directing the movement input at the movement element, the first computer system initiates the display of the communication session user interface at the updated position in accordance with the movement input by the first user. For example, the first user directs the movement input at the communication session user interface from a position directly in front of the viewpoint of the first user to a position to the right of the viewpoint of the first user. In this example, the first computer system ceases the display of the communication session user interface while updating the spatial arrangement of the communication session user interface from the position in front of the viewpoint of the first user to the position to the right of the viewpoint of the first user and redisplays the communication session user interface user interface once the first computer system determines the communication session user interface is now at the position to the right of the viewpoint of the first user. In some embodiments, the computer system re-displays the first visual representation after the computer system determines that the first user is no longer directing the movement input at the movement element. In this example, the updated position of the communication session user interface and the updated position of the first visual representation are the fixed distance from each other in the three-dimensional environment. In some embodiments, the first movement input comprises the first user drawing the first visual representation from a first position near an environmental edge (e.g., a wall of the three-dimensional environment) across from the viewpoint of the first user to a second position closer to the viewpoint of the first user than the first position in the three-dimensional environment. In this example, the communication session user interface is displayed at third position the fixed distance away from the first position and when the first visual representation is displayed at the second position, the computer system displays the communication session user interface at a fourth position the fixed distance away from the second position in the three-dimensional environment. In some embodiments, detecting termination of the first movement input has one or more characteristics of detecting termination of inputs discussed above. Ceasing the display of a virtual object while updating its respective position in a three-dimensional environment serves to reduce the rendering load on the first computer system, especially when the spatial arrangement of multiple virtual objects are simultaneously updated, and/or allows the user to focus their attention unobstructed on the positioning of the first visual representation.

In some embodiments, while updating the spatial arrangement of the first visual representation, the communication session user interface, and the movement element in the three-dimensional environment relative to the viewpoint of the first user in accordance with the first movement input in accordance with the determination that the first movement input is directed to the movement element in response to detecting the first movement input (e.g., the air tap, the air pinch, the air drag and/or air long pinch initiated by the first user), the first computer system updates the spatial arrangement of the communication session user interface and the movement element in a first manner relative to the viewpoint of the first user, such as moving the communication session user interface 716 and the movement element 730 to within threshold boundary 782 in the overhead view 712 in FIG. 7N. In some embodiments, when updating the spatial arrangement of the communication session user interface and the movement element, the respective locations of the communication session user interface and the movement element are updated with a first movement animation. For example, the update of the spatial arrangement of the communication session user interface and the movement element include a bounce animation, bouncing back slightly before settling into place once the movement of the communication session user interface and the movement element ends. In some embodiments, while updating the spatial arrangement of the first visual representation from a first location to a second location (as previously discussed above) in response to the first movement input, the spatial arrangement of the communication session user interface, the movement element is updated from the first location to the second location where the second location of the communication session user interface and the movement element is farther from the viewpoint of the first user than the second location of the first visual representation.

In some embodiments, the first computer system updates the spatial arrangement of the first visual representation in a second manner, different from the first manner, relative to the viewpoint of the first user, such as preventing movement of the virtual object 702 and the first representation 704 to within the threshold boundary 782 in the overhead view 712 in FIG. 7N. In some embodiments, while updating the spatial arrangement of the virtual objects in the three-dimensional environment, the movement of the virtual objects is characterized with a second movement animation, different than the first movement animation. In some embodiments the first movement animation is a linear animation (e.g., a type of animation where the object moves in a straight line from one point to another without any acceleration or deceleration) of the spatial update of the communication session user interface and the movement element, and the second movement animation is an easing animation (e.g., an ease-in animation and/or an ease-out animation) of the spatial update of the first visual representation. In some embodiments, the first manner is represented in the three-dimensional environment with the first movement animation at a first magnitude and the second manner is represented in the three-dimensional environment with the second movement animation at a second magnitude, less than the first magnitude. In some embodiments, the first magnitude of the first movement animation and the second magnitude of the second movement animation are represented by a linear movement towards and/or away from the viewpoint of the first user in the three-dimensional environment, where the first movement animation is smaller than the second movement animation. In some embodiments, the first manner and the second manner are represented by an angular movement animation across the viewpoint of the first user in the three-dimensional environment. In this example, the first manner and the second manner, represented by the angular movement animation, are of equal magnitude relative to the viewpoint of the first user. In some embodiments, the spatial arrangement of the communication session user interface and the first visual representation is updated in accordance with the first manner and the second manner from a first spatial arrangement to a second spatial arrangement, different than the first spatial arrangement. In this example, while updating the communication session user interface and the first visual representation from the first spatial arrangement to the second spatial arrangement, the respective spatial arrangements of the virtual objects, not including the communication session user interface, remains unchanged. In some embodiments, the first manner and the second matter are displayed as the same animation relative to the viewpoint of the first user. In some embodiments, the first manner includes a first movement speed when updating the spatial arrangement of the communication session user interface and the movement element and a second movement speed when updating the spatial arrangement of the first visual representation to illicit a parallax animation effect between the communication session user interface, the movement element, and the first visual representation relative to the viewpoint. Moving a first set of virtual objects in a different manner than a second set of virtual object introduces parallax within the three-dimensional environment, which involves the alteration of the movement characteristics (e.g., the first manner and the second manner) of virtual objects relative to the viewpoint of the first user, thereby enhancing the depth perception experienced by the user, and replicating the natural depth cues observed in the physical world within the three-dimensional environment.

In some embodiments, the communication session user interface (e.g., communication session user interface 716 in FIG. 7D) includes a plurality of interactive communication session controls (e.g., interactive elements 716a-e in FIG. 7D). In some embodiments, the communication session user interface includes a variety of interactive communication session controls encompassing a range of features, functionalities, and/or tools aimed at facilitating and/or modifying the communication between users (e.g., the first user and the second user) within the three-dimensional environment. For example, the communication session user interface includes virtual buttons, sliders, or other interactive elements such as a mute button, enabling the user to optionally silence audio input during the communication session. In some embodiments, a video conferencing button is included in the plurality of communication session controls, allowing users to seamlessly transition between audio and video communication modes to allow the user to tailor their communication experience to specific needs or preferences. In some embodiments, controls to end the communication session or share content in the three-dimensional environment are also included in the plurality of communication session controls. For example, in selecting (e.g., by providing an input initiated by the user of the first computer system) the control to end the communication session, the first computer system subsequently ceases the display of the first virtual representation and/or generate a visual representation (e.g., a notification or other user interface element) of a confirmation to cease the communication session. In some embodiments, if the first computer system detects a selection of the interactive communication session control associated with sharing content with the user of a different computer system, the first computer system generates (e.g., displays) a plurality of interactive options for sharing the content. For example, the first computer system generates a list of open applications at the first computer system, wherein the selection of any of the open applications initiates a process to share the content of the respective application with other users in the communication session, including the second user. Including a plurality of interactive communication session controls allows the user to maintain control over one or more aspects of communication within the communication session with other users, and/or facilitates ease of interaction with the controls via their inclusion within the three-dimensional environment upon display of the communication session user interface, which also improves the overall user experience during the real-time communication session.

In some embodiments, while displaying the communication session user interface (e.g., communication session user interface 716 in FIG. 7D) in the three-dimensional environment (e.g., three-dimensional environment 700 in FIG. 7D) before detecting the first movement input (input provided by hand 709 in FIG. 7D), the communication session user interface is displayed with a first orientation relative to the environment facing the viewpoint of the first user (e.g., user 708 in FIG. 7D), such as the orientation of the communication session user interface 716 in FIG. 7D.

In some embodiments, after updating the spatial arrangement of the first visual representation, the communication session user interface, and the movement element in the three-dimensional environment relative to the viewpoint of the first user in accordance with the first movement input, the communication session user interface is displayed with a second orientation (e.g., orientation of communication session user interface 716 in FIG. 7E) relative to the environment facing the viewpoint of the first user, wherein the first orientation is different from the second orientation. In some embodiments, when the first computer system updates the spatial arrangement of the first visual representation, the communication session user interface, and the movement element in accordance with the first movement input (e.g., in a respective direction, such as to the left or right) relative to the user's viewpoint, (e.g., in accordance with a leftward or rightward movement of the hand of the user, as previously discussed above), the orientation of the communication session user interface is dynamically updated to continue aligning a front face of the communication session user interface (e.g., aligning a normal of the front face of the communication session user interface) to the viewpoint of the first user. In certain embodiments, the plurality of interactive controls (e.g., virtual buttons, sliders, or other interactive elements as discussed above) associated with the communication session user interface continue to remain visible from the viewpoint of the first user in accordance with the change in orientation associated with the communication session user interface. In certain embodiments, the first movement input does not define the orientation of the communication session user interface, rather the first computer system automatically updates the orientation of the communication session user interface to align the normal of the front face of the communication session user interface to the viewpoint of the first user in response to the first movement input updating the spatial arrangement of the communication session user interface. In certain embodiments, the orientation of other virtual objects (e.g., a virtual application window, a video conferencing user interface, or other virtual object) displayed in the three-dimensional environment—relative to each other and/or relative to the three-dimensional environment—is not updated in response to the first user updating the spatial arrangement of the first visual representation, the communication session user interface, and the movement element, or the orientation of the other virtual objects is updated but differently than the orientation of the communication session user interface; and in such a circumstance, such change of orientation is optionally defined by the first movement input. By adjusting the orientation of the communication session user interface based on the change of the spatial arrangement of the virtual objects, the computer system enhances user engagement and interaction. This dynamic orientation of the communication session user interface ensures that the displayed content aligns with the user's viewpoint, creating a more immersive and natural interaction.

In some embodiments the real-time communication session further includes a third user (, different than the first user (e.g., user 708 in FIG. 7G) and the second user, of a third computer system, different than the first computer system (e.g., computer system 101 in FIG. 7G) and the second computer system, and the three-dimensional environment (e.g., three-dimensional environment 700 in FIG. 7G) further includes a second visual representation (e.g., second representation 706 in FIG. 7G) of the third user at a second location, different than the first location, in the three-dimensional environment relative to the viewpoint of the first user. In some embodiments, as similarly discussed above, the first computer system initiates and/or receives a request to join the communication session with the third computer system, different than the second computer system (e.g., in addition to initiating and/or receiving the request to join the communication session with the second computer system). In some embodiments, in response to initiating and/or receiving the request to join the communication session, the first and/or second and/or third computer systems initiate display of the three-dimensional environment to facilitate communication between the first user of the first computer system, the second user of the second computer system, and the third user of the third computer system. In some embodiments, the second visual representation of the third user corresponds to a virtual avatar (e.g., different from the virtual avatar of the second user). In some embodiments, the three-dimensional environment includes the second visual representation at a second location, different from the first location of the first visual representation from the perspective of the first user (e.g., inside of the viewport of the first user). In some embodiments, the second visual representation has one or more of the characteristics of the virtual avatar corresponding to the first visual representation as discussed above.

In some embodiments, while displaying the first visual representation of the second user, the second visual representation of the third user, the communication session user interface at a first location based on the first visual representation in the three-dimensional environment (e.g., having the respective spatial arrangement relative to the first visual representation of the second user previously described), and the movement element (e.g., movement element 730 in FIG. 7G), the first computer system detects, via the one or more input devices (e.g., 114a-114c in FIG. 7G), a second input (e.g., input provided by hand 709 in FIG. 7G) (e.g., after detecting the first input described above). In some embodiments, the second input has one or more characteristics of the first input described above. In some embodiments, the communication session user interface is displayed partially overlaying the first visual representation from the viewpoint of the first user when the second input is detected. For example, the communication session user interface is displayed between the viewpoint of the first user and the first visual representation in the three-dimensional environment when the second input is detected.

In some embodiments, the first computer system responds to detecting the second input in accordance with a determination that the second input is directed to the second visual representation (e.g., gaze 726 directed to second representation 706 in FIG. 7R). For example, the first computer system detects the gaze of the first user directed to the second visual representation, followed by an air pinch gesture, as similarly discussed above.

In some embodiments, the first computer system ceases displaying the communication session user interface at the first location based on the first visual representation in the three-dimensional environment, as similarly discussed with reference to FIG. 7R). In some embodiments, the communication session user interface associated with the second visual representation is displayed before the detection of the second input and ceases to be displayed in response to detecting the second input.

In some embodiments, the first computer system initiates the display of the communication session user interface at a second location (e.g., communication session user interface 716 in FIG. 7R), different than the first location, based on the second visual representation in the three-dimensional environment. (e.g., having the respective spatial arrangement relative to the second visual representation of the third user previously described). For example, the first computer system redisplays the communication session user interface at a location in the three-dimensional environment that is between the second visual representation and the viewpoint of the first user. In some embodiments, when the communication session user interface is redisplayed in the three-dimensional environment, the communication session user interface is at least partially overlaid on and/or in front of the second visual representation of the third user from the viewpoint of the first user. In some embodiments, the communication session user interface is displayed at a first location associated with the first visual representation and redisplayed at a second location different than the first location associated with the second visual representation. In some embodiments, initiating the display of the communication session user interface associated with the second visual representation is accompanied by a sound effect and/or visual cue when initializing the display. In one example, the first computer system plays the sound effect as though the sounds were emanating from a specific position/location and/or region within the three-dimensional environment (e.g., such as a location of the second visual representation in the three-dimensional environment). Ceasing display of the communication session user interface that is displayed based on a location of the first visual representation and redisplaying the communication session user interface based on a location of the second visual representation in response to detecting an input directed to the second visual representation reduces clutter and/or unnecessary duplication of display of virtual objects in the three-dimensional environment, thereby enhancing the efficiency of interactions among multiple users.

In some embodiments, the real-time communication session further includes a third user, different than the first user (e.g., user 708 in FIG. 7G) and the second user, of a third computer system, different than the first computer system (e.g., computer system 101 in FIG. 7G) and the second computer system, and the three-dimensional environment (e.g., three-dimensional environment 700 in FIG. 7G) further includes a second visual representation (e.g., second representation 706 in FIG. 7G) of the third user at a second location, different than the first location, in the three-dimensional environment relative to the viewpoint of the first user. In some embodiments, as similarly discussed above, the first computer system initiates and/or receives a request to join the communication session with the third computer system, different than the second computer system (e.g., in addition to initiating and/or receiving the request to join the communication session with the second computer system). In some embodiments, in response to initiating and/or receiving the request to join the communication session, the first and/or second and/or third computer systems initiate display of the three-dimensional environment to facilitate communication between the first user of the first computer system, the second user of the second computer system, and the third user of the third computer system. In some embodiments, the second visual representation of the third user corresponds to a virtual avatar (e.g., different from the virtual avatar of the second user). In some embodiments, the three-dimensional environment includes the second visual representation at a second location, different from the first location of the first visual representation from the perspective of the first user (e.g., inside of the viewport of the first user). In some embodiments, the second visual representation has one or more of the characteristics of the virtual avatar corresponding to the first visual representation as discussed above.

In some embodiments, while displaying the first visual representation of the second user, the second visual representation of the third user, the communication session user interface at a first location based on the first visual representation in the three-dimensional environment (e.g., having the respective spatial arrangement relative to the first visual representation of the second user previously described), and the movement element (e.g., movement element 730 in FIG. 7G), the first computer system detects, via the one or more input devices (e.g., 114a-114c in FIG. 7G), a second input (e.g., input provided by hand 709 in FIG. 7G) (e.g., after detecting the first input described above). In some embodiments, the second input has one or more characteristics of the first input described above. In some embodiments, the communication session user interface is displayed partially overlaying the first visual representation from the viewpoint of the first user when the second input is detected. For example, the communication session user interface is displayed between the viewpoint of the first user and the first visual representation in the three-dimensional environment when the second input is detected.

In some embodiments, the first computer system responds to detecting the second input in accordance with a determination that the second input is directed to the second visual representation (e.g., gaze 726 directed to second representation 706 in FIG. 7G). For example, the first computer system detects the gaze of the first user directed to the second visual representation, followed by an air pinch gesture, as similarly discussed above.

In some embodiments, the first computer system ceases displaying the communication session user interface at the first location based on the first visual representation in the three-dimensional environment, as similarly discussed with reference to FIG. 7R). In some embodiments, the communication session user interface associated with the second visual representation is displayed before the detection of the second input and ceases to be displayed in response to detecting the second input.

In some embodiments, the first computer system initiates the display of the communication session user interface at a second location (e.g., communication session user interface 716 in FIG. 7R), different than the first location, based on the second visual representation in the three-dimensional environment. (e.g., having the respective spatial arrangement relative to the second visual representation of the third user previously described). For example, the first computer system redisplays the communication session user interface at a location in the three-dimensional environment that is between the second visual representation and the viewpoint of the first user. In some embodiments, when the communication session user interface is redisplayed in the three-dimensional environment, the communication session user interface is at least partially overlaid on and/or in front of the second visual representation of the third user from the viewpoint of the first user. In some embodiments, the communication session user interface is displayed at a first location associated with the first visual representation and redisplayed at a second location different than the first location associated with the second visual representation. In some embodiments, initiating the display of the communication session user interface associated with the second visual representation is accompanied by a sound effect and/or visual cue when initializing the display. In one example, the first computer system plays the sound effect as though the sounds were emanating from a specific position/location and/or region within the three-dimensional environment (e.g., such as a location of the second visual representation in the three-dimensional environment). Ceasing display of the communication session user interface that is displayed based on a location of the first visual representation and redisplaying the communication session user interface based on a location of the second visual representation in response to detecting an input directed to the second visual representation reduces clutter and/or unnecessary duplication of display of virtual objects in the three-dimensional environment, thereby enhancing the efficiency of interactions among multiple users.

In some embodiments, the second movement input (e.g., input provided by hand 709 in FIG. 7E) comprises an air pinch and drag gesture performed by the first user (e.g., user 708 in FIG. 7E) and directed to the communication session user interface (e.g., gaze 727 directed at communication session user interface 716 in FIG. 7E). In some embodiments, the gesture directed to the communication session user interface is an input interacting with the communication session user interface that is performed by one or more hands of the user, a movement of the one or more hands of the user, a gaze by the user at a respective location, a voice command, and/or the like. For example, as similarly discussed above, the first computer system optionally receives, via the one or more input devices, an air pinch gesture (e.g., two or more fingers of a user's hand such as the thumb and index finger moving together and touching each other) to form a pinch hand shape while attention (e.g., including gaze) of the user is optionally directed to the communication session user interface (e.g., and not to the movement element), and while maintaining the pinch gesture, the first computer system receives movement of a portion (e.g., a hand, arm, and/or finger) of the user in space. In some embodiments, the gesture corresponding to the second movement input is directed at the communication session user interface and not to the movement element. Forgoing updating a spatial arrangement of the virtual objects in a three-dimensional environment in response to detecting an air pinch and drag input directed to the communication session user interface helps reduce or avoid unintentional updating of the spatial arrangement of the virtual objects in the three-dimensional environment, thus minimizing the occurrence of erroneous user input and improving user-device interaction.

In some embodiments, the second movement input (e.g., represented by dashed arrow of overhead view 712 in FIG. 7R) comprises movement of the viewpoint of the first user (e.g., user 708 in FIG. 7R) relative to the three-dimensional environment (e.g., three-dimensional environment 700 in FIG. 7R). In some embodiments, the first computer system detects the movement of the viewpoint of the first user without detecting input provided by one or more hands of the first user (e.g., an air pinch gesture). In some embodiments, the second input causes the viewpoint of the first user move (e.g., shift and/or rotate) relative to the communication session user interface in the three-dimensional environment, but does not cause the location of the communication session user interface (and the locations of the first visual representation and the movement element) to change in the three-dimensional environment. In certain embodiments, the viewpoint is tied to the display generation component, the display generation component being affixed to the user in such a way that movement of the user (e.g., the second movement input) shifts the display generation component, corresponding to the movement of the viewpoint of the first user. In some embodiments, the second movement input corresponds to a movement of the user's head resulting in a movement of the viewpoint of the first user relative to the three-dimensional environment. For example, the display generation component is fixed to the user's head, wherein a rotation of the user's head (e.g., the second movement input), results in a rotation of the viewpoint of the first user relative to the three-dimensional environment of equal magnitude to the rotation of the user's head. In some embodiments, the first computer system detects the second movement input corresponding to a movement of the display generation component by the hands of a user, resulting in the movement of the viewpoint of the first user relative to the three-dimensional environment. Forgoing updating a spatial arrangement of the virtual objects in a three-dimensional environment in response to detecting movement of the viewpoint of the first user helps reduce or avoid unintentional updating of the spatial arrangement of the virtual objects in the three-dimensional environment, thus minimizing the occurrence of erroneous user input and improving user-device interaction.

In some embodiments, the communication session user interface (and the movement element are not displayed in the three-dimensional environment prior to the first computer system detecting the first input) (and/or when the first input is detected) corresponding to selection of the first visual representation, such as the communication session user interface 716 and the movement element 730 not being displayed in FIG. 7A prior to detecting the input provided by the hand 709 directed at first representation 704 in FIG. 7A. In some embodiments, the communication session user interface and the movement element are not displayed prior to the selection of the first visual representation by the user discussed previously above. Forgoing display of the communication session user interface and the movement element prior to the detection of the first input directed at the first visual representation mitigates clutter in the three-dimensional environment and minimizes user distraction by deferring the display of non-essential information until it becomes necessary or desired for the user.

In some embodiments, in response to detecting the second input, the first computer system displays, via the display generation component, the one or more system objects and the communication session user interface (e.g., communication session user interface 716 in FIG. 7CC) in the three-dimensional environment, without displaying the movement element associated with the communication session user interface in the three-dimensional environment (e.g., movement element 730 is not shown in FIG. 7CC). In some embodiments, displaying the one or more system objects (e.g., the control center user interface) includes the display of the communication session user interface but does not include the display of the movement element associated with the communication session user interface. In some embodiments, the first computer system displays the one or more system objects and the communication session user interface in a predefined location of the three-dimensional environment, such as in the predefined region discussed above. In some embodiments, the first computer system displays the one or more system objects and the communication session user interface at a location in the three-dimensional environment that is designated for displaying the one or more system objects (e.g., such as a notifications center). In some embodiments, the one or more system objects and/or communication session user interface are arranged to be displayed in a predetermined spatial arrangement (e.g., position and/or orientation) in the three-dimensional environment relative to the viewpoint of the first user. In certain embodiments, the one or more system objects and/or communication session user interface are not displayed between the viewpoint of the first user and the first visual representation as previously discussed above (e.g., not displayed with the respective spatial arrangement previously described relative to the visual representation(s) of users in the communication session). In some embodiments, the one or more system objects correspond to the plurality of interactive controls associated with the communication session user interface as previously discussed above. In some embodiments, in accordance with a movement input directed to the communication session user interface, such an input does not result in updating the spatial arrangement of the communication session user interface and the one or more system objects relative to the viewpoint of the first user and/or the three-dimensional environment (e.g., does not result in the type of result that occurs in response to the first input described with reference to method 800). Displaying the communication session user interface when displaying the one or more system objects in the three-dimensional environment enables user interaction with external content and/or system controls of the first computer system within the three-dimensional environment, negates the necessity to exit the three-dimensional environment, while the omission of the movement element associated with the communication session user interface serves to prevent erroneous updates of the spatial arrangements of the virtual objects discussed above when interacting with the external content and/or system controls of the first computer system displayed by the one or more system objects.

In some embodiments, while displaying the one or more system objects (e.g., system controls user interface 722 in FIG. 7CC) and the communication session user interface in the three-dimensional environment, the first computer system determines that a threshold amount of time (e.g., threshold time 753 in FIG. 7DD) (e.g., 1 second, 5 seconds, 10 seconds, or 15 seconds) has elapsed (e.g., elapsing of amount of time 752 in FIG. 7DD) since displaying the one or more system objects and the communication session user interface in the three-dimensional environment. In some embodiments, the first computer system includes a time-detection component configured to determine that the threshold amount of time has elapsed. In some embodiments, the time-detection component is further configured to begin tracking a display time of the one or more system objects in response to the detection of the second input. In some embodiments, the threshold amount of time corresponds to the threshold amount of time associated with the display of the communication session user interface as discussed previously above. For example, the threshold amount of time corresponds to the predetermined threshold amount of time of five seconds determined by the computer system. In some embodiments, the computer system initiates the time-detection component in response to the first computer system detecting the second input by the first user in the three-dimensional environment. In some embodiments, the threshold amount of time associated with the one or more system objects and the threshold amount of time associated with the communication session user interface are not an equivalent amount of time. In some embodiments, the time-detection component is associated with the display of the one or more system objects in the three-dimensional environment, and not the display of the communication session user interface.

In some embodiments, in response to determining that the threshold amount of time has elapsed including in accordance with a determination that an input (optionally directed to the one or more system objects and/or the communication session user interface) is not detected within the threshold amount of time (e.g., threshold time 753 in FIG. 7DD), the first computer system ceases, via the display generation component, the display of the one or more system objects (e.g., ceasing display of the system controls user interface 722 in FIG. 7DD) and the communication session user interface (e.g., ceasing display of the communication session user interface 716 in FIG. 7DD) in the three-dimensional environment. In some embodiments, the computer system ceases the display of the one or more system objects in the three-dimensional environment at a time prior to ceasing the display of the communication session user interface in the three-dimensional environment. In some embodiments, the determination that an input has not been detected during the threshold amount of time excludes inputs detected by the computer system not directed at the one or more system objects and/or the communication session user interface within the three-dimensional environment. In some embodiments, the input must satisfy one or more criteria to be detected during the threshold amount of time. For example, the first user directs an input to shared content in the three-dimensional environment that does not satisfy a criterion of the one or more criteria of the input during the threshold amount of time. In another example, a criterion of the one or more criteria includes a user gaze directed at one or more virtual objects within the viewpoint of the first user in the three-dimensional environment. Ceasing the display of the one or more system objects and the communication session user interface in the three-dimensional environment after the threshold amount of time has elapsed prevents the user's attention from being split while directing their attention at other virtual objects in the three-dimensional environment that are not included the one or more system objects and/or the communication session user interface and/or reduces the number of inputs needed to cease display of the communication session user interface.

In some embodiments, while displaying the first visual representation of the second user, the communication session user interface and the movement element in the three-dimensional environment in response to the first input, the first computer system determines that a threshold amount of time (e.g., a 10 second range, a 30 second range, and a 1-minute range) has elapsed without a detection of a second input directed at the communication session user interface since displaying the communication session user interface and the movement element in the three-dimensional environment, such as threshold time 753 elapsing as shown in FIG. 7J. In some embodiments, the threshold amount of time corresponds to the threshold amount of time predetermined by the first computer system as described similarly above with reference to ceasing the display of the communication session user interface in the three-dimensional environment after determining no additional input was detected after a threshold amount of time has elapsed. In some embodiments, the threshold amount of time is a predetermined amount of time set by the first computer system. In some embodiments, the threshold amount of time is set by the first computer system and is additionally configured to be customizable within a range of time (e.g., the range of time comprising a 10 second range, a 30 second range, and a 1-minute range). For example, the threshold amount of time within a range of 1-10 seconds. In some embodiments, the time-detection component described above with reference to ceasing the display of the one or more system objects after not detecting an input after a threshold amount of time has elapsed. In some embodiments the time-detection component is triggered after a determination that the communication session user interface has been displayed.

In some embodiments, in response to determining that the threshold amount of time has elapsed, the first computer system ceases, via the display generation component, the display of the communication session user interface and the movement element in the three-dimensional environment, such as ceasing display of the communication session user interface 716 as shown in FIG. 7J. In some embodiments, the time-detection component determines that the threshold amount of time has elapsed and communicates this information to the computer system. In response to this communication, the first computer system optionally ceases the display of the communication session user interface and the movement element in the three-dimensional environment. In some embodiments, the first computer system initiates ceasing the display of the communication session user interface in the three-dimensional environment after the threshold amount of time has elapsed. In some embodiments the cessation of the display of the communication session user interface in the three-dimensional environment occurs simultaneously with the cessation of the display of the movement element in the three-dimensional environment. In some embodiments, ceasing the display of the communication session user interface and the movement element in the three-dimensional environment occurs instantaneously. In some embodiments, the display of the communication session user interface and the movement element in the three-dimensional environment is ceased in a similar fashion as described above with reference to ceasing the display of the communication session user interface in the three-dimensional environment after not detecting an additional input during a threshold amount of time. In some embodiments, ceasing the display of the communication session user interface and the movement element within the three-dimensional environment after the threshold amount of time reveals the first visual representation of the second user from the viewpoint of the first user in the three-dimensional environment (e.g., because the communication session user interface is no longer displayed overlaid on the first visual representation). Ceasing the display of the communication session user interface and the movement element in the three-dimensional environment reduces the number of virtual objects that the user must keep track of, resulting in a more streamlined and focused user experience, and/or reduces the number of inputs needed to cease display of the communication session user interface and the movement element, thereby improving user-device interaction.

In some embodiments, while displaying the first visual representation of the second user, the communication session user interface, and the movement element in the three-dimensional environment in response to the first input, In accordance with a determination that attention of the first user (e.g., gaze 726 in FIG. 7E) is directed at the communication session user interface (e.g. communication session user interface 716 in FIG. 7E) in the three-dimensional environment, the first computer system maintains, via the display generation component, the display of the communication session user interface and the movement element in the three-dimensional environment, such as maintaining display of the communication session user interface 716 and the movement element 730 as shown in FIG. 7E. In some embodiments, the first computer system determines a user's attention (e.g., a gaze) using one or more input devices. In some embodiments, the one or more input devices track the user's gaze and the first computer system determines the direction of the user attention within the three-dimensional environment. In some embodiments, the user's attention corresponds to the location of the user's gaze in the three-dimensional environment. In some embodiments, the user's attention is determined to be directed at a particular location according to a determination that the user's gaze has been maintained at the location for a certain time-period (e.g., 0.5 seconds, 1 second, 2 seconds, 3 seconds, 4 seconds, and/or 5 seconds). In some embodiments the display of the communication session user interface is contingent on one or more criteria including an attention criterion. For example, the user directs their attention (e.g., gaze) at the communication session user interface once its display has been initiated within the three-dimensional environment. In this example, the communication session user interface continues to be displayed after the threshold amount of time has passed as described similarly above with reference to the ceasing the display of the communication session user interface after a threshold amount of time has elapsed. In this example, a criterion of the one or more criteria includes the threshold amount of time, wherein the communication session user interface is displayed within the three-dimensional environment but will continue to be displayed once the threshold amount of time criterion is no longer fulfilled, contingent on the attention criterion being maintained.

In some embodiments, in accordance with a determination that the attention of the first user is not directed at the communication session user interface in the three-dimensional environment, such as the gaze 726 not being directed to the communication session user interface 716 as shown in FIG. 7F, (e.g., a determination that a user gaze and/or hand pinch is directed at a location in the three-dimensional environment not associated with the communication session user interface), the first computer system ceases, via the display generation component, the display of the communication session user interface and the movement element in the three-dimensional environment, such as ceasing display of the communication session user interface 716 and the movement element 730 as shown in FIG. 7F. In some embodiments, the first computer system determines the attention of the first user is no longer directed at the communication session user interface based on a detection of the user's gaze directed at another location in the three-dimensional environment that is not associated with the location of the communication session user interface in the three-dimensional environment. In some embodiments, the computer system ceases the display of the communication session user interface in the three-dimensional environment in accordance with a determination that the gaze of the first user (e.g., the attention of the user as discussed above) has not been directed at the communication session user interface for a threshold amount of time. In some embodiments, the threshold amount of time corresponds to the threshold amount of time as discussed previously above with reference to ceasing the display of the communication session user interface after the second input is not detected at the communication session user interface for the threshold amount of time. In some embodiments, the direction of the user's attention is determined when the user's gaze is directed at a particular location in the three-dimensional environment for longer than a time period. For example, the gaze of the first user is directed at a location in the three-dimensional environment to the left of the communication session user interface relative to the viewpoint of the first user. In this example, the display of the communication session user interface is maintained while the gaze of the user is directed at the location for under the time period. Upon the user's gaze being directed at the location for longer than the time period, the first computer system determines that the first user's attention is no longer directed at the communication session user interface and subsequently ceases the display of the communication session user interface in the three-dimensional environment. In some embodiments, the user's attention is based on the viewpoint of the first user. In this embodiment, the communication session user interface is displayed in the three-dimensional environment upon a determination that the communication session user interface is within the field of view of the first user from the viewpoint of the first user. Reducing the required number of displayed virtual objects in the three-dimensional environment, from the user's perspective, dynamically manages the display of virtual objects based on attention, which enhances user immersion by replicating real-world perception and/or reduces the number of inputs needed to cease display of the communication session user interface and the movement element.

In some embodiments, while displaying the first visual representation of the second user (e.g., first representation 704 in FIG. 7S), the communication session user interface (e.g., communication session user interface 716 in FIG. 7S) and the movement element (e.g., movement element 730 in FIG. 7S) in the three-dimensional environment (e.g., three-dimensional environment 700 in FIG. 7S), the first computer system detects, via the one or more input devices, a second input (e.g., input provided by hand 709 in FIG. 7S) (e.g., the second input is detected before termination of the first input, optionally as a continuation of the first input and/or during the first input, or after termination of the first input). In some embodiments, the second input is directed to a location associated with the first visual representation. In some embodiments, the second input is directed to a location not associated with the first visual representation and/or is directed to the communication session user interface. For example, the second input (e.g., a gaze and/or air pinch gesture) is directed to empty space (e.g., different from one or more locations in the three-dimensional environment associated with the virtual objects) in the three-dimensional environment. In some embodiments, the second input has one or more characteristics of the first input discussed above.

In some embodiments, in response to detecting the second input and in accordance with a determination that the second input corresponds to selection of the first visual representation (e.g., gaze 726 directed at second representation 706) (e.g., the gaze of the first user is directed to the first visual representation when a selection input is detected, such as an air pinch or tap gesture), the first computer system ceases displaying the communication session user interface and the movement element in the three-dimensional environment, such as ceasing display of the communication session user interface 716 and the movement element 730 as shown in FIG. 7T. In some embodiments, the communication session user interface and movement element are continued to be displayed in accordance with a determination that the second input is not directed to the first visual representation and/or is directed to the communication session user interface and/or is directed to empty space in the three-dimensional environment. Ceasing display of the communication session user interface and the movement element in response to detecting a selection of the first visual representation reduces the number of inputs needed to cease display of the communication session user interface and the movement element, thereby enabling the user to easily mitigate visual clutter within the three-dimensional environment and allowing the user to direct attention toward other virtual objects within the three-dimensional space undistracted.

In some embodiments, the three-dimensional environment (e.g., three-dimensional environment 700 in FIG. 7H) further includes a first object (e.g., virtual object 702 in FIG. 7T). (e.g., the virtual application window, a shared game, the video conferencing user interface, or other virtual object as discussed above) In some embodiments, the first object is or includes a virtual application window (e.g., an application user interface associated with an application running on the computer system), virtual media content (e.g., virtual movie, television show episode, video clip, and/or music video). In some embodiments, the first object is displayed as the virtual application window accompanied by a movement element (e.g., a grabber bar) different than the movement element associated with the communication session user interface.

In some embodiments, while displaying the first visual representation of the second user (e.g., first representation 704 in FIG. 7T), the communication session user interface, the movement element associated with the communication session user interface, and the first object in the three-dimensional environment (e.g., after detecting the first input discussed above), the first computer system detects, via the one or more input devices, a second movement input (e.g., input provided by hand 709 in FIG. 7T) directed to the first object. In some embodiments the second movement input has one or more characteristics of the first movement input discussed above, but specific to the first object. In some embodiments, the second movement input is directed to a second movement element associated with the first object (e.g., a grabber bar affordance that is displayed with the first object, such as below the first object in the three-dimensional environment), different from the movement element associated with the communication session user interface. In certain embodiments, the first object is displayed adjacent to the first visual representation, the communication session user interface, and the movement element associated with the communication session user interface when the second input is detected.

In some embodiments, in response to the first computer system detecting the second movement input and in accordance with a determination that one or more criteria are satisfied, the first computer system updates the spatial arrangement of the first visual representation, the communication session user interface, the movement element, and the first object in the three-dimensional environment relative to the viewpoint of the first user (e.g., user 708 in FIG. 7U) in accordance with the second movement input (e.g., similar to the movement of the virtual object 702, the first representation 704, and the second representation 706 as shown in FIG. 7U). (e.g., as similarly described above with reference to updating the spatial arrangement of the first visual representation, the communication session user interface, and the movement element in accordance with the first movement input, but also including the first object and being in accordance with the second movement input)

In some embodiments, in accordance with a determination that the one or more criteria are not satisfied, the first computer system moves the first object (e.g., virtual object 710 in FIG. 7U) in the three-dimensional environment relative to the viewpoint of the first user, without updating the spatial arrangement of the first visual representation, the communication session user interface, and the movement element in the three-dimensional environment, relative to the viewpoint of the first user, in accordance with the second movement input (e.g., the first computer system only moves the first object in the three-dimensional environment in accordance with the second movement input), similar to the movement of the virtual object 710 without moving the virtual object 702, the first representation 704, or the second representation 706 as shown in FIG. 7V. In some embodiments, the one or more criteria include a criterion that is based on whether the virtual application window is only viewable by the user of the first computer system (e.g., the first object is a private object for the first user in the three-dimensional environment). For example, as discussed below, the one or more criteria are not satisfied if the first object is a private object, and the first computer system only moves the first object (e.g., and forgoes updating the spatial arrangement of the other virtual objects discussed above). Additional criteria of the one or more criteria are discussed below. Limiting the updating of the spatial arrangement to the first object based on whether one or more criteria are satisfied facilitates user understanding of object movement rules within the communication session and reduces the amount of virtual objects the user has to keep track of when moving, thereby improving user-device interaction.

In some embodiments, the one or more criteria include a criterion that is not satisfied when the first object (e.g., virtual object 710 in FIG. 7U) is private to the first user (e.g., user 708 in FIG. 7U) in the real-time communication session (e.g., not viewable or displayed to other users in the real-time communication session). In some embodiments, the criterion of the one or more criteria is satisfied in accordance with a determination that the first object is viewable by and/or interactive to the user of the first computer system and the user of the second computer system (e.g., and/or a user of a third computer system). Accordingly, the criterion of the one or more criteria is optionally not satisfied in accordance with a determination that the first object is only viewable by and/or interactive to one user (e.g., the first user) in the communication session. For example, as mentioned above, if the first object is private to the first user in the real-time communication session, in response to detecting the second movement input, the first computer system moves the first object in the three-dimensional environment relative to the viewpoint of the first user in accordance with the second movement input, without moving (and/or rotating) the first visual representation, the communication session user interface, and the movement element. In some embodiments, the above described behavior of the first object with respect to being private to the first user applies irrespective of whether the communication session user interface and the movement element are displayed in the three-dimensional environment. Denoting a criterion of the one or more criteria as a determination of whether the first object is private (i.e., viewable only by the first user) prevents unnecessary movement of shared virtual objects shared between the first user and or a plurality of users of different computer systems in addition to reducing the computational requirements of the first computer system.

In some embodiments, the one or more criteria include a criterion that is satisfied when the first object (e.g., virtual object 702 in FIG. 7T) is shared between the first user (e.g., user 708 in FIG. 7T) and the second user in the real-time communication session (e.g., as similarly discussed above with reference to the first object being private to the first user). For example, the one or more criteria are satisfied if the first object is a shared game viewable by and/or interactable between the first user and the second user in the real-time communication session. In some embodiments, the first object is shared between a plurality of users including at least the first user and the second user (e.g., a shared game requiring at least two players). In some embodiments, as similarly discussed above, the above-described behavior of the first object with respect to being shared between the first user and the second user applies irrespective of whether the communication session user interface and the movement element are displayed in the three-dimensional environment. Updating the spatial arrangement of the first visual representation, the communication session user interface, the movement element, and the first object in response to detecting a movement input directed to the first object in accordance with a determination that the first object is shared between the first user and the second user allows for a seamless communication session between users by helping avoid erroneous user input related to updating the spatial arrangement of the elements.

In some embodiments, the first visual representation is a spatial visual representation of the second user (e.g., first representation 704 in FIG. 7T), and the one or more criteria include a criterion that is not satisfied when the first object (e.g., first virtual panel 718 in FIG. 7W) corresponds to a non-spatial representation of a respective user in the real-time communication session. In some embodiments, the real-time communication session includes a third user, different from the first user and the second user. In some embodiments, the first object is displayed as a virtual object (e.g., a non-spatial window) that includes a two-dimensional rendering of the third user based on image data captured by sensors in the environment of the participant, such as one or more cameras of the third computer system. Additionally, in some embodiments, the first visual representation of the second user corresponds to a non-spatial communication interface (e.g., a virtual video panel that includes a two-dimensional rendering of the second user) via which to communicate with the second user (e.g., in lieu of a virtual avatar, as previously discussed above). Accordingly, in some embodiments, the one or more criteria are satisfied in accordance with a determination that the first object does not correspond to the non-spatial communication interface discussed above (e.g., the first object instead corresponds to a shared object as discussed above, such as a shared application window). In certain embodiments, according to the determination that the one or more criteria are not satisfied (e.g., because the first object corresponds to the non-spatial communication interface), the first computer system updates the spatial arrangement of only the first object (e.g., the non-spatial window, non-spatial communication interface, or virtual video panel discussed above) according to the second movement input, where the second input is directed at a movement element displayed adjacent to and associated with the non-spatial communication interface. In some embodiments, the user selects an option to display the non-spatial communication interface (e.g., the first object), the non-spatial communication interface serving as a visual indication that the first user and the third user are engaging in a non-spatial communication session (e.g., discussed in more detail below). In other embodiments, when the real-time communication session is initiated, the first user (or another user) selects an option to conduct the communication session as either a spatial communication session (e.g., discussed in more detail below) or a non-spatial communication session. In some embodiments, while the first user and the second user are engaging in in a con-communication session, the first user and the second user are concurrently communicating in a spatial communication session. In some embodiments, the third user and the second user engage in a non-spatial communication session while the second user is in a spatial communication session with the first user. In some embodiments, the one or more criteria are satisfied (and/or the one or more criteria include a criterion that is satisfied) if the first object corresponds to a spatial visual representation of a user (e.g., the second user and/or the third user). Imposing a criterion of one or more criteria that is not satisfied when the first object corresponds to a video conferencing user interface provides a distinct visual and/or interactive indication that the respective user represented by the video conferencing user interface is non-spatial within the real-time communication session, thereby informing future user interactions with the respective user. In some embodiments, the first visual representation is a spatial visual representation of the second user (e.g., first representation 704 in FIG. 7T), and the one or more criteria include a criterion that is not satisfied when the first object (e.g., first virtual panel 718 in FIG. 7W) corresponds to a non-spatial representation of a respective user in the real-time communication session. In some embodiments, the real-time communication session includes a third user, different from the first user and the second user. In some embodiments, the first object is displayed as a virtual object (e.g., a non-spatial window) that includes a two-dimensional rendering of the third user based on image data captured by sensors in the environment of the participant, such as one or more cameras of the third computer system. Additionally, in some embodiments, the first visual representation of the second user corresponds to a non-spatial communication interface (e.g., a virtual video panel that includes a two-dimensional rendering of the second user) via which to communicate with the second user (e.g., in lieu of a virtual avatar, as previously discussed above). Accordingly, in some embodiments, the one or more criteria are satisfied in accordance with a determination that the first object does not correspond to the non-spatial communication interface discussed above (e.g., the first object instead corresponds to a shared object as discussed above, such as a shared application window). In certain embodiments, according to the determination that the one or more criteria are not satisfied (e.g., because the first object corresponds to the non-spatial communication interface), the first computer system updates the spatial arrangement of only the first object (e.g., the non-spatial window, non-spatial communication interface, or virtual video panel discussed above) according to the second movement input, where the second input is directed at a movement element displayed adjacent to and associated with the non-spatial communication interface. In some embodiments, the user selects an option to display the non-spatial communication interface (e.g., the first object), the non-spatial communication interface serving as a visual indication that the first user and the third user are engaging in a non-spatial communication session (e.g., discussed in more detail below). In other embodiments, when the real-time communication session is initiated, the first user (or another user) selects an option to conduct the communication session as either a spatial communication session (e.g., discussed in more detail below) or a non-spatial communication session. In some embodiments, while the first user and the second user are engaging in in a con-communication session, the first user and the second user are concurrently communicating in a spatial communication session. In some embodiments, the third user and the second user engage in a non-spatial communication session while the second user is in a spatial communication session with the first user. In some embodiments, the one or more criteria are satisfied (and/or the one or more criteria include a criterion that is satisfied) if the first object corresponds to a spatial visual representation of a user (e.g., the second user and/or the third user). Imposing a criterion of one or more criteria that is not satisfied when the first object corresponds to a video conferencing user interface provides a distinct visual and/or interactive indication that the respective user represented by the video conferencing user interface is non-spatial within the real-time communication session, thereby informing future user interactions with the respective user.

In some embodiments, while displaying the first visual representation (e.g., first representation 704 in FIG. 7D) of the second user, the communication session user interface (e.g., communication session user interface 716 in FIG. 7D), the movement element (e.g., movement element 730 in FIG. 7D) associated with the communication session user interface, and the first object (e.g., virtual object 702 in FIG. 7D) in the three-dimensional environment (three-dimensional environment 700 in FIG. 7D), the first computer system detects, via the one or more input devices, a third movement input directed to the movement element, such as input provided by hand 709 in FIG. 7D. In some embodiments, the third movement input has one or more characteristics of the first movement input discussed above, but being directed to the movement element associated with the communication session.

In some embodiments, in response to detecting the third movement input and in accordance with a determination that the one or more criteria are satisfied (e.g., any one criterion or combination of criteria discussed above and/or below), the first computer system updates the spatial arrangement of the first visual representation, the communication session user interface, and the movement element (and optionally the first object) in the three-dimensional environment relative to the viewpoint of the first user (e.g., user 708 in FIG. 7D) in accordance with the third movement input, such as moving first representation 704, second representation 706, communication session user interface 716, and virtual object 702 in FIG. 7D. In some embodiments, the spatial arrangement of the virtual objects is updated in accordance with the third movement input in a manner similar to the updating of the spatial arrangement of the virtual objects in accordance with the first movement input discussed previously above. In some embodiments, the first visual representation and the second visual representation are not dynamically scaled relative to the three-dimensional environment, in accordance with the third movement input, when updating the spatial arrangement of the virtual objects. For example, in accordance with a determination that the updated spatial arrangement of the first visual representation and the second visual representation are positioned farther away from the viewpoint of the first user in the three-dimensional environment than the prior spatial arrangement of the virtual objects, the first visual representation and the second visual representation are displayed at a smaller size from the viewpoint of the first user (e.g., have the same size relative to the three-dimensional environment independent of their distance from the viewpoint of the first user). This behavior of the visual representation(s) of the user(s) in the communication session optionally apply to the result of the first input in method 800 as well, as well as to any other input resulting in movement of representations of users relative to the viewpoint of the first user. In some embodiments, in accordance with a determination that the one or more criteria are not satisfied, the first computer system updates the spatial arrangement of the first visual representation, the communication session user interface, and the movement element in the three-dimensional environment relative to the viewpoint of the first user, without moving the first object, in accordance with the third movement input. For example, if the first object corresponds to a private virtual application as discussed above, and the third movement input is directed to the movement element (e.g., the grabber bar) associated with the communication session user interface, the first computer system updates the spatial arrangement of the communication session user interface, the movement element, and the first visual representation in accordance with the third movement input, without moving the first object in the three-dimensional environment relative to the viewpoint of the first user. Updating the spatial arrangement of the virtual objects in accordance with a determination that one or more criteria are satisfied and in response to detecting a movement input directed to the movement element of the communication session user interface reduces the complexity in organizing the virtual objects in the three-dimensional space and/or facilitates discovery of whether the one or more criteria are satisfied, which helps avoid erroneous user input related to updating the spatial arrangement of the virtual objects.

In some embodiments, the one or more criteria include a criterion that is satisfied in accordance with a determination that the real-time communication session is a spatial communication session, as similarly described with reference to FIG. 7D, and that is not satisfied in accordance with a determination that the real-time communication session is a non-spatial communication session, as similarly described with reference to FIG. 7W. In some embodiments, a spatial communication session refers to a real-time communication session in which the three-dimensional environment includes virtual avatars (e.g., the first visual representation described above) that visually provide the user of the first computer system with indications of the locations in the virtual space that are occupied by other users (e.g., the second user) within the communication session. Accordingly, in some embodiments, the one or more criteria are satisfied when the first visual representation of the second user corresponds to a three-dimensional virtual avatar in the three-dimensional environment. In some embodiments, a non-spatial communication session refers to a real-time communication session in which the three-dimensional environment does not include virtual avatars or other three-dimensional representations of users that visually provide the user indications of the locations in the virtual space that are occupied by other users within the communication session. For example, the one or more criteria are optionally not satisfied when the first visual representation of the second user corresponds to a non-spatial communication interface (e.g., that includes a two-dimensional image (e.g., photograph or video feed) associated with the second user) described previously above. In some embodiments, according to a determination that the communication session is a spatial communication session, the first computer system updates the spatial arrangement of the virtual objects (e.g., the first visual representation, the communication session user interface, and the movement element) in the three-dimensional environment according to the second movement input in response to detecting the second movement input discussed above. Limiting updating the spatial arrangement of the virtual objects to the real-time communication session being a spatial communication session conserves computational power at the first computer system and helps avoid erroneous user input related to updating the spatial arrangement of the virtual object, thereby improving user-device interaction.

In some embodiments, while displaying, via the display generation component 120, the first visual representation as the non-spatial representation (e.g., the two-dimensional image (e.g., photograph or video feed) associated with the second user) described previously above) of the respective user relative to the communication session user interface, and the movement element associated with the communication session user interface in the three-dimensional environment, such as while displaying the communication session user interface 716 with the coin 705 in FIG. 7FF, the first computer system detects, via the one or more input devices, a third input corresponding to selection of the second visual representation, the second visual representation as the spatial representation, such as detecting the input provided by the hand 709 in FIG. 7FF. In some embodiments, the third input comprises a continuation of the second input and/or the first input. In some embodiments, the third input corresponds to a gesture (e.g., pinch and/or point of the hand) by the first user directed at the first visual representation as the non-spatial representation. In some embodiments, the selection of the second visual representation corresponds to a display of the communication session user interface as discussed in further detail below.

In some embodiments, in response to detecting the third input, the first computer system ceases, via the display generation component, the communication session user interface and the movement element relative to the first visual representation as the non-spatial representation in the three-dimensional environment, such as the communication session user interface 716 and the movement element 730 not being displayed with the coin 705 in FIG. 7GG.

In some embodiments, the first computer system displays, via the display generation component, the communication session user interface and the movement element associated with the communication session user interface in the three-dimensional environment relative to the second visual representation that is the spatial representation of the respective user, such as displaying the communication session user interface 716 and the movement element 730 relative to the second representation 706 as shown in FIG. 7GG. In some embodiments, the communication session user interface and the movement element are displayed at a location in the three-dimensional environment such that a front face of the communication session user interface partially and/or completely overlays the display of the second visual representation in the three-dimensional environment relative to the viewpoint of the first user. In some embodiments, the display location of the communication session user interface is at the predetermined fixed distance as discussed previously above with reference to displaying a communication session user interface in a spatial communication session. In some embodiments, the communication session user interface is displayed at the fixed location in the three-dimensional environment relative to the viewpoint of the first user, wherein the display of the a spatial representation of a respective user is displayed at a location in the three-dimensional environment that is farther away from the viewpoint of the first user. In some embodiments, the communication session user interface and the movement element are displayed at a location tangential to a location of the second visual representation relative to the viewpoint of the first user. For example, the second visual representation is displayed at a location within the three-dimensional environment that is directly in front of the viewpoint of the first user, where the communication session user interface and the movement input are displayed in a location to the left of the second visual representation relative to the viewpoint of the first user. In this example, the second visual representation, the movement element, the communication session user interface are displayed perpendicular to a line-of-sight of the viewpoint of the first user. In some embodiments, the spatial arrangement of the second visual representation is updated from a first location to a second location in the three-dimensional environment in response to the first computer system initiating the display of the communication session user interface and the movement element in the first location in the three-dimensional environment as similarly discussed herein. In some embodiments, the non-spatial first visual representation, the spatial second visual representation, the communication session user interface relative to the spatial second visual representation all share the same orientation relative to the viewpoint of the first user. Concurrently displaying the non-spatial first visual representation, the spatial second visual representation, the communication session user interface, and the movement element optimizes the visual space of the three-dimensional environment by ensuring that that all relevant information related to the communication are always displayed at any given time, and in orientating all virtual objects along the same plane, this increases the visual cohesiveness of the three-dimensional environment.

In some embodiments, while updating the spatial arrangement of the first visual representation (e.g., first representation 704 in FIG. 7L), the communication session user interface, and the movement element in the three-dimensional environment (e.g., the three-dimensional environment 700 in FIG. 7L) relative to the viewpoint of the first user (e.g., the user 708 in FIG. 7L) in accordance with the first movement input (e.g., hand 709 in FIG. 7L in accordance with the determination that the first movement input 709 is directed to the movement element 730 (not shown) in response to detecting the first movement input, in accordance with a determination that the updating the spatial arrangement causes the communication session user interface to be located within a threshold distance of a boundary (e.g., 5 feet, 3 feet, 1 foot, 0.5 feet, 0.25 feet) of the three-dimensional environment 700, the first computer system generates, via the display generation component, a visual indication (e.g., visual indication 781 in FIG. 7L) that the communication session user interface is located within the threshold distance of the boundary. In some embodiments, the first computer system determines that one or more of the plurality of virtual objects, when updating the spatial arrangement of said virtual objects, is approaching and/or extends beyond a boundary corresponding to an impermissible location of any of the virtual objects in the three-dimensional environment. For example, the first computer system optionally defines one or more regions of the three-dimensional environment that are beyond a boundary allowed for virtual objects relative to the viewpoint of the first user, such that viewing and/or interacting with respective virtual objects (e.g., photos, video, text, and/or interactable virtual elements like pushbuttons) displayed beyond the boundary is optionally suboptimal due to a reduced size of the virtual object. In response to the first movement input corresponding to a request to update the spatial arrangement of the virtual objects from a first position to a second position, such that at least a portion of the virtual object (e.g., a corner, a point corresponding to the virtual object, and/or a three-dimensional shape bounding the virtual object, such as a mesh surrounding the virtual object that optionally is not displayed) extends into a far-field region that is beyond the boundary relative to the viewpoint of the first user, the first computer system generates a visual indication relative to the viewpoint of the first user until the first movement input is terminated. In some embodiments, the indication is an audible indication projected within a range of typical human hearing (e.g., 20 Hz to 20 kHz). In some embodiments, the first computer system defines one or more boundaries of the three-dimensional environment based on a physical environment of the user. For example, the first computer system optionally detects a floor of the physical environment, and in response to detecting the first movement input updating the spatial arrangement of at least one of the plurality of virtual objects to a position that extends into the floor, the first computer system optionally prevents and/or resists movement of the virtual object into the floor and generates the visual indication. In some embodiments, the computer system does not display the visual indication upon a determination that none of the plurality of virtual objects are within the threshold distance. In some embodiments, the visual indication is optionally accompanied with an audible indication. In some embodiments, the audible indication is used in response to a virtual object approaching the boundary of the three-dimensional environment in lieu of the visual indication. In some embodiments, the first computer system defines the one or more boundaries based on additional or alternative aspects of the physical environment, such as the physical floor of the environment, one or more boundaries relative to one or more portions of the user's body, and/or virtual boundaries such as virtual walls and/or floors of an immersive virtual environment. In some embodiments, the visual indication is displayed as a colored icon that changes in response to the virtual object approaching the threshold distance. For example, the virtual object is displayed with a green-colored visual indication when the virtual object is outside the threshold distance by a range of distances (e.g., 1 foot, 2 feet, 3 feet). In this example, when the virtual object is within the range of distances from the threshold distance, the first computer system displays the virtual object with a yellow-colored visual indication. In this example, when the virtual object is within the threshold distance, the first computer system displays the virtual object with a red-colored visual indication. In some embodiments, the visual indication is displayed as a pop-up in the three-dimensional environment that includes text alerting the user (e.g., approaching environment boundary, outside environment, user error). Generating indications (e.g., audio and/or visual feedback) upon a virtual object's collision with one or more boundaries for the three-dimensional environment adds realism and immersion to the three-dimensional environment by mimicking real-world constraints and spatial limitations thereby serving as valuable feedback and providing users with cues that reinforce their actions and interactions within the three-dimensional environment.

In some embodiments, in response to detecting the first movement input (e.g., hand 709 in FIG. 7M) (e.g., air pinch or grab, including gaze) and in accordance with the determination that the first movement input is directed to the first visual representation (e.g., first representation 704 in FIGS. 7M and 7N) (e.g., a gesture in the direction of the avatar representing the second user in the three-dimensional environment) and that the first visual representation 704 is located within a threshold distance (e.g., threshold boundary 782) (e.g., a predetermined distance configurable by the system settings of the computer system) of the viewpoint of the first user (e.g., user 708 in FIG. 7N) in the three-dimensional environment (e.g., three-dimensional environment 700 in FIG. 7N), the first computer system updates the spatial arrangement of the first visual representation (e.g., first representation 704 in FIG. 7P), the communication session user interface (e.g., communication session user interface in FIG. 7P), and the movement element (e.g., movement element 730 in FIG. 7P) in the three-dimensional environment relative to the viewpoint of the first user in accordance with the first movement input. In some embodiments, the first computer system is additionally configured to detect, with the one or more input devices, a position of first visual representation as being within a threshold distance (e.g., 3 feet, 2 feet, 1 foot, 0.5 feet, 0.25 feet) of the viewpoint of the first user in the three-dimensional environment. In some embodiments, the threshold distance is calculated as a three-dimensional sphere within the three-dimensional environment possessing a radius corresponding to the threshold distance from the viewpoint of the first user. In some embodiments, the computer system does not allow the first user to direct the first movement input towards the communication session user interface when the first visual representation is within the threshold boundary of the viewpoint of the first user. For example, in response to the location of the first visual representation being within the threshold boundary, the first computer system ceases and/or forgoes the display of the communication session user interface and the movement element. In this example, the first user directs the first movement input towards the first visual representation. In some embodiments, the first movement input directed at the first visual representation, causes the first computer system to update the spatial arrangement of the first visual representation from a location within the threshold distance to a location outside the threshold distance. In this example, in response to the first visual representation no longer being within the threshold distance, the first computer system initiates the display of the communication session user interface and the movement element within the three-dimensional environment. In some embodiments, the threshold distance from the viewpoint of the first user is represented as a visual indication within the three-dimensional environment. For example, in accordance with a determination by the first computer system that one or more of the virtual objects are within the threshold boundary, a boundary line possessing a level of opacity under 100% is displayed at the threshold distance from the viewpoint of the first user in the three-dimensional environment. Varying the ability to update the spatial arrangement of virtual objects via the communication session user interface based on a distance between the first visual representation and the viewpoint of the user serves as a visual indication that the first visual representation is within a threshold distance of the viewpoint of the first user in the three-dimensional environment and/or helps preserve visibility of the first visual representation in the three-dimensional environment, thereby improving user-device interaction.

In some embodiments, while displaying the first visual representation (e.g., first representation 704 in FIG. 7O) of the second user 704 at the first location relative to the viewpoint of the first user (e.g., user 708 in FIG. 7O), the first computer system detects, via the one or more input devices (e.g., 114a-114c), a third input (e.g., gaze 726 and/or hand 709 in FIG. 7O) corresponding to selection of the first visual representation. In some embodiments, the third input corresponds to a movement or gesture by the first user, different than the first input and/or the second input. In some embodiments, the third input comprises the same input as the first input as discussed similarly above with reference to updating the spatial arrangement of virtual objects in response to the detection of the first input.

In some embodiments, in response to detecting the third input and in accordance with a determination that that the first visual representation is located within a threshold distance (e.g., the threshold boundary 782 in FIG. 7O) (e.g., 6 feet, 3 feet, 1.5 feet, 1 foot, 0.5 feet) of the viewpoint of the first user in the three-dimensional environment, the first computer system displays, via the display generation component, at least one of the communication session user interface or the movement element in the three-dimensional environment, such as displaying the communication session user interface 716 as shown in FIG. 7P. In some embodiments, the threshold distance is the same distance as discussed similarly above with reference to updating the spatial arrangement of virtual objects based on the first visual representation and not the communication session user interface. In some embodiments, as previously discussed above, the communication session user interface is displayed in response to a selection of the first visual representation (e.g., avatar corresponding to the second user) and is displayed at a location between a location of the first visual representation and the viewpoint of the first user in the three-dimensional environment. In some embodiments, the display of the communication session user interface is a location within the threshold boundary, and the initiation of the display of the communication session user interface automatically updates the spatial arrangement of the first visual representation from a first location to a second location, different than the first location, as discussed in further detail below with reference to automatic spatially updating virtual objects. In some embodiments, the first computer system determines that a location of the first visual representation is outside the threshold distance from the viewpoint of the first user and in response to the detection of the first input, does not display the communication session user interface but does display the movement element. In some embodiments, in response to the detection of the third input, a plurality of communication session user interface of the at least one of the communication session user interface is displayed in the three-dimensional environment. For example, the user directs the third input at the first visual representation of a plurality of visual representations and in response, the first computer system generates a movement element corresponding to each of the plurality of visual representations in the three-dimensional environment. Selectively displaying the communication session user interface while the position of the first visual representation of the second user is within the threshold distance of the viewpoint of the first user prevents the first user from initiating the display of the communication session user interface at a position that causes the communication session user interface to be unreadable or inconvenient for the user to interact with in the three-dimensional space, thus improving overall performance and responsiveness of the three-dimensional environment.

In some embodiments, in response to detecting the third input (e.g., gaze 726 and/or hand 709 in FIG. 7O), in accordance with the determination that that the first visual representation (e.g., representation 704 in FIG. 7O) is located within the threshold distance (e.g., threshold boundary 782 in FIG. 7O) of the viewpoint of the first user (e.g., user 708 in FIG. 7O) in the three-dimensional environment.

the first computer system updates a spatial arrangement (e.g., as indicated by movement arrow in FIG. 7Q) of the first visual representation relative to the viewpoint of the first user from the first location (e.g., location of first representation 704 in FIG. 7O) in the three-dimensional environment to a second location (e.g., the location of the first representation 704 in FIG. 7Q), different from the first location, in the three-dimensional environment, wherein the second location is at a distance in the three-dimensional environment further from the viewpoint of the first user than the first location. In some embodiments, a location of the first visual representation is within a predetermined distance of the viewpoint of the first user in the three-dimensional environment as set by the first computer system settings. In some embodiments, the first computer system automatically updates the spatial arrangement of the first visual representation from a location within the threshold distance relative to the viewpoint of the first user, to a position corresponding to (or larger than) the threshold distance from the viewpoint of the first user in the three-dimensional environment in response to detecting the third input. For example, the first computer system ceases the display of the first visual representation at a first position in the three-dimensional environment in response to the detection of the third input and redisplays the first visual representation at a second position, different than the first position. In this example, while the first computer system is initiating the display of the first visual representation at the second location, the first computer system additionally displays the communication session user interface at the first location in the three-dimensional environment. In some embodiments, the spatial arrangement of the plurality virtual objects in the three-dimensional environment, as discussed above previously, is automatically updated according to the computer system updating the spatial arrangement of the first visual representation. For example, when the computer system automatically updates the first visual representation from first position to the second position in the three-dimensional environment, the computer system automatically updates the position of the second visual representation from a first position to a second position in the three-dimensional environment. In some embodiments, the spatial arrangement of the first visual representation and the plurality of virtual objects is maintained when the computer system automatically update the position of the first visual representation as discussed above. In some embodiments, the update of the spatial arrangement of the first visual representation from the first location to the second location includes a movement animation. In some embodiments, the update of the spatial arrangement of the communication session user interface results in the display of the communication session user interface at the predetermined location discussed above with reference to the fixed distance from the viewpoint of the first user in the three-dimensional environment. Automatically updating the spatial arrangement of the first visual representation in the three-dimensional environment relative to the viewpoint of the user when displaying the communication session user interface in a location proximate to the viewpoint of the user prevents overlap and reduces clutter and confusion, thereby optimizing the layout of virtual objects, and improving user-device interaction.

In some embodiments, in response to detecting the third input (e.g., gaze 726 and/or hand 709 in FIG. 7O), the communication session user interface (e.g., communication session user interface 716 in FIG. 7P) is displayed at a second location (e.g., location of communication session user interface 716 in FIG. 7Q), different from the first location (e.g., location of the communication session user interface 716 in FIG. 7O), in the three-dimensional environment, wherein the second location is further from the viewpoint of the first user (e.g., user 708 in FIG. 7P) than the first location relative to the viewpoint of the first user, as similarly indicated in the overhead view 712 in FIG. 7P. In some embodiments, the communication session user interface is displayed at a location farther than the location of the first visual representation relative to the viewpoint of the first user. In some embodiments, the location of the communication session user interface and the location of the first visual representation are centered on an axis extending from the viewpoint of the first user. In some embodiments, the second location of the communication session user interface is outside the threshold distance as previously discussed above. In some embodiments, the second location is closer to the viewpoint than the first location relative to the viewpoint of the first user.

In some embodiments, in response to detecting the third input, in accordance with a determination that the first visual representation at least partially overlaps the communication session user interface relative to the viewpoint of the first user, such as the first representation 704 overlapping the communication session user interface 716 from the viewpoint of the first user 708 in the overhead view 712 in FIG. 7P, the first computer system changes a visual appearance of (e.g., reducing a visual prominence of) at least a portion of the first visual representation in the three-dimensional environment at the first location in the three-dimensional environment, such as increasing the translucency of the first representation 704 as shown in FIG. 7P (optionally so as to increase a visibility of the communication session user interface through the at least the portion of the first visual representation from the viewpoint of the user). In some embodiments, when the communication session user interface is displayed, the opacity of the first visual representation at the first location is lowered to a degree that enables the communication session user interface to be visible at the second location relative to the viewpoint of the first user. In some embodiments, the first computer system determines that the first visual representation partially overlaps the communication session user interface using a predetermined percentage coverage metric (e.g., 10% coverage, 25% coverage, 50% coverage, 75% coverage, 100% coverage). For example, in response to displaying the communication session user interface, the first computer system determines that the first visual representation covers 50% of the communication session user interface relative to the viewpoint of the first user. In this example, the first computer system lowers the opacity of an area of the first visual representation corresponding to the 50% coverage of the communication session user interface such that the 50% coverage of the communication session user interface is visible relative to the viewpoint of the first user. In some embodiments, the opacity of the first visual representation is altered regardless to the percent of coverage of the communication session user interface relative to the viewpoint of the first user. In some embodiments, the communication session user interface is displayed at a location in front of the display of the first visual representation relative to the viewpoint of the first user. In this example, the first computer system alters a visual appearance of the communication session user interface in such a way that the first visual representation is visible through the display of the communication session user interface relative to the viewpoint of the first user. In altering the visual appearance of the first visual representation, the communication session user interface remains viewable from the viewpoint of the first user, allowing for continued access to the communication session user interface (viewable and therefore selectable) for performing spatial updates on the plurality of virtual objects, creating a seamless interaction even within the threshold distance of the user.

In some embodiments, displaying at least one of the communication session user interface or the movement element in the three-dimensional environment includes displaying the movement element without displaying the communication session user interface in the three-dimensional environment, such as the movement element being displayed with the first representation 704 without the communication session user interface 716 as shown in FIG. 7R. In some embodiments, the first computer system forgoes the display of the communication session user interface in the three-dimensional environment upon a determination that the location of the first visual representation is within the threshold distance of the viewpoint of the user in the three-dimensional environment. In some embodiments, if the communication session user interface is already displayed in the three-dimensional environment, and the first computer system determines the first visual representation is within (e.g., is moved to being within) the threshold distance of the viewpoint of the user in the three-dimensional environment, the first computer system ceases the display of the communication session user interface in response. In some embodiments, the display of the communication session user interface is ceased in response to updating the spatial arrangement of the first visual representation from a location outside the threshold distance to a location within the threshold distance. In some embodiments, when initiating the display of the plurality of virtual objects in the three-dimensional environment, the first computer system does not initiate the display of the communication session user interface in response to initiating the display of the first visual representation at a location within the threshold distance of the viewpoint of the first user. In some embodiments, the movement element is displayed at the location previously occupied by the communication session user interface. Foregoing the display of the communication session user interface serves as an additional indicator to the user that the first visual representation is within the threshold distance and/or allows the user to freely interface (e.g., update the spatial arrangement of the plurality of virtual objects) without distractions, thereby improving user-device interaction.

In some embodiments, the first user (e.g., user 708 in FIG. 7A) of the first computer system is further in the real-time communication session with a third user (e.g., indicated by second representation 706 in FIG. 7A), different from the first user and the second user, of a third computer system, different from the first computer system and the second computer system. In some embodiments, the first user, the second user, and the third user are all participating in the real-time communication session in the three-dimensional environment. In some embodiments, the third user joins the real-time communication session at a time after the first user and the second user initiate the real-time communication session. In some embodiments, the real-time communication session is initiated by the first computer system including the first user, the second user, and the third user in the three-dimensional environment.

In some embodiments, while displaying the first visual representation and a second visual representation of the third user in the three-dimensional environment, the first computer system detects, via the one or more input devices (e.g., 114a-114c), a second input (e.g., gaze 726 and/or hand 709 in FIG. 7A) corresponding to selection of the first visual representation (e.g., first representation 704 in FIG. 7A). In some embodiments, as similarly discussed above, the non-spatial communication session is a real-time (e.g., or nearly real-time) communication session that includes audio (e.g., real-time voice audio from the first user and/or the third user and/or the second user) and/or video (e.g., real-time video of the environment of the first user and/or the third user and/or the second user). For example, the first computer system displays the second visual representation via which to visually and/or audibly communicate with the third user in the three-dimensional environment. In some embodiments, the second visual representation is displayed as a virtual object (e.g., a non-spatial window) that includes a two-dimensional rendering of the third user based on image data captured by sensors in an environment of the third user, such as one or more cameras of the third computer system.

For example, the two-dimensional rendering of the third user corresponds to a photograph, cartoon, sketch, or other still image selected by the second user or corresponds to a (e.g., live) video feed of the second user. In some embodiments, the two-dimensional rendering of the second visual representation corresponds to a two-dimensional animated representation of the third user (e.g., a two-dimensional avatar rather than a three-dimensional avatar as discussed above). Additionally, in some embodiments, the second visual representation is or includes a non-spatial communication interface (e.g., a virtual video panel that includes a two-dimensional rendering of the third user) via which to communicate with the third user (e.g., in lieu of a virtual avatar, as discussed in more detail below). Accordingly, in some embodiments, the second visual representation (e.g., the non-spatial communication interface) serves as a visual indication that the first user and the third user are engaging in a non-spatial communication session. In some embodiments, the second visual representation is configured to be movable and/or repositioned in the environment as other virtual objects are, as similarly discussed above. In some embodiments, the second visual representation has one or more characteristics of the first visual representation discussed above. In some embodiments, the second input has one or more characteristics of the first input discussed above.

In some embodiments, in response to detecting the second input, the first computer system displays, via the display generation component, the communication session user interface (e.g., communication session user interface 716 in FIG. 7B), the movement element (e.g., movement element 730 in FIG. 7B), and a second movement element (shown by second representation 706 in FIG. 7B) associated with the second visual representation in the three-dimensional environment. In some embodiments, each visual representation corresponding to a user displayed in the three-dimensional environment includes a movement element configurable to receive a user movement input. For example, the user directs a movement input at the movement element corresponding to a user and, according to the movement input, cause the first computer system to update the spatial arrangement of the virtual objects in the three-dimensional environment. In some embodiments, the second movement element includes one or more characteristics of the first movement as previously discussed above.

In some embodiments, while displaying the first visual representation, the second visual representation, the communication session user interface, the movement element, and the second movement element in the three-dimensional environment, the first computer system detects, via the one or more input devices, a second movement input (e.g., a user movement corresponding to the first movement input) directed to the second movement element, such as the input provided by the hand 709 directed to the movement element of the first representation 704 as described with reference to FIG. 7K. In some embodiments, the one or more input devices are additionally configured by the first computer system to detect the second movement input. In some embodiments, the first computer system detects the second movement input directed to the second movement element according to a determination that the first user is performing an air pinch and drag gesture, optionally while the attention of the user is directed towards the second movement element. In some embodiments, the second movement input has one or more characteristics of the first movement input discussed above.

In some embodiments, in response to detecting the second movement element, the first computer system updates a spatial arrangement of the communication session user interface, the movement element, the first visual representation, the second visual representation, and the second movement element in the three-dimensional environment relative to the viewpoint of the first user in accordance with the second movement input, such as the first computer system updating the spatial arrangement of the first representation 704, the second representation 706, and the virtual object 702 as shown in FIG. 7L. In some embodiments, the spatial arrangement of the plurality of virtual objects is updated in a similar manner as previously discussed above with reference to updating the spatial arrangement of the first visual representation, the communication session user interface, and the movement element. In some embodiments, because each of the plurality of virtual objects within the three-dimensional environment includes a movement element associated with the respective virtual object, the spatial arrangement of the plurality of objects is able to be updated in accordance with a detection of the second movement input being directed at any of movement elements in the three-dimensional environment. Displaying a movement element corresponding to each visual representation corresponding to a user in the real-time communication session increases the number of controllable inputs within the three-dimensional environment and/or facilitates the discovery that any of the virtual objects in the real-time communication session are able to be manipulated in real-time, thereby improving the overall user experience during the real-time communication session, and helps avoid erroneous user input related to updating the spatial arrangement of the virtual objects.

In some embodiments, the first user of the first computer system is further in the real-time communication session with a third user (e.g., represented by second virtual panel 720 shown in FIG. 7Z), different from the first user and the second user (e.g., represented by first virtual panel 718 shown in FIG. 7Z), of a third computer system (e.g., the third user as described above with reference to updating the spatial arrangement of the spatial representation of the second user, the third user, and a plurality of virtual objects), different from the first computer system and the second computer system.

In some embodiments, the first computer system displays, via the display generation component, the first visual representation as a non-spatial representation of the second user in the three-dimensional environment and a second visual representation as a non-spatial representation of the third user in the three-dimensional environment, such as the first virtual panel 718 and the second virtual panel 720 in FIG. 7Z. In some embodiments, the plurality of representations are displayed within one or more virtual windows and/or containers. For example, the first representation of the second user is displayed within a first virtual window, and a second representation of a third user, different from the second user, is displayed within a second virtual window, different from the first virtual window. The plurality of representations is optionally displayed at different distances (e.g., at different depths) relative to the current viewpoint of the first user in the three-dimensional environment. For example, a second representation of a third user, different from the first representation of the second user, is displayed at a second distance, different from the first distance, from the current viewpoint of the first user. In some embodiments, the plurality of representations is two-dimensional virtual elements (e.g., the virtual windows and/or containers are two-dimensional). In some embodiments, the virtual object includes the one or more virtual windows (e.g., the virtual object has a volume including one or more locations of the one or more virtual windows). For example, the one or more virtual windows are arranged in a pattern within the virtual object (e.g., virtual windows are arranged linearly (e.g., aligned at the same height and/or distance relative to the current viewpoint of the first user), or non-linearly (e.g., arranged at different heights and/or distance (e.g., alternating heights and/or distances) relative to the current viewpoint of the first user)).

In some embodiments, while displaying the first visual representation 718 and the second visual representation as non-spatial representations in the three-dimensional environment, the first computer system detects, via the one or more input devices, a second input (e.g., gaze 726 and/or hand 709 in FIG. 7Z) corresponding to selection of the first visual representation, such as selection of the first virtual panel 718 in FIG. 7Z. In some embodiments, the second input has one or more characteristics of the first input discussed above.

In some embodiments, in response to detecting the second input (e.g., after detecting the first input described above. In some embodiments, the second input has one or more characteristics of the first input described above), the first computer system displays, via the display generation component, the communication session user interface (e.g., communication session user interface 716 in FIG. 7AA) and the movement element (movement element 730 in FIG. 7AA) in the three-dimensional environment, wherein the communication session user interface is displayed at a location in the three-dimensional environment that has a spatial arrangement (e.g., spatial arrangement as shown in FIG. 7AA) relative to the collective spatial arrangement of the first visual representation and the second visual representation in the three-dimensional environment. In some embodiments, the communication session user interface and the movement element are displayed in a location partially overlaying the first visual representation but not the second visual representation. In some embodiments, the collective spatial arrangement of the first visual representation and the second visual representation, and the spatial arrangement of the communication session user interface, and the movement element are displayed in locations that prevent each respective display from overlapping each other relative to the viewpoint of the first user. For example, the first visual representation and the second visual representation are displayed as platters aligned on the right side of the three-dimensional environment relative to the viewpoint of the first user, and the communication session user interface and the movement element is displayed on a right side of the three-dimensional environment relative to the viewpoint of the first user. In some embodiments, if the first computer system detects a movement input directed at the movement element similar to the first movement input discussed above with reference to updating the spatial arrangement of the spatial representation of the first visual representation, the first computer system updates a spatial arrangement of the first visual representation, the second visual representation, the communication session user interface, and the movement element in the three-dimensional environment in accordance with the movement input. For example, the collective spatial arrangement of the first visual representation and the second visual representation, and the spatial arrangement of the communication session user interface, and the movement element is updated in a similar manner to the spatial representation of the first visual representation, the communication session user interface, and the movement element in the three-dimensional environment as discussed above. In emulating similar behavior when displaying representations of multiple users in the real-time communication session compared to displaying only the representation of the second user in the three-dimensional environment while in the real-time communication session, the user is able to continue with communication without having to relearn a new method of interacting with users within the three-dimensional environment, which lowers the amount of disruption associated with the addition of a new user to a real-time communication session.

In some embodiments, the communication session user interface (e.g., communication session user interface 716 in FIG. 7B) further includes an interactive communication component (e.g., caller details button 721 in FIG. 7B).

In some embodiments, while displaying the communication session user interface (e.g., communication session user interface 716 in FIG. 7B) and the movement element (e.g., movement element 730 in FIG. 7B) in the three-dimensional environment, the first computer system detects, via the one or more input devices, a second input (e.g., gaze 726 and/or hand 709 in FIG. 7B) corresponding to selection of the interactive communication component (e.g., caller detail button 721 in FIG. 7B) in the communication session user interface. In some embodiments, the second input corresponds to the first input described above (e.g., air gesture, touch gesture). In some embodiments, the interactive communication component corresponds to a call details button configured to display information corresponding to the second user. In some embodiments, the second input is directed at a communication session user interface corresponding to the third user.

In some embodiments, in response to detecting the second input, the first computer system replaces display of the communication session user interface in the three-dimensional environment with a call details interface (e.g., call details user interface 717 in FIG. 7C) associated with the real-time communication session in the three-dimensional environment. In some embodiments, the first computer system ceases the display of the communication session user interface and generates a display of a call details interface associated with the real-time communication session in response to detecting the second input. In some embodiments, the call details interface comprises a two-dimensional platter displayed at a location in the three-dimensional environment in front of the first visual representation, partially overlaying the first visual representation, relative to the viewpoint of the first user. In some embodiments, the call details interface includes contact information associated with the second user (e.g., phone number, email). In some embodiments, the display of the call details interface is generated via a display animation as discussed previously above. In some embodiments, the call details interface includes a two-dimensional representation corresponding to the two-dimensional representation of the second user. In some embodiments, the call details interface is displayed in a location in the three-dimensional, different than the location of the first visual representation such that the contact user interface does not overlap the first visual representation relative to the viewpoint of the first user. In some embodiments, the call details interface is displayed alongside a two-dimensional representation of the second user and the third user in the three-dimensional environment. In some embodiments, after the first computer system ceases the display of the communication session user interface, the first computer system initiates the display of the call details interface in the location previously occupied by the communication session user interface relative to the viewpoint of the first user. The replacement of the communication session user interface with the call details interface allows the first user to seamlessly access and interact with the contact details or relevant information associated with the real-time communication session, all within the context of the ongoing communication session, which provides convenient access to pertinent information while maintaining the communication session within the three-dimensional environment.

It should be understood that the particular order in which the operations in method 800 have been described is merely exemplary and is not intended to indicate that the described order is the only order in which the operations could be performed. One of ordinary skill in the art would recognize various ways to reorder the operations described herein. In some embodiments, aspects/operations of method 800 may be interchanged, substituted, and/or added between these methods. For example, various object manipulation techniques and/or object movement techniques of method 800 is optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method comprising:
at a first computer system in communication with a display generation component and one or more input devices:
while a three-dimensional environment is visible via the display generation component from a viewpoint of a first user of the first computer system, and while the first user of the first computer system is in a real-time communication session with a second user, different from the first user, of a second computer system, different from the first computer system, displaying, via the display generation component, a first visual representation of the second user at a first location in the three-dimensional environment relative to the viewpoint of the first user;
while displaying the first visual representation of the second user at the first location relative to the viewpoint of the first user, detecting, via the one or more input devices, a first input corresponding to selection of the first visual representation;
in response to detecting the first input, displaying, via the display generation component, a communication session user interface and a movement element associated with the communication session user interface in the three-dimensional environment;
while displaying the first visual representation of the second user, the communication session user interface and the movement element in the three-dimensional environment, detecting, via the one or more input devices, a first movement input; and
in response to detecting the first movement input:
in accordance with a determination that the first movement input is directed to the movement element, updating a spatial arrangement of the first visual representation, the communication session user interface, and the movement element in the three-dimensional environment relative to the viewpoint of the first user in accordance with the first movement input; and
in accordance with a determination that the first movement input is directed to the first visual representation of the second user, forgoing updating the spatial arrangement of the first visual representation, the communication session user interface, and the movement element in the three-dimensional environment relative to the viewpoint of the first user.

2. The method of claim 1, further comprising:
while displaying the first visual representation of the second user, the communication session user interface and the movement element in the three-dimensional environment in the updated spatial arrangement, detecting, via the one or more input devices, termination of the first movement input directed to the movement element in the three-dimensional environment; and
in response to detecting the termination of the first movement input, ceasing display of the communication session user interface and the movement element in the three-dimensional environment.

3. The method of claim 1, wherein updating the spatial arrangement of the first visual representation, the communication session user interface, and the movement element in the three-dimensional environment relative to the viewpoint of the first user includes:
moving the first visual representation, the communication session user interface, and the movement element in the three-dimensional environment relative to the viewpoint of the first user in accordance with the first movement input.

4. The method of claim 1, further comprising:
while updating the spatial arrangement of the first visual representation, the communication session user interface, and the movement element in the three-dimensional environment relative to the viewpoint of the first user in accordance with the first movement input in accordance with the determination that the first movement input is directed to the movement element:
in accordance with a determination that the first movement input corresponds to movement of the movement element in a first direction away from the viewpoint of the first user within the three-dimensional environment relative to the viewpoint of the first user, scaling up the size of the communication session user interface relative to the three-dimensional environment in proportion to the first movement input;
in accordance with a determination that the first movement input corresponds to a movement of the movement element in a second direction towards the viewpoint of the first user within the three-dimensional environment relative to the viewpoint of the first user, scaling down the size the communication session user interface relative to the three-dimensional environment and in proportion to the first movement input.

5. The method of claim 1, wherein:
displaying the communication session user interface in the three-dimensional environment in response to detecting the first input includes displaying the communication session user interface at a first height relative to the viewpoint of the first user in the three-dimensional environment, wherein the first height is based on a height of the first visual representation in the three-dimensional environment.

6. The method of claim 5, wherein for a given height of the first visual representation in the three-dimensional environment:
in accordance with a determination that the first user is engaging in a non-spatial communication session with the second user, the first height is a second height; and
in accordance with a determination that the first user is engaging in a spatial communication session with the second user, the first height is a third height, different from the second height.

7. The method of claim 1, wherein the communication session user interface is displayed at a respective location in the three-dimensional environment that has a respective spatial arrangement relative to the first location of the first visual representation in the three-dimensional environment.

8. The method of claim 7, wherein the respective location is a predefined ratio of a first distance away from the first visual representation, wherein the first distance is between the viewpoint of the first user in the three-dimensional environment and the first visual representation when the communication session user interface is displayed in response to the first input, and the respective location is a second distance away from the first visual representation when the communication session user interface is displayed in response to the first input.

9. The method of claim 8, wherein, in response to detecting the first movement input:
in accordance with the determination that the first movement input is directed to the movement element, updating the spatial arrangement of the first visual representation, the communication session user interface, and the movement element in the three-dimensional environment relative to the viewpoint of the first user in accordance with the first movement input includes maintaining the display of the communication session user interface at the second distance away from the first visual representation in the three-dimensional environment relative to the viewpoint of the first user.

10. The method of claim 7, wherein the respective location of the communication session user interface is a fixed distance from the first visual representation in the three-dimensional environment relative to the viewpoint of the first user.

11. The method of claim 7, further comprising:
after updating the spatial arrangement of the first visual representation, the communication session user interface, and the movement element in the three-dimensional environment relative to the viewpoint of the first user in accordance with the first movement input in accordance with the determination that the first movement input is directed to the movement element in response to detecting the first movement input:
in accordance with a determination that attention of the first user is detected as being directed to the communication session user interface in the three-dimensional environment, maintaining the display of the communication session user interface and the movement element in the three-dimensional environment; and
in accordance with a determination that the attention of the first user is not detected as being directed to the communication session user interface in the three-dimensional environment, ceasing the display of the communication session user interface and the movement element in the three-dimensional environment.

12. The method of claim 7, further comprising:
while displaying the first visual representation of the second user, the communication session user interface and the movement element in the three-dimensional environment, determining that a threshold amount of time has elapsed since displaying the communication session user interface and the movement element in the three-dimensional environment; and
in response to determining that the threshold amount of time has elapsed in accordance with a determination that an input is not detected within the threshold amount of time, ceasing the display of the communication session user interface and the movement element in the three-dimensional environment.

13. The method of claim 1, wherein the communication session user interface is displayed at a respective location in the three-dimensional environment that has a respective spatial arrangement relative to the viewpoint of the first user in the three-dimensional environment when the communication session user interface is displayed in response to the first input.

14. The method of claim 13, further comprising:
while updating the spatial arrangement of the first visual representation, the communication session user interface, and the movement element in the three-dimensional environment relative to the viewpoint of the first user in accordance with the first movement input in accordance with the determination that the first movement input is directed to the movement element in response to detecting the first movement input, maintaining the display of the communication session user interface with the respective spatial arrangement relative to the viewpoint of the first user in the three-dimensional environment.

15. The method of claim 13, further comprising:
while updating the spatial arrangement of the first visual representation, the communication session user interface, and the movement element in the three-dimensional environment relative to the viewpoint of the first user in accordance with the first movement input in accordance with the determination that the first movement input is directed to the movement element in response to detecting the first movement input, ceasing the display of the communication session user interface in the three-dimensional environment; and
in accordance with detecting termination of the first movement input, displaying, via the display generation component, the communication session user interface with the respective spatial arrangement relative to the viewpoint of the first user.

16. The method of claim 13, further comprising:
while updating the spatial arrangement of the first visual representation, the communication session user interface, and the movement element in the three-dimensional environment relative to the viewpoint of the first user in accordance with the first movement input in accordance with the determination that the first movement input is directed to the movement element in response to detecting the first movement input:
updating the spatial arrangement of the communication session user interface and the movement element in a first manner relative to the viewpoint of the first user; and
updating the spatial arrangement of the first visual representation in a second manner, different from the first manner, relative to the viewpoint of the first user.

17. The method of claim 1, wherein the communication session user interface includes a plurality of interactive communication session controls.

18. The method of claim 1, wherein:
while displaying the communication session user interface in the three-dimensional environment before detecting the first movement input, the communication session user interface is displayed with a first orientation relative to the environment facing the viewpoint of the first user; and
after updating the spatial arrangement of the first visual representation, the communication session user interface, and the movement element in the three-dimensional environment relative to the viewpoint of the first user in accordance with the first movement input, the communication session user interface is displayed with a second orientation relative to the environment facing the viewpoint of the first user, wherein the first orientation is different from the second orientation.

19. The method of claim 1, wherein the real-time communication session further includes a third user, different than the first user and the second user, of a third computer system, different than the first computer system and the second computer system, and the three-dimensional environment further includes a second visual representation of the third user at a second location, different than the first location, in the three-dimensional environment relative to the viewpoint of the first user, the method further comprising:
while displaying the first visual representation of the second user, the second visual representation of the third user, the communication session user interface at a first location based on the first visual representation in the three-dimensional environment, and the movement element, detecting, via the one or more input devices, a second input; and in response to detecting the second input:
in accordance with a determination that the second input is directed to the second visual representation:
ceasing displaying the communication session user interface at the first location based on the first visual representation in the three-dimensional environment; and
initiating display of the communication session user interface at a second location, different than the first location, based on the second visual representation in the three-dimensional environment.

20. The method of claim 1, further comprising:
while displaying, via the display generation component, the first visual representation, the communication session user interface, and the movement element in the three-dimensional environment:
detecting, via the one or more input devices, a second movement input; and
in response to detecting the second movement input:
forgoing moving the first visual representation, the communication session user interface, and the movement element within the three-dimensional environment in accordance with the second movement input.

21. The method of claim 20, wherein the second movement input comprises an air pinch and drag gesture performed by the first user and directed to the communication session user interface.

22. The method of claim 20, wherein the second movement input comprises movement of the viewpoint of the first user relative to the three-dimensional environment.

23. The method of claim 1, wherein the communication session user interface and the movement element are not displayed in the three-dimensional environment prior to detecting the first input corresponding to selection of the first visual representation.

24. The method of claim 1, further comprising:
while displaying the first visual representation of the second user at the first location relative to the viewpoint of the first user, detecting, via the one or more input devices, a second input corresponding to a request to display one or more system objects in the three-dimensional environment; and
in response to detecting the second input, displaying, via the display generation component, the one or more system objects and the communication session user interface in the three-dimensional environment, without displaying the movement element associated with the communication session user interface in the three-dimensional environment.

25. The method of claim 24, further comprising:
while displaying the one or more system objects and the communication session user interface in the three-dimensional environment, determining that a threshold amount of time has elapsed since displaying the one or more system objects and the communication session user interface in the three-dimensional environment; and
in response to determining that the threshold amount of time has elapsed:
in accordance with a determination that an input is not detected within the threshold amount of time, ceasing, via the display generation component, the display of the one or more system objects and the communication session user interface in the three-dimensional environment.

26. The method of claim 1, further comprising:
while displaying the first visual representation of the second user, the communication session user interface and the movement element in the three-dimensional environment in response to the first input, determining that a threshold amount of time has elapsed without a detection of a second input directed at the communication session user interface since displaying the communication session user interface and the movement element in the three-dimensional environment; and
in response to determining that the threshold amount of time has elapsed, ceasing, via the display generation component, the display of the communication session user interface and the movement element in the three-dimensional environment.

27. The method of claim 1, further comprising:
while displaying the first visual representation of the second user, the communication session user interface, and the movement element in the three-dimensional environment in response to the first input:
in accordance with a determination that attention of the first user is directed at the communication session user interface in the three-dimensional environment, maintaining, via the display generation component, the display of the communication session user interface and the movement element in the three-dimensional environment; and
in accordance with a determination that the attention of the first user is not directed at the communication session user interface in the three-dimensional environment, ceasing, via the display generation component, the display of the communication session user interface and the movement element in the three-dimensional environment.

28. The method of claim 1, further comprising:
while displaying the first visual representation of the second user, the communication session user interface and the movement element in the three-dimensional environment, detecting, via the one or more input devices, a second input; and
in response to detecting the second input:
in accordance with a determination that the second input corresponds to selection of the first visual representation, ceasing displaying the communication session user interface and the movement element in the three-dimensional environment.

29. The method of claim 1, wherein the three-dimensional environment further includes a first object, the method further comprising:
while displaying the first visual representation of the second user, the communication session user interface, the movement element associated with the communication session user interface, and the first object in the three-dimensional environment, detecting, via the one or more input devices, a second movement input directed to the first object; and
in response to detecting the second movement input:
in accordance with a determination that one or more criteria are satisfied, updating the spatial arrangement of the first visual representation, the communication session user interface, the movement element, and the first object in the three-dimensional environment relative to the viewpoint of the first user in accordance with the second movement input; and
in accordance with a determination that the one or more criteria are not satisfied, moving the first object in the three-dimensional environment relative to the viewpoint of the first user, without updating the spatial arrangement of the first visual representation, the communication session user interface, and the movement element in the three-dimensional environment, relative to the viewpoint of the first user, in accordance with the second movement input.

30. The method of claim 29, wherein the one or more criteria include a criterion that is not satisfied when the first object is private to the first user in the real-time communication session.

31. The method of claim 29, wherein the one or more criteria include a criterion that is satisfied when the first object is shared between the first user and the second user in the real-time communication session.

32. The method of claim 29, wherein the first visual representation is a spatial visual representation of the second user, and the one or more criteria include a criterion that is not satisfied when the first object corresponds to a non-spatial representation of a respective user in the real-time communication session.

33. The method of claim 29, further comprising:
while displaying the first visual representation of the second user, the communication session user interface, the movement element associated with the communication session user interface, and the first object in the three-dimensional environment, detecting, via the one or more input devices, a third movement input directed to the movement element; and
in response to detecting the third movement input:
in accordance with a determination that the one or more criteria are satisfied, updating the spatial arrangement of the first visual representation, the communication session user interface, and the movement element in the three-dimensional environment relative to the viewpoint of the first user in accordance with the third movement input.

34. The method of claim 29, wherein the one or more criteria include a criterion that is satisfied in accordance with a determination that the real-time communication session is a spatial communication session and that is not satisfied in accordance with a determination that the real-time communication session is a non-spatial communication session.

35. The method of claim 32, further comprising:
while displaying, via the display generation component, the first visual representation as the non-spatial representation of the respective user relative to the communication session user interface, and the movement element associated with the communication session user interface in the three-dimensional environment, detecting, via the one or more input devices, a third input corresponding to selection of the second visual representation, the second visual representation as the spatial representation; and
in response to detecting the third input:
ceasing display, via the display generation component, of the communication session user interface and the movement element relative to the first visual representation as the non-spatial representation in the three-dimensional environment; and
displaying, via the display generation component, the communication session user interface and the movement element associated with the communication session user interface in the three-dimensional environment relative to the second visual representation that is the spatial representation of the respective user.

36. The method of claim 1, further comprising:
while updating the spatial arrangement of the first visual representation, the communication session user interface, and the movement element in the three-dimensional environment relative to the viewpoint of the first user in accordance with the first movement input in accordance with the determination that the first movement input is directed to the movement element in response to detecting the first movement input:
in accordance with a determination that the updating the spatial arrangement causes the communication session user interface to be located within a threshold distance of a boundary of the three-dimensional environment, generating, via the display generation component, a visual indication that the communication session user interface is located within the threshold distance of the boundary.

37. The method of claim 1, further comprising:
in response to detecting the first movement input:
in accordance with the determination that the first movement input is directed to the first visual representation and that the first visual representation is located within a threshold distance of the viewpoint of the first user in the three-dimensional environment, updating the spatial arrangement of the first visual representation, the communication session user interface, and the movement element in the three-dimensional environment relative to the viewpoint of the first user in accordance with the first movement input.

38. The method of claim 1, further comprising:
while displaying the first visual representation of the second user at the first location relative to the viewpoint of the first user, detecting, via the one or more input devices, a third input corresponding to selection of the first visual representation; and
in response to detecting the third input:
in accordance with a determination that that the first visual representation is located within a threshold distance of the viewpoint of the first user in the three-dimensional environment, displaying, via the display generation component, at least one of the communication session user interface or the movement element in the three-dimensional environment.

39. The method of claim 38, further comprising:
in response to detecting the third input, in accordance with the determination that that the first visual representation is located within the threshold distance of the viewpoint of the first user in the three-dimensional environment:
updating a spatial arrangement of the first visual representation relative to the viewpoint of the first user from the first location in the three-dimensional environment to a second location, different from the first location, in the three-dimensional environment, wherein the second location is at a distance in the three-dimensional environment further from the viewpoint of the first user than the first location.

40. The method of claim 38, wherein, in response to detecting the third input, the communication session user interface is displayed at a second location, different from the first location, in the three-dimensional environment, wherein the second location is further from the viewpoint of the first user than the first location relative to the viewpoint of the first user, the method further comprising:
in response to detecting the third input:
in accordance with a determination that the first visual representation at least partially overlaps the communication session user interface relative to the viewpoint of the first user, changing a visual appearance of at least a portion of the first visual representation in the three-dimensional environment at the first location in the three-dimensional environment.

41. The method of claim 37, wherein displaying at least one of the communication session user interface or the movement element in the three-dimensional environment includes displaying the movement element without displaying the communication session user interface in the three-dimensional environment.

42. The method of claim 1, wherein the first user of the first computer system is further in the real-time communication session with a third user, different from the first user and the second user, of a third computer system, different from the first computer system and the second computer system, the method further comprising:
while displaying the first visual representation and a second visual representation of the third user in the three-dimensional environment, detecting, via the one or more input devices, a second input corresponding to selection of the first visual representation;
in response to detecting the second input:
displaying, via the display generation component, the communication session user interface, the movement element, and a second movement element associated with the second visual representation in the three-dimensional environment; and
while displaying the first visual representation, the second visual representation, the communication session user interface, the movement element, and the second movement element in the three-dimensional environment, detecting, via the one or more input devices, a second movement input directed to the second movement element; and
in response to detecting the second movement input:
updating a spatial arrangement of the communication session user interface, the movement element, the first visual representation, the second visual representation, and the second movement element in the three-dimensional environment relative to the viewpoint of the first user in accordance with the second movement input.

43. The method of claim 1, wherein the first user of the first computer system is further in the real-time communication session with a third user, different from the first user and the second user, of a third computer system, different from the first computer system and the second computer system, the method further comprising:
displaying, via the display generation component, the first visual representation as a non-spatial representation of the second user in the three-dimensional environment and a second visual representation as a non-spatial representation of the third user in the three-dimensional environment;
while displaying the first visual representation and the second visual representation as non-spatial representations in the three-dimensional environment, detecting, via the one or more input devices, a second input corresponding to selection of the first visual representation; and in response to detecting the second input:
displaying, via the display generation component, the communication session user interface and the movement element in the three-dimensional environment, wherein the communication session user interface is displayed at a location in the three-dimensional environment that has a spatial arrangement relative to the collective spatial arrangement of the first visual representation and the second visual representation in the three-dimensional environment.

44. The method of claim 1, wherein the communication session user interface further includes an interactive communication component, the method further comprising:
while displaying the communication session user interface and the movement element in the three-dimensional environment, detecting, via the one or more input devices, a second input corresponding to selection of the interactive communication component in the communication session user interface; and
in response to detecting the second input:
replacing display of the communication session user interface in the three-dimensional environment with a call details interface associated with the real-time communication session in the three-dimensional environment.

45. A first computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
while a three-dimensional environment is visible via the display generation component from a viewpoint of a first user of the first computer system, and while the first user of the first computer system is in a real-time communication session with a second user, different from the first user, of a second computer system, different from the first computer system, displaying, via the display generation component, a first visual representation of the second user at a first location in the three-dimensional environment relative to the viewpoint of the first user;
while displaying the first visual representation of the second user at the first location relative to the viewpoint of the first user, detecting, via the one or more input devices, a first input corresponding to selection of the first visual representation;
in response to detecting the first input, displaying, via the display generation component, a communication session user interface and a movement element associated with the communication session user interface in the three-dimensional environment;
while displaying the first visual representation of the second user, the communication session user interface and the movement element in the three-dimensional environment, detecting, via the one or more input devices, a first movement input; and
in response to detecting the first movement input:
in accordance with a determination that the first movement input is directed to the movement element, updating a spatial arrangement of the first visual representation, the communication session user interface, and the movement element in the three-dimensional environment relative to the viewpoint of the first user in accordance with the first movement input; and
in accordance with a determination that the first movement input is directed to the first visual representation of the second user, forgoing updating the spatial arrangement of the first visual representation, the communication session user interface, and the movement element in the three-dimensional environment relative to the viewpoint of the first user.

46. A non-transitory computer readable storage medium storing one or more programs, the one or more programs comprising instructions, which when executed by one or more processors of a first computer system that is in communication with a display generation component and one or more input devices, cause the first computer system to perform a method comprising:
while a three-dimensional environment is visible via the display generation component from a viewpoint of a first user of the first computer system, and while the first user of the first computer system is in a real-time communication session with a second user, different from the first user, of a second computer system, different from the first computer system, displaying, via the display generation component, a first visual representation of the second user at a first location in the three-dimensional environment relative to the viewpoint of the first user;
while displaying the first visual representation of the second user at the first location relative to the viewpoint of the first user, detecting, via the one or more input devices, a first input corresponding to selection of the first visual representation;
in response to detecting the first input, displaying, via the display generation component, a communication session user interface and a movement element associated with the communication session user interface in the three-dimensional environment;
while displaying the first visual representation of the second user, the communication session user interface and the movement element in the three-dimensional environment, detecting, via the one or more input devices, a first movement input; and
in response to detecting the first movement input:
in accordance with a determination that the first movement input is directed to the movement element, updating a spatial arrangement of the first visual representation, the communication session user interface, and the movement element in the three-dimensional environment relative to the viewpoint of the first user in accordance with the first movement input; and
in accordance with a determination that the first movement input is directed to the first visual representation of the second user, forgoing updating the spatial arrangement of the first visual representation, the communication session user interface, and the movement element in the three-dimensional environment relative to the viewpoint of the first user.
